(19) United States
(12) Patent Application Publication
(10) Pub. No.: US 2003/0158854 A1
(43) Pub. Date: Aug. 21, 2003

(54) Structured document converting method and data converting method

(75) Inventors: Shigeru Yoshida, Kawasaki (JP); Hironori Yahagi, Kawasaki (JP); Noriko Itani, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/274,230

(22) Filed: Oct. 21, 2002

(30) Foreign Application Priority Data
Dec. 28, 2001 (JP) 2001-401934

(51) Int. Cl. G06F 7/00

(52) U.S. Cl. 707/101

(57) ABSTRACT

A technique aimed to decrease the resource required for operations on a structured document, decrease the amount of a memory used, and increase the processing speed when the structured document is processed. Elements constituting a structured document to be converted are separated into key elements and nonkey elements, a new element given a predetermined tag name and a predetermined attribute name is created, tag name conversion is performed to create a tag name character string and describe the tag name character string as an attribute value corresponding to the predetermined attribute name in the new element, content conversion is performed to create a content character string including contents of the nonkey elements and describe the content character string as a content of the new element, and the key elements are described unchanged in a converted structured document. The method is applied to a system handling structured documents such as XML.

### BACKGROUND OF THE INVENTION

1) Field of the Invention

The present invention relates to a technique adapted to a system handling structured documents in XML (extensible Markup Language) or the like. More specifically, the present invention relates to a technique for converting the data structure of a structured document or character strings constituting a structured document in order to speed up the processing speed and decrease the amount of a memory used in the system.

XML documents are roughly classified into two types according to the characteristics. One is data-centric XML documents such as slips, schedules and the like including a large number of tags and relatively short element contents. The other is document-centric XML documents such as magazines, manuals, dictionaries and the like, in which element contents are relatively long sentences. The present invention is a technique suitable to process the former data-centric XML documents are objects of processing. Particularly, the present invention is a technique suitable to process XML documents expressed in table forms, and handled as databases.

2) Description of the Related Art

Recently, all kinds of systems of individuals, enterprises, local governments, etc. are communicably interconnected over the Internet. These systems associate with each other to provide Web services, EDI (Electronic Data Interchange), EC (Electronic Commerce), etc. For this, wide exchange of information becomes necessary. Under such circumstances, XML attracts attention as a common base format on the occasion of the data exchange between or among the above systems, or data processing in each system, because XML has an ability to structure data and flexibly express it, thus being suited for processing by computers.

XML was developed by W3C (World Wide Web Consortium) as basic specifications XML 1.0 in February, 1998 in order to use SGML (Standard Generalized Markup Language) standardized by ISO (International Organization for Standardization) in 1986 more easily on the Internet. HTML (HyperText Markup Language), which is a Web page creating language, has fixed tags, specialized to display. HTML has thus a problem that HTML cannot cope with a requirement to process information by computers on the basis of tag information. On the contrary, XML has a language structure that the user can freely define tags, and give a meaning to a character string in a document. When a document is described in XML, it is possible to process the document by a computer on the basis of tag information.

Here, terms to be used in the following description will be explained on the basis of the XML standard. A character string sandwiched between a pair of “<” and “>” is called “tag.” “<character string>” is called “start tag.” “</character string>” is called “end tag.” “<character string/>” is called “empty element tag.” The whole character string from a start tag to an end tag is called “element.” A character string sandwiched between a start tag and an end tag is called “element content (sometimes called merely content).” A name of an element described inside a tag is called “element name (or tag name).” Additional information to an element is called “attribute.”

In a structured document, a data structure is described in the way that tags are embedded in the document. By employing a data structure in which tags are embedded in a document, it becomes possible to give flexibility and expandability when a data item is added, deleted or changed. By giving a name that the user can comprehend the meaning to a tag, it is possible to give visual recognizability to the structured document.

When it is desired to speed up the processing on the XML documents or decrease the amount of memory used, it is the main stream to enhance the performance of implementation of basic software. Other than this method, it is alternatively possible to improve the performance in processing on XML document by beforehand processing the XML documents. The present invention relates to the latter method (a method of processing an XML document to improve the performance in processing). Now, known techniques relating to the latter method will be described.

[a1] Known Technique 1

An article in Nikkei Computer Magazine (March, 12, 2001), “Overturned ‘Common knowledge’ of almighty, dreamy XML” discloses a problem that the processing speed decreases when XML is introduced, but the problem can be solved by changing the data structure. In the case of Sumitomo Denko Systems (refer to p64-65 in the same magazine), the same kind of data is collectively described in CSV (Comma Separated Values) form, and collected data is embedded in one tag in the XML data. For example, definition information on the XML data is changed, and XML data of each month is delimited by commas in the order of their dates, and collected into one.

In concrete, data relating to daily results having been described in different tags as this:

<KOUSU day=“01”>8.0</KOUSE><KOUSU day=“02”>5.5</KOUSU>. . . <KOUSU day=“31”>12.8</KOUSU>is collected into a monthly result, then the original document is rewritten to:

<KOUSU day=01,02, . . . , 31” data=”8.0,5.5, . . . , 12.8></KOUSU>

By changing as above, only one inquiry to the database-server suffices to refer data for one month. Not only the above, but also single transmission of definition information of XML suffices, so that the data capacity is decreased to one-tenth. The known technique 1 collects the same type of data used in the data processing into one tag, which is applied to specific data including the same type of data. Its effect of improvement depends on data.

[a2] Known Technique 2

When record items (field) of an XML document can be separated into key elements that are objects of data processing and elements (nonkey elements) that are not objects of the data processing, it is possible to collect the nonkey elements and put them into another file while leaving the key elements, as shown in [a2-1] and [a2-2] below. At this time, the nonkey elements are quoted from the key elements using identification information (id) as the attribute. The known technique 2 can limit the load to only the key elements when data processing is performed on only the key elements. However, when it is desired to extract a relevant file for the purpose of retrieval or the like, and display the key elements and the nonkey elements together, it is necessary to read the nonkey elements from another file and combine them with the key elements, which is troublesome.

[a2-1] Practical Example of Original XML Document

<nominal list>

<individual><name>A</name><company>A

company</company><department>A
department</department><address>A
city</address><telephone>123</telephone></individu
al>

<individual><name>B</name><company>B

company</company><department>B
department</department><address>B
city</address><telephone>456</telephone></individu
al>
</nominal list>

[a2-2] Example of Division into Two Files

In the above original XML document, key elements (name, company) and nonkey elements (department, address, telephone) are separated into different files, that is, an XML document of the key elements and an XML document of the nonkey elements. In the XML document of the key elements, an empty element tag of a tag name “information” is newly created, and the key elements are related with the XML document of the nonkey elements by an attribute (id) in the empty element tag. In another file, the nonkey elements are collected into an element of a tag name “information”, and the nonkey elements are referred using an attribute (ref) corresponding to the id attribute.

XML document of key elements

<nominal list>

<individual><name>A</name><company>A

company</company><information
id=“1”/></individual>

<individual><name>B</name><Company>B

| company</company><information | |
|---|---|
| </nominal list> | |
| · XML document of nonkey elements | |
| <nominal list> | |
| <information | ref=“1”><department>A |
| department</department><address>A | |
| city</address><telephone>123</telephone></informat | |
| ion> | |
| <information | ref=“2”><department>B |

department</department><address>B
city</address><telephone>456</telephone></informat
ion>
</nominal list>

[a3] Known Technique 3

A known techniques designates a hierarchical layer of XML data, and compresses data below that hierarchical layer by means of compression software XML Zip exclusive to XML. In XML data in the database form, a compressed file is created for each record, and the compressed XML data can be partially decompressed. The XML document can be decompressed for each record, whereby restriction of the memory can be avoided. However, when a size (data amount) per one record is not large, the known technique 3 cannot obtain an effective compression ratio.

There are defined two standard interfaces (API: Application Programming Interface) called DOM (Document Object Model) and SAX (Simple API for XML) for XML documents, which are representative structured documents, in order to handle the XML documents by means of application software (application). SAX has a generally high-speed processing speed, and requires a small amount of memory used at the time of processing. SAX outputs data in time series, thus has characteristics suitable for simple processing of only referring to data. DOM has a generally low processing speed, and requires a large amount of memory used at the time of processing. DOM expands elements of an XML document into a hierarchical tree (DOM tree), thus has characteristics that DOM is suited to make a program for complex processing contents.

In an operation of retrieving, updating, deleting or the like on an XML document, the XML document to be operated is first expanded into a DOM tree by standard API (DOM), then the operation is performed, in general. When the XML document is developed into a DOM tree, a large operation memory capacity six times as large as the original data amount becomes necessary, and a long time is required for the expanding process because items not to be used (items not to be operated) are also expanded.

A large amount of memory used and a slow processing speed of standard API (DOM) are caused by that all elements including elements that are not objects of data processing are also expanded on the memory by the application handling the XML document. As a result, the processing speed and the amount of memory used are increased proportional to the number of elements in a structured document.

For this reason, the above known techniques 1 and 2, each of which beforehand processes an XML document, have been proposed in order to improve the processing performance for XML documents.

In the manner of the above known technique 1, data of the same type to be used in the data processing are collected into one tag. However, this manner is applied to specific data including the same type of data, so that the effect of the improvement to decrease the amount of memory used or increase the processing speed relies on data.

In the manner of the above known technique 2, key elements that are objects of the data processing and element not to be used are separated into different files. When the key elements and the nonkey elements are desired to be displayed together, it is necessary to read the nonkey elements from another file, and combine them with the key elements, which is quite troublesome.

When the structure of XML data is beforehand converted, it needs to consider a general-purpose data structure converting method, so that the converting method can be applied to various types of XML data. Additionally, it is necessary to carry out the conversion in a such way that the converted XML data keeps an effective data structure, and to secure transparency to the application software. The transparency signifies that the converted XML document can be used even if the application software does not correct at all or correct a little the converted XML document to be processed. The transparency is an essential characteristic when the converted XML document is executed by existing application software.

According to the above known technique 3, a compressed file is created for each record of XML data. Since the compressed data is generally binary data, it cannot be put in an XML document composed of only character codes, thus is stored in another file. When a predetermined record in the XML document is desired to be referred to, it becomes necessary to read the record from another file and decompress it, which is quite troublesome. For this, there is a requirement for development of the compressing method that can put a result of compression in an XML document while compressing the XML document efficiently (that is, a result of compression can be obtained in the form of character codes).

### SUMMARY OF THE INVENTION

In the light of the above problems, an object of the present invention is to provide a general-purpose converting technique, which can perform a data structure converting process of collecting nonkey elements into one element on various kinds of structured document data while securing transparency to applications and effectiveness of data structures of converted structured documents, thereby to realize a decrease in the resource required for operations on the structured document, a decrease in the amount of a memory used, and an increase in the processing speed at the time of processing on the structured document.

Another object of the present invention is to provide a compressing conversion technique that can effectively compress a structured document, obtain a result of the compression in the form of character codes, and put it in a structured document, thereby to decrease the resource required for operations on the structured document, decrease the amount of the memory used and increase the processing speed at the time of processing on the structured document.

The present invention therefore provides a structured document converting method comprising the steps of separating elements constituting a structured document to be converted into key elements and nonkey elements, creating a new element given a predetermined tag name and a predetermined attribute name, performing tag name conversion to create a tag name character string including tag names of the nonkey elements and describe the tag name character string as an attribute value corresponding to the predetermined attribute name in the new element, performing content conversion to create a content character string including contents of the nonkey elements and describe the content character string as a content of the new element, and describing the key elements unchanged (without any conversion on the key elements) in a converted structured document.

The present invention further provides a structured document converting method comprising the steps of separating elements constituting a structured document to be converted into key elements and nonkey elements, creating a new element given a predetermined tag name, creating a character string in which symbols relating to tagging in description of the nonkey elements are replaced with character strings not relating to tagging, describing the created character string as a content of the new element, and describing the key elements unchanged (without any conversion on the key elements) in a converted structured document.

The present invention still further provides a structured document converting method comprising the steps of separating elements constituting a structured document to be converted conversion into key elements and nonkey elements, creating a new element given a predetermined tag name, converting the nonkey elements into a compressed character string composed of character codes according to ASCII (American Standard Code for Information Interchange) by performing variable-length coding to assign a shorter variable-length code to a character or a character string having a higher frequency of appearance in the nonkey element, packing each six bits of binary data obtained by the variable-length coding into conversion data of one byte, and converting six-bit data packed into each conversion data into a character code according to ASCII, describing the compressed character string as a content of the new element, and

describing the key elements unchanged in a converted structured document.

The present invention still further provides a data converting method comprising the steps of performing variable-length coding to assign a shorter variable-length code to a character or a character string having a higher frequency of appearance in a document to be converted, and packing each six bits of binary data obtained by the variable-length coding into a conversion data of one byte and outputting the conversion data. At this time, six-bit data packed into each conversion data may be converted into a character code according to ASCII, and the character code obtained for each conversion data maybe outputted as a result of compressing conversion of the document to be converted.

In the structured document converting method according to this invention, elements constituting a structured document to be converted are separated into key elements and nonkey elements, and the structured document is converted into a structured document in which the key elements are described unchanged, whereas the nonkey elements are collected into one tag and described. In the converted structured document, the number of the elements is decreased, and the nonkey elements can be collectively handled at the time of expansion or data processing. Particularly, the effect of decreasing the number of elements is remarkable in a structured document having a large number of nonkey elements that are not objects of data processing, or in a structured document having a large number of elements in one record.

When application software (application) performs data processing on a structured document, only key elements are used. According to this invention, since key elements are described unchanged in a converted document, it is possible to refer a content of a key element using a tag name of the key element as usual, thus transparency of the converted structure is kept.

At this time, a conversion specification document is given as a structured document, so that it becomes unnecessary to create a style sheet for each of various kinds of structured documents. Accordingly, the data structure converting/reversely converting process according to this invention can be applied to various structured documents. If a style sheet for conversion/reverse conversion instructing conversion/reverse conversion is created on the basis of the conversion specification document, conversion/reverse conversion can be performed by a structured document converting processor (standard XSLT processor, for example) using the style sheet for conversion/reverse conversion. In other words, the converting/reversely converting process according to this invention can be performed in almost all kinds of structured document system (XML document system).

As above, the present invention provides a general-purpose converting technique that can perform the data structure converting process of collecting nonkey elements into one element on various structured document data, while securing transparency to applications and effectiveness of the data structures of converted structured documents. Whereby, the resource required for operations on a structured document is largely decreased, the amount of the memory used is decreased and the processing speed is increased when the structured document is processed.

At the time of tag name conversion or content conversion, tag names or contents of nonkey elements are connected via (a) delimiter(s) such as a comma or the like, so that a tag name character string or a content character string can be created quite easily using symbols not relating to tagging.

When the nonkey elements are in a plurality of hierarchical layers on this occasion, hierarchical structure identification information may be added to a tag name character string, whereby the hierarchical structure is retained in the converted document. Reverse conversion can be readily performed to restored a converted document into the original structured document according to the hierarchical structure identification information.

When a nonkey element has an attribute, an attribute name of the attribute, to which attribute identification information is added, may be described after a tag name having the attribute via a delimiter in a tag name character string, and a content character string, in which contents of nonkey elements are connected, is created correspondingly to the arrangement of tag names in the tag name character string, whereby the attribute of the nonkey element can be retained in a converted structured document. Reverse conversion can be readily performed to restore a document to the original structure document according to attribute identification information.

Tag name abbreviating conversion of replacing a tag name of a nonkey element with an abbreviated tag name can decrease the amount of data of a converted structured document. Tag name abbreviating conversion information in a conversion specification document instructs whether tag name abbreviating conversion be performed or not to automatically switch between execution/non-execution of tag name abbreviating conversion or tag name expanding conversion.

When a structured document to be converted is described in a table form, tag name conversion or attribute conversion may be omitted because a tag name or an attribute name can be readily deduced in reverse conversion for restoring the document to the original structured document. Description of a content character string of nonkey element suffices in a converted structured document, thus description of tag names or attribute names can be omitted. This allows a large decrease in the data amount of a converted structured document. At this time, table form information in a conversion specification document instructs whether table-form conversion be performed or not to automatically switch between execution and non-execution of table-form conversion or table-form reverse conversion.

In the structured document converting method according to the present invention, elements constituting a structured document to be converted are separated into key elements and nonkey elements, and the structured document is converted into a structured document in which the key elements are described unchanged, and the nonkey elements are collected into one tag and symbols relating to tagging in description of the nonkey elements are replaced with character strings not relating to tagging. This structured document converting method can provide similar effects and advantages to those provided by the structured document converting method described above. At this time, entity reference description of a symbol relating to tagging is used as a character string not relating to tagging (for example, when a structured document is an XML document, tag symbols “<” and “>” are replaced with character strings “&lt;” and “&gt;” of entity reference description), respectively, so that the structured document can be converted quite easily.

In the structured document converting method according to the present invention, elements constituting a structured document to be converted are separated into key elements and nonkey elements. The structured document is converted into a structured document in which the key elements are described unchanged, and characters or character strings composing the nonkey elements are collected into one tag, and described as a character code string (compressed character string) obtained by compressing them in a data compressing method to be described later. This structured document converting method can provide similar effects and advantages to those provided by the structured document converting method described above. Additionally, this structured document converting method can largely decrease the data amount of a converted structured document.

When characters or character strings constituting the nonkey elements are compressed, variable-length coding is performed, each six bis of binary data obtained by the variable-length coding are packed into conversion data of one byte, and six-bit data packed into each conversion data is converted into a character code according to ASCII, whereby compressed data (compressed character string) described by character codes is obtained. The compressed data can be put as an element or an attribute value in the structured document.

The data compressing method according to this invention provides a compressing conversion technique that can obtain a result of compression as character codes and put them in a structured document, while efficiently compressing the structured document. Therefore, it is possible to largely increase the resource required for operations on the structured document, decrease the amount of the memory used, and increase the processing speed, when the structured document is processed.

At this time, a set of ASCII, in which character codes relating to tagging (for example, <, >, &, “and ‘ in XML documents) are eliminated, is used as character codes expressing the compressed data. Accordingly, no symbol relating to tagging is present in a compressed character string in a converted structured document, thus occurrence of erroneous processing can be certainly prevented at the time of data processing or the like.

Since ASCII is a character code set commonly included in various character code systems, a bit string of a compressed character string using ASCII codes is kept in the original state without affected by conversion of the character code system even when the converted structured document is undergone conversion of the character code system. A compressed character string included in a structured document, in which its character code system has been converted, can be appropriately restored into the original nonkey elements.

By giving information representing a type of a character code system at the time of compression to a compressed character string, it is possible to recognize a type of the character code system of data restored from the compressed character string. The character code system is matched with the present character code system of a structured document, whereby matching of the character code system of the whole structured document can be kept.

In prior to conversion of nonkey elements into a compressed character string, a character string composed of the nonkey elements is replaced with dictionary numbers using a static diction beforehand created, whereby a character string that is an object of variable-length coding can be abbreviated. Accordingly, the compression efficiency is more improved, and the data amount of a converted structured document is more decreased.

Other subjects and further features of the present invention will be apparent from the following detailed description when read in conjunction with the accompanying drawings.

### BRIEF DESCRIPTION OF THE DRAWINGS

FIGS. 1A and 1B are diagrams for illustrating the principle of a structured document converting method according to a first embodiment of this invention; FIG. 1A is a diagram showing a memory expansion form of an XML document to be converted; FIG. 1B is a diagram showing a memory expansion form of an XML document obtained by applying the structure document converting method according to the first embodiment to the XML document shown in FIG. 1A;

FIG. 2 is a diagram for illustrating a system to which the structured document converting method according to the first embodiment of this invention is applied, and a flow of a converting/reversely converting process in the system;

FIG. 3A is a diagram showing a practical example of an XML document to be converted; FIGS. 3B through 3F show first to fifth practical examples of results of conversion obtained by applying the structured document converting method according to the first embodiment to the XML document shown in FIG. 3A;

FIG. 4A is a diagram showing a practical example of an XML document (in table form) to be converted; FIGS. 4B and 4C are diagrams showing first and second practical examples of results of conversion obtained by applying the structured document converting method according to the first embodiment to the XML document shown in FIG. 4A when the XML document shown in FIG. 4A is in a table form;

FIG. 5 is a diagram showing a practical example of an XML document to be converted conversion;

FIG. 6 is a diagram showing a first practical example of a result of conversion obtained by applying the structured document converting method according to the first embodiment to the XML document shown in FIG. 5;

FIG. 7 is a diagram showing a second practical example of a result of conversion obtained by applying the structured document converting method according to the first embodiment to the XML document shown in FIG. 5;

FIG. 8 is a diagram showing a third practical example of a result of conversion obtained by applying the structured document converting method according to the first embodiment to the XML document shown in FIG. 5;

FIG. 9 is a diagram showing a practical example of a conversion specification document according to the first embodiment;

FIG. 10 is a diagram showing a practical example of a style sheet for conversion created on the basis of the conversion specification document shown in FIG. 9 according to the first embodiment;

FIG. 11 is a diagram showing a practical example of a style sheet for reverse conversion created on the basis of the conversion specification document shown in FIG. 9 according to the first embodiment;

FIG. 12 is a diagram showing a practical example of a conversion specification document for tag name abbreviation according to the first embodiment;

FIG. 13 is a diagram showing a practical example of a conversion specification document having a function of designating a data from (table form or not) according to the first embodiment;

FIG. 14 is a diagram showing a practical example of a conversion specification document having a function of designating a data form (performing tag name abbreviating conversion or not) according to the first embodiment;

FIG. 15 is a diagram showing a first practical example of a conversion specification document applied when nonkey elements in a record have a hierarchical structure and attribute;

FIG. 16 is a flowchart for illustrating a procedure for creating a conversion specification document applied when nonkey elements in a record have a hierarchical structure and attribute;

FIG. 17 is a diagram showing a second practical example of a conversion specification document applied when nonkey elements in a record have a hierarchical structure and attribute;

FIG. 18 is a flowchart for illustrating a procedure for a converting process in the structured document converting method according to the first embodiment;

FIG. 19 is a flowchart for illustrating a procedure for an reversely converting process in the structured document converting method according to the first embodiment;

FIGS. 20A and 20B are flowcharts for illustrating procedures for creating a style sheet for conversion and a style sheet for reverse conversion according to the first embodiment; FIGS. 20C and 20D are flowcharts for illustrating modified examples of the procedures for the converting process and the reversely converting process in the structured document converting method according to the first embodiment;

FIGS. 21A and 21B are flowcharts for illustrating modified examples of procedures for creating a style sheet for conversion and a style sheet for reverse conversion according to the first embodiment;

FIG. 22 is a diagram showing a memory expansion form of an XML document obtained by applying a structure document converting method according to a second embodiment to the XML document shown in FIG. 1A in order to illustrate the principle of the structured document converting method according to the second embodiment of this invention;

FIG. 23 is a diagram showing a first practical example of a result of conversion obtained by applying the structured document converting method according to the second embodiment to the XML document shown in FIG. 4A;

FIG. 24 is a diagram showing a second practical example of a result of conversion obtained by applying the structured document converting method according to the second embodiment to the XML document shown in FIG. 4A;

FIG. 25 is a diagram showing a third practical example of a result of conversion obtained by applying the structured document converting method according to the second embodiment to the XML document shown n FIG. 4A;

FIG. 26 is a fourth practical example of a result of conversion obtained by applying the structured document converting method according to the second embodiment to the XML document shown in FIG. 4A;

FIG. 27 is a diagram showing a practical example of a conversion specification document according to the second embodiment;

FIG. 28 is a diagram showing a practical example of a style sheet for conversion created on the basis of the conversion specification document shown in FIG. 27 according to the second embodiment;

FIG. 29 is a diagram showing a practical example of a style sheet for reverse conversion created on the basis of the conversion specification document shown in FIG. 27 according to the second embodiment;

FIG. 30 is a flowchart for illustrating a procedure for creating a conversion specification document applied when nonkey elements in a record have a hierarchical structure and attributes according to the second embodiment;

FIG. 31 is a flowchart for illustrating a first example of a procedure for a converting process in the structure document converting method according to the second embodiment of this invention;

FIG. 32 is a flowchart for illustrating a first example of a procedure for a reversely converting process in the structured document converting method according to the second embodiment of this invention;

FIG. 33 is a flowchart for illustrating a second example of a procedure for a converting process in the structure document converting method according to the second embodiment of this invention;

FIG. 34 is a flowchart for illustrating a second example of a procedure for a reversely converting process in the structured document converting method according to the second embodiment of this invention;

FIG. 35 is a flowchart for illustrating a third example of a procedure for a converting process in the structured document converting method according to the second embodiment of this invention;

FIG. 36 is a flowchart for illustrating a third example of a procedure for a reversely converting process in the structured document converting method according to the second embodiment of this invention;

FIG. 37 is a flowchart for illustrating a fourth example of a procedure for a converting process in the structured document converting method according to the second embodiment of this invention;

FIG. 38 is a flowchart for illustrating a fourth example of a procedure for a reversely converting process in the structured document converting method according to the second embodiment of this invention;

FIGS. 39A and 39B are flowcharts for illustrating procedures for creating a style sheet for conversion and a style sheet for reverse conversion according to the second embodiment; FIGS. 39C and 39D are flowcharts for illustrating a fifth example of a procedure for a converting process and a procedure for a reversely converting process in the structured document converting method according to the second embodiment of this invention;

FIG. 40 is a diagram showing a memory expansion form of an XML document obtained by applying a structured document converting method according a third embodiment to the XML document shown in FIG. 1A in order to illustrate the principle of the structured document converting method according to the third embodiment of this invention;

FIGS. 41A and 41B are diagrams for illustrating a data converting method used in the third embodiment; FIG. 41A is a diagram for illustrating a flow of a data converting process (compressing process); FIG. 41B is a diagram for illustrating a flow of a data reversely converting process (decompressing process);

FIG. 42 is a diagram showing a practical example of a lookup table for character code conversion according to the third embodiment;

FIG. 43 is a diagram for illustrating a system to which the structure document converting method according to the third embodiment of this invention is applied and a flow of a converting/reversely converting process in the system;

FIGS. 44A and 44B are diagrams for illustrating a first and a second practical examples of results of conversion obtained by applying the structured document converting method according to he third embodiment to the XML document shown in FIG. 4A;

FIG. 45 is a diagram showing a practical example of a compressed character string to which information representing a type of a character code system is added according to the third embodiment;

FIG. 46 is a diagram showing a practical example of a conversion specification document according to the third embodiment;

FIG. 47 is a flowchart for illustrating a procedure for a converting process in the structured document converting method according to the third embodiment of this invention; and

FIG. 48 is a flowchart for illustrating a procedure for a reversely converting process in the structured document converting method according to the third embodiment of this invention.

### DESCRIPTION OF THE PREFERRED EMBODIMENTS

Hereinafter, description will be made of embodiments of this invention with reference to the drawings.

When DOM is employed as the standard API, and a structured document is expanded as a DOM tree on a memory, the larger the number of elements in the structured document, the longer a time is required for the expanding process and the longer a time is required to perform tag-dependent content retrieval.

A structured document includes key elements that are objects of data processing on the structure document and nonkey elements that are not objects of the data processing. Accordingly, elements constituting a structured document can be separated into key elements and nonkey elements. When application software (application) performs data processing on a structured document, only key elements become objects of the processing, a key element is retrieved with a tag name, and a content of the retrieved key element is referred.

According to this invention (first to third embodiments), a structured document that is an object of conversion is converted into a structured document in which key elements are not converted at all, but nonkey elements are collected into one tag and described in one record. In this embodiment, a structured document is an XML document.

[1] Description of First Embodiment

In a first embodiment, description will be made first of a method of converting an XML document in which elements in each record are in one hierarchical layer, secondary of a method of converting an XML document including a record in which elements are in not less than two hierarchical layers or a record in which an element having an attribute, for the sake of simple explanation.

[1-1] Principle of Structured Document Converting Method According to First Embodiment

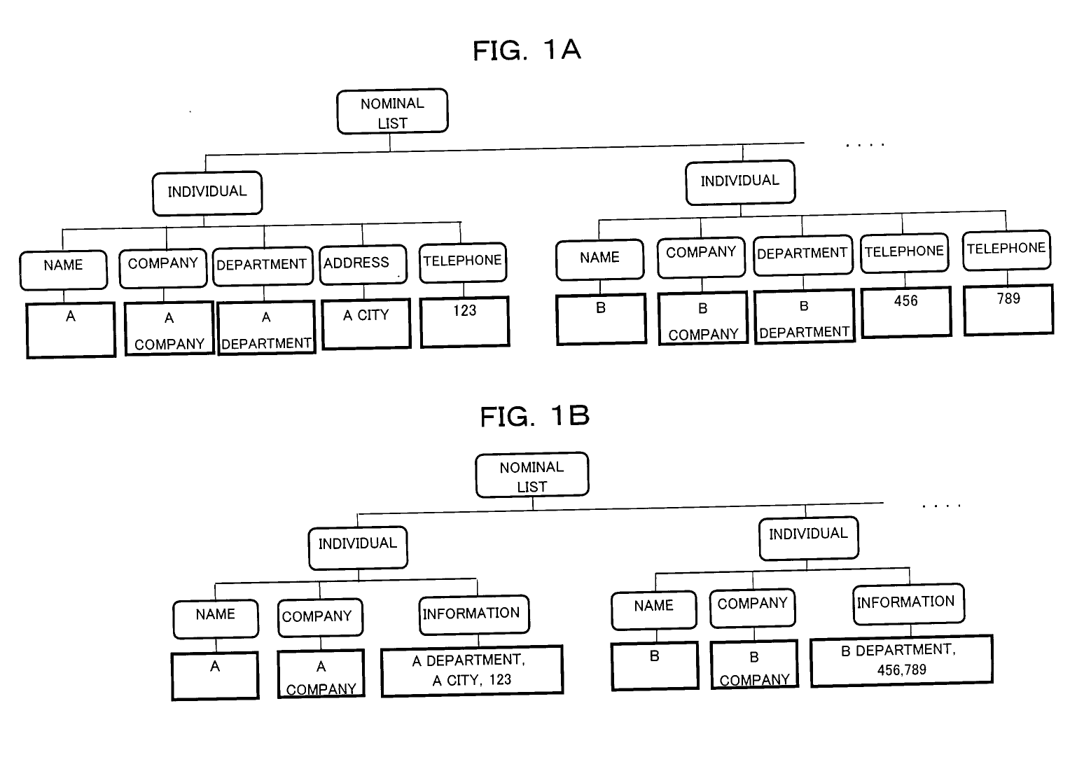

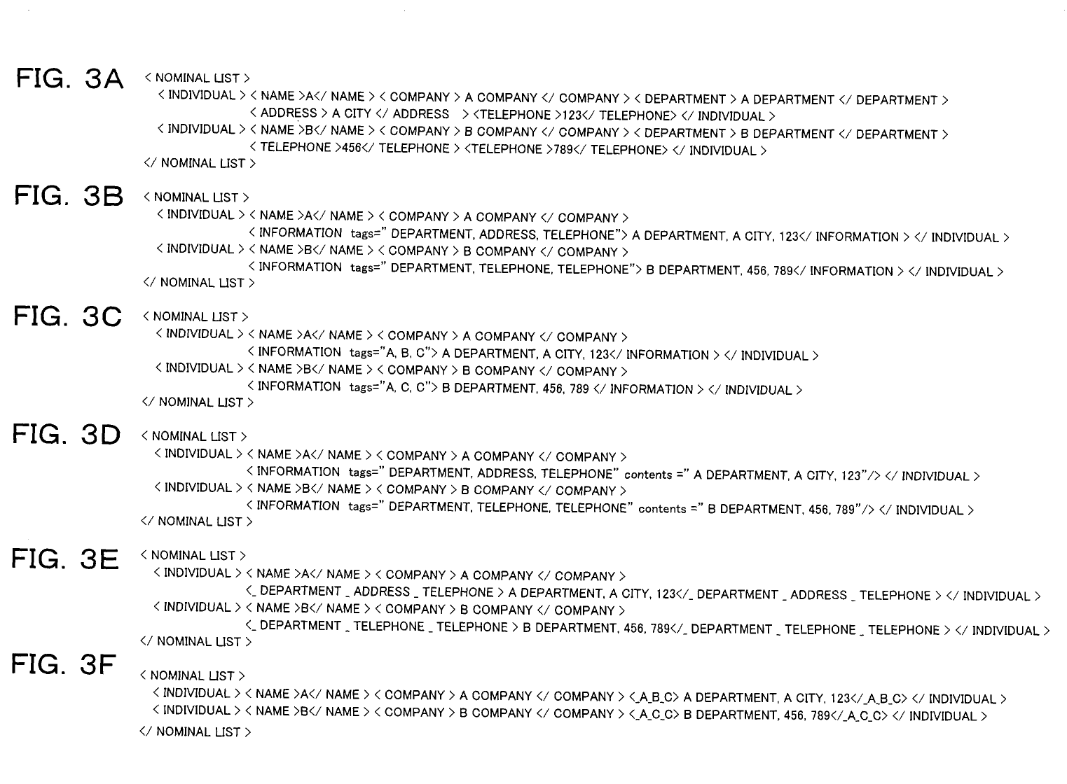

Now, the principle of a structured document converting method according to the first embodiment of this invention will be described with reference to FIGS. 1A, 1B and 3A.

An XML document to be converted shown in FIG. 3A has two records (of tag name “individual”). One record has elements of respective tag names “name”, “company”, “department”, “address” and “telephone”. The other record has elements of tag names “name”, “company” and “department”, along with two elements of one tag name “telephone”. In these two records, the kinds and the number of the elements are different, the XML document shown in FIG. 3A is thus not in a table form. A memory expansion form of the XML document shown in FIG. 3A is shown in FIG. 1A. FIG. 1A shows an example where the XML document shown in FIG. 3A is expanded as a DOM tree on a memory.

FIG. 1B shows a memory expansion form of a converted XML document obtained by applying the structured document converting method according to the first embodiment to the XML document having the above elements, in which elements of tag names “name” and “company” are key elements, whereas elements of tag names “department”, “address” and “telephone” are nonkey elements. Incidentally, the expansion form shown here is an expansion form on a memory when the converted XML document is operated by an application software through the standard API (DOM).

The converted XML document shown in FIG. 1B corresponds to an XML document to be described later with reference to FIGS. 3B through 3D. FIG. 1B shows an example where the XML document shown in FIGS. 3B through 3D is expanded as a DOM tree on the memory. In the XML document shown in FIG. 1B, a new element having a tag name “information” is created, and contents of nonkey elements of tag names “department”, “address” and “telephone” are collectively described.

In one record, “A department, A city, 123” are described as a content of an element of a tag name “information”. In the other record, “B department, 456 and 789” are described as a content of an element of a tag name “information”. Key elements of tag names “name” and “company” are described unchanged.

By converting an XML document in such a way that nonkey elements are collected into one element, it is possible to largely decrease the number of elements included in the XML document, that is, the number of child elements of a tree expanded on the memory, the nonkey elements can be collectively handled when expanded or undergone the data processing.

[1-2] System and Flow of Converting/Reversely Converting Process According to First Embodiment

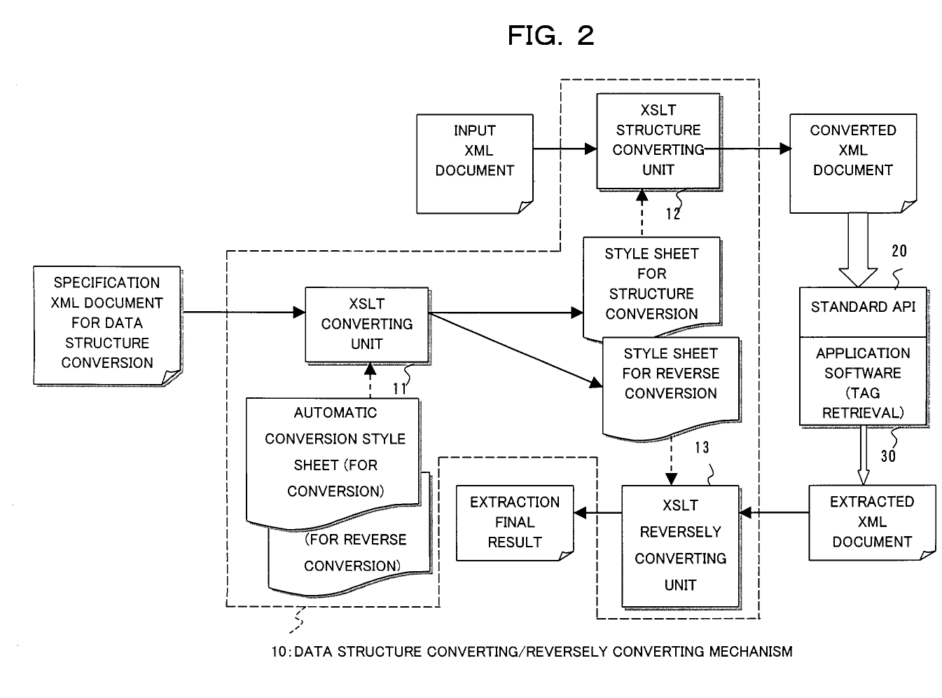

FIG. 2 is a diagram for illustrating a system to which the structured document converting method according to the first embodiment of this invention is applied, and a flow of a converting/reversely converting process in the system.

It is troublesome to create each style sheet [XSL (XML Style Language) sheet] coping with each of various kinds of XML documents.

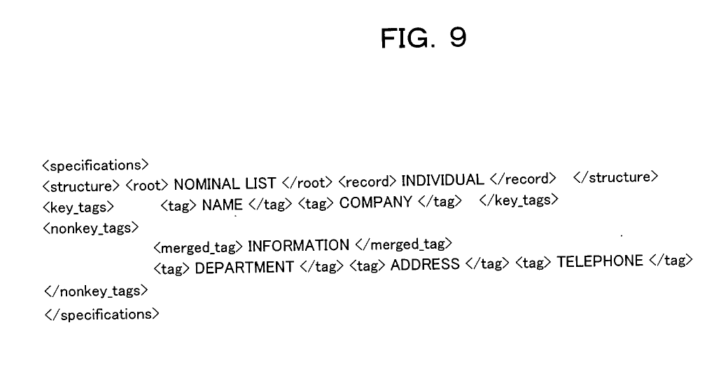

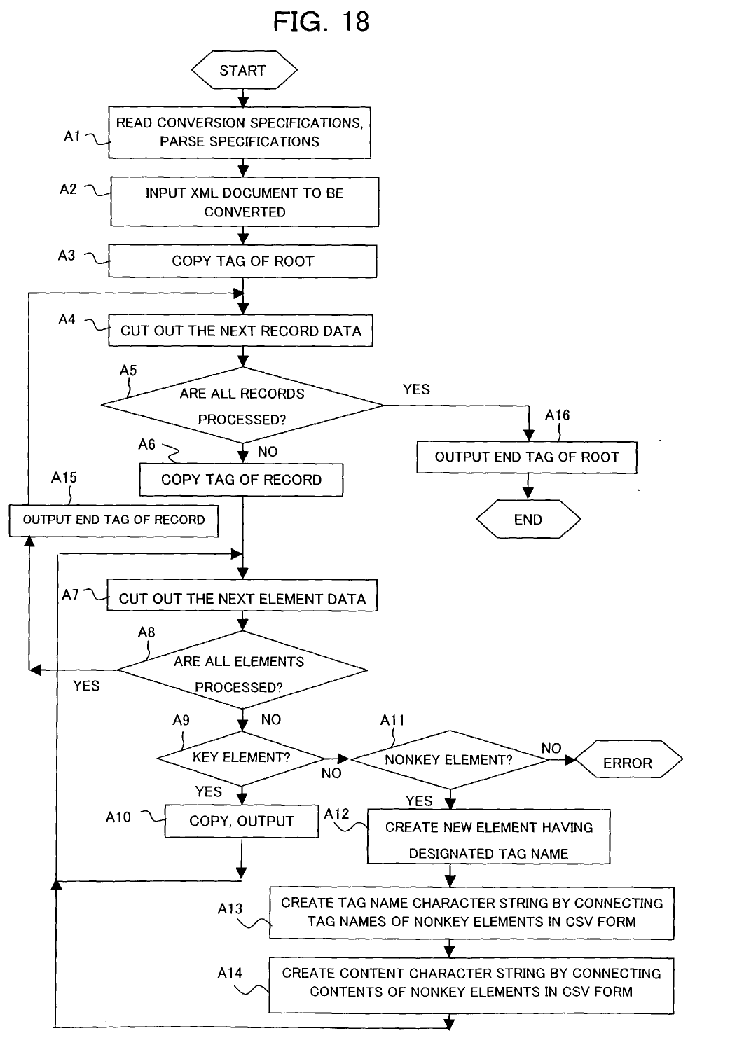

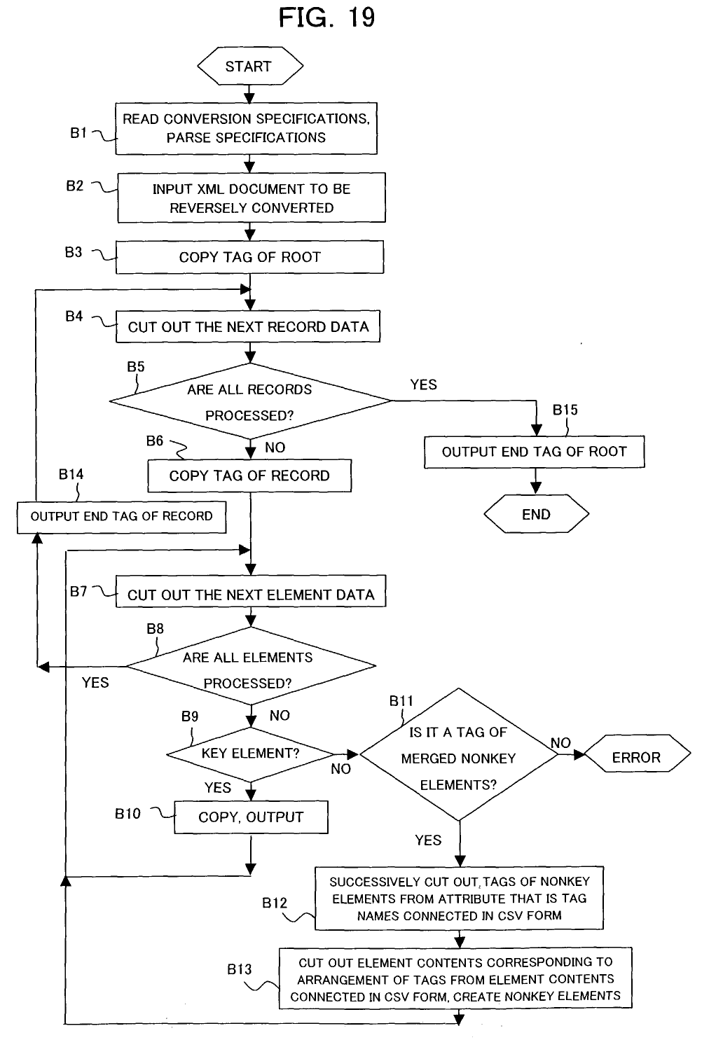

In order to save the labor, specifications (record name, key tag name, nonkey tag name, etc.) for converting the data structure of an XML document are created by an XML document (conversion specification document) to give a conversion execution procedure as will be described later with reference to FIGS. 9, 12 through 15, and 17, and conversion/reverse conversion of the XML document is executed according to the conversion specification document as will be described later with reference to FIGS. 18 and 19.

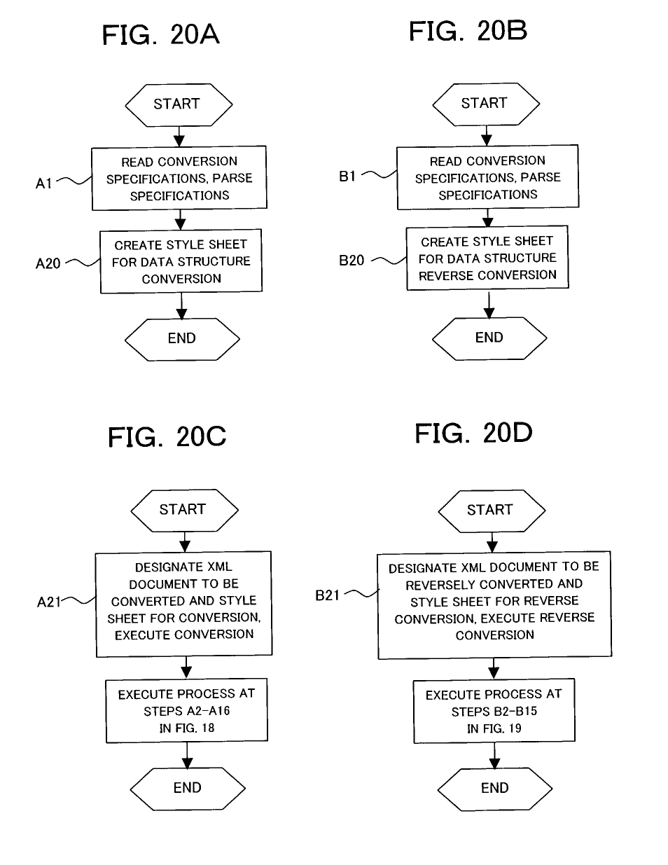

According to the first embodiment, a style sheet for conversion instructing a conversion execution procedure or a style sheet instructing a reverse conversion execution procedure is automatically created on the basis of a given conversion specification document, and a structured document converting processor [XSLT (XML Style Language Translator) processor] executes data structure conversion/reverse conversion on an XML document using the style sheet, as will be described later with reference to FIGS. 20A through 20D. Conversion/reverse conversion can be executed by a standard XSLT processor if a procedure for executing conversion/reverse conversion is given in the form of a style sheet, so that the converting/reversely converting process according to the first embodiment can be executed in almost all types of XML document systems.

A system shown in FIG. 2 comprises a data structure converting/reversely converting mechanism 10 having an XSLT converting unit 11, an XSLT structure converting unit 12 and an XSLT reversely converting unit 13, a standard API 20, and application software 30. Incidentally, the XSLT converting unit 11, the XSLT structure converting unit 12 and the XSLT reversely converting unit 13 (data structure converting/reversely converting mechanism 10) are actually realized by one standard XSLT processor (structured document converting processor).

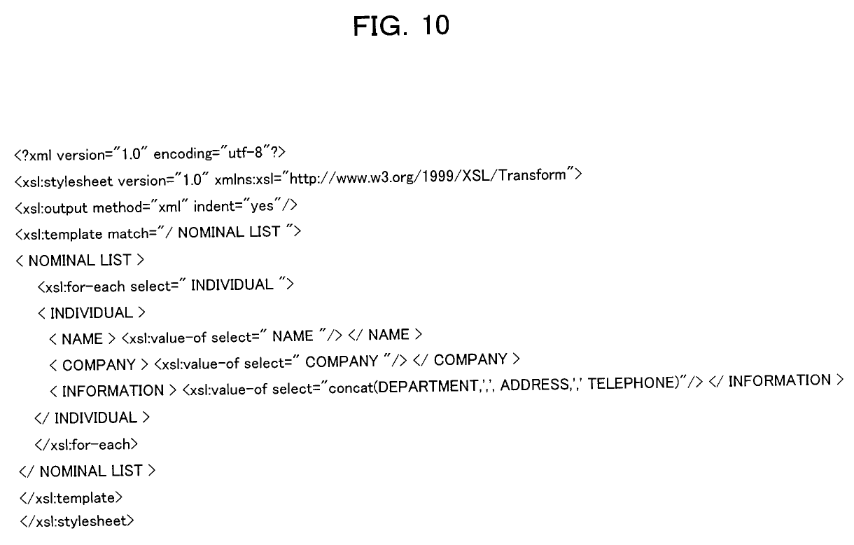

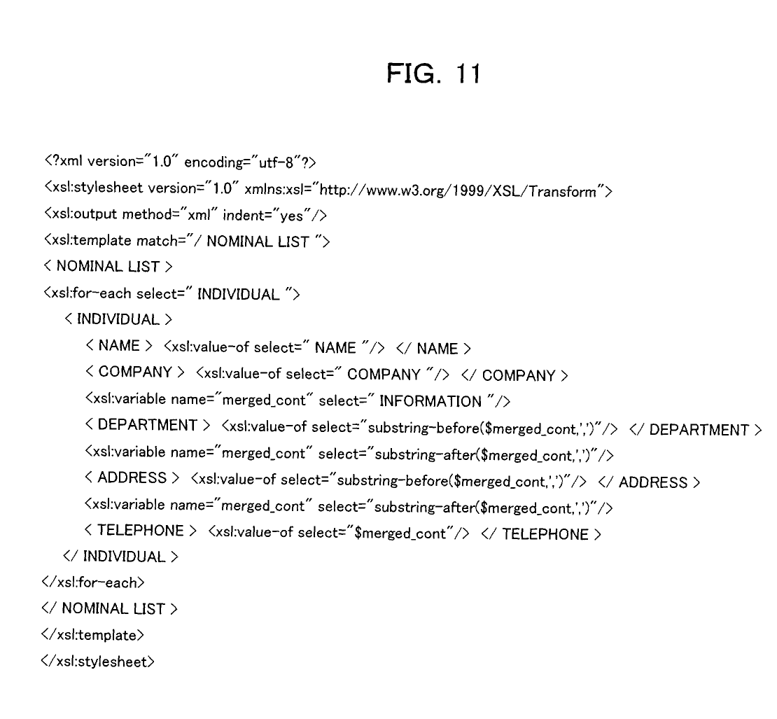

The XSLT converting unit 11 reads specifications (refer to FIG. 9, for example) for data structure conversion given by an XML document and describing discrimination information between key elements and nonkey elements, and the like, and generates a style sheet (refer to FIG. 10, for example) for structure conversion and a style sheet (refer to FIG. 11, for example) for reverse conversion with the XML document and automatic conversion style sheets.

The XSLT structure converting unit 12 reads an XML document (input XML document) to be converted, and performs data structure conversion on the inputted XML document on the basis of a style sheet for structure conversion generated by the XSLT converting unit 11 to collect nonkey elements in each record into one element.

The standard API 20 and the application software (application) 30 are executed by a processor to perform predetermined data processing on the converted XML document from the XSLT structure converting unit 12. As the processor, an XSLT processor for realizing the data structure converting/reversely converting mechanism 10 may be used, or another processor other than the XSLT processor may be used.

The XSLT reversely converting unit 13 reads the XML document (extracted XML document, converted XML document) processed by the application software 30, executes reverse conversion on the basis of a style sheet for reverse conversion generated by the XSLT converting unit 11 to restore the extracted XML document to an XML document in the original form (XML document in which nonkey elements are restored to the original state), and outputs a result of restoration as a final result of extraction.

In the system having the above structure, the data structure converting/reversely converting mechanism (XSLT processor) 10 reads a conversion specification document for an XML document, reads an input XML document to be processed, converts the input XML document on the basis of conversion specifications (actually, a style sheet for structure conversion), and outputs an XML document undergone predetermined data structure conversion. The application software 30 performs data processing (tag-dependent content retrieval, for example) on the converted XML document through the standard API 20, and an XML document undergone the data processing is obtained. When tag-dependent content retrieval is performed as the data processing, a result of the retrieval is obtained in the form of an extracted XML document. The extracted XML document is read into the data structure converting/reversely converting mechanism 10, reversely converted into an XML document having the original data structure on the basis of a conversion specifications (actually, a style sheet for reverse conversion), and an XML document is obtained as a final result of the data processing.

In the first embodiment, a specification XML document for data structure conversion to be read into the XSLT converting unit 11 will be described later with reference to FIGS. 9, 12 through 15, and 17. A style sheet for structure conversion and a style sheet for reverse conversion generated by the XSLT converting unit 11 will be described later with reference to FIGS. 10 and 11, respectively.

[1-3] Method of Converting Non-Table Form XML Document and Practical Examples of Conversion According to First Embodiment

When the converting method according to the first embodiment is applied to an XML document (non-table form XML document) which is not in the table form, a tag name character string including tag names of nonkey elements, and a content character string including contents of the nonkey elements are created, and these character strings are described as an element content, a tag name or an attribute value in an element newly created.

At this time, the tag name character string is created by connecting tag names of a plurality of nonkey elements via delimiters. Similarly, the content character string is created by connecting contents of a plurality of nonkey elements via delimiters. In the first embodiment, a comma “,” is used as the delimiter.

As a way of connecting tag names or contents, here is used CSV (Comma Separated Values) form. CSV is originally a method of connecting numeral values or character strings via comma, where the delimiter is limited to comma. According to this invention, the delimiter is not limited to only comma.

When comma is used as the delimiter, there is possibility that it is confused with a comma representing the thousand's place when a content of an element is an amount of money. For this, “@” (“at” mark) or “_” (under bar) is used rather than comma. If the delimiter is included as a character in a character string when the character string is connected via the delimiter, the character may be replaced with the form of entity reference. For example, a comma in a character string in the case where comma is used as the delimiter, it is replaced with “&CMM;” which is entity reference description. Therefore, it is desirable to use a character rarely appearing in general character strings as the delimiter. In this embodiment, a manner of connecting numeral values or character strings via not only comma but also delimiter is called CSV, for the sake of convenience.

FIGS. 3B through 3F show first to fifth practical examples that are results of conversion obtained by applying the structured document converting method according to the first embodiment to the above-described XML document not in the table form shown in FIG. 3A. Here, elements of tag names “name” and “company” are key elements, whereas elements of tag names “department”, “address” and “telephone” are nonkey elements.

In the converting method according to the first embodiment, basically, elements constituting an XML document to be converted are separated into key elements that are objects of data processing and nonkey elements that are not objects of the data processing, a new element is created, tag name conversion and content conversion are performed on the nonkey elements, while the key elements are described unchanged without any conversion in a converted XML document.

In the first practical example shown in FIG. 3B, a new element given a tag name “information” and an attribute name “tags” is created, a tag name character string of nonkey elements is created in CSV form by tag name conversion, and the tag name character string is described as an attribute value corresponding to the attribute name “tags” in the new element. By content conversion, a content character string of the nonkey elements is creased in CSV form, and the content character string is described as a content of a new element.

Namely, in the first record of the converted XML document shown in FIG. 3B, a content character string of “A department,A city,123” is described as an element content, while a tag name character string of “department,address,telephone” is described as an attribute value of an attribute name “tags” in an element of a tag name “information”. In the second record, a content character string of “B department, 456, 789” is described as an element content, while a tag name character string of “department, telephone, telephone” is described as an attribute value of an attribute name “tags” in an element of a tag name “information”.

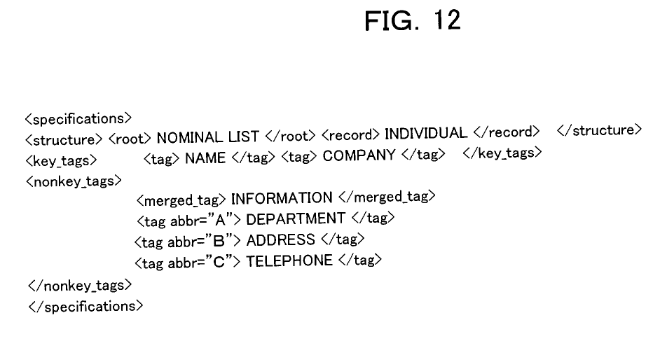

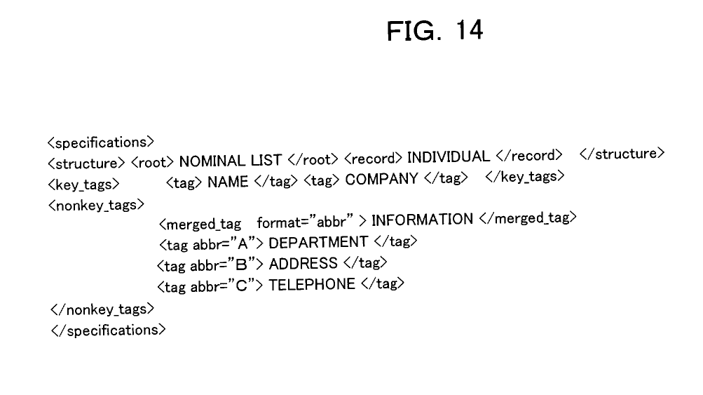

At this time, a tag name of the nonkey element may be related with an abbreviated tag name that is shorter than the tag name and can specify the same and described in a conversion specification document, as will be described later with reference to FIG. 12 or 14, and tag name abbreviating conversion may be performed to replace the tag name of the nonkey element with an abbreviated tag name on the basis of the conversion specification document when the above tag name conversion is performed. When an XML document undergone such the tag name abbreviating conversion is restored to the original state (at the time of reverse conversion), tag name expanding conversion is performed to replace the abbreviated tag name to the tag name of the nonkey element on the basis of the conversion specification document.

In the second practical example shown in FIG. 3C, there is shown a resulting XML document from the above tag name abbreviating conversion performed on the XML document shown in FIG. 3B. Namely, the tag names “department”, “address” and “telephone” are related with abbreviated tag names “A”, “B” and “C”, respectively, in the conversion specification document (refer to FIG. 12 or 14), whereby the tag name character string described as an attribute value of an attribute name “tags” in the first record is replaced with “A,B,C” in the first record. Similarly, in the second record, a tag name character string described as an attribute value of an attribute name “tags” is replaced with “A,C,C”.

In the third practical example shown in FIG. 3D, a new element given a tag name “information”, the first attribute name “tags” and the second attribute name “contents” is created, a tag name character string of nonkey elements is created in CSV form by tag name conversion, and the tag name character string is described as the first attribute value corresponding to the first attribute name “tags” in the new element. By content conversion, a content character string of the nonkey elements is created in CSV form, and the content character string is created as the second attribute value corresponding to the second attribute name “contents” in the new element. In this case, the new element is described as an empty element tag.

In the first record of the converted XML document shown in FIG. 3D, a content character string “A department,A city, 123” is described as the second attribute value of the second attribute name “contents”, and a tag name character string “department,address,telephone” is described as the first attribute value of the first attribute name “tags” in the element of a tag name “information”. In the second record, a content character string “B department,456,789” is described as the second attribute value of the second attribute name “contents”, and a tag name character string “department, telephone, telephone” is described as the first attribute value of the first attribute name “tags” in the element of a tag name “information”. At this time, tag name abbreviating conversion similar to the above may be performed on a tag name character string described as the first attribute value, like the second practical example shown in FIG. 3C.

In the fourth practical example shown in FIG. 3E, a tag name character string of nonkey elements is created in CSV form by tag name conversion, and a new element given the tag name character string as a tag name is created. By content conversion, a content character string of the nonkey elements is created in CSV form, and the content character string is described as a content of the new element.

In the first record of the converted XML document shown in FIG. 3E, a content character string “A department,A city, 123” is described as an element content in an element of a tag name “department,address,telephone”. In the second record, a content character string “B department, 456,789” is described as an element content in an element of a tag name “department,telephone,telephone”.

In the fifth practical example shown in FIG. 3F, there is shown a resulting XML document from tag name abbreviating conversion similar to the above performed on the XML document shown in FIG. 3E. Namely, tag names “department”, “address” and “telephone” are related with abbreviated tag names “A”, “B” and “C”, respectively, in a conversion specification document (refer to FIG. 12 or 14), whereby a tag name character string described as a tag name of a new element is replaced with “A,B,C”. Similarly, a tag name character string described as a tag name of a new element is replaced with “A,C,C” in the second record.

When a method of inserting a tag name character string in CSV form as an attribute value in a start tag of a new element as shown in FIG. 3B is employed, the amount of data is decreased by the amount of a reduced portion of an end tag, as compared with when a tag name character string in CSV form is inserted in a start tag of a new element as shown in FIG. 3E. Instead, when the former method is employed, one attribute describing a tag name character string in CSV form is increased. In the XML documents shown in FIGS. 3B and 3E, the amount of data can be decreased by performing the above tag name abbreviating conversion as shown in FIGS. 3C and 3F.

According to the converting method of the first embodiment, a plurality of nonkey elements are collected into one element, so that the nonkey elements can be handled as elements having no connection with data processing while the application software executes the data processing. Whether a tag name character string created by connecting tag names of nonkey elements in CSV form is described as the tag name of a new element or described as the attribute value of a new element can be selected and designated in a conversion specification document or the like. Whether a content character string created by connecting element contents of nonkey elements in CSV form is described as the attribute value of a new element or described as the content of a new element can be selected and designated in a conversion specification document or the like, as well. Which one of the various methods described above with reference to FIGS. 3B through 3F is employed is determined according to the amount of data of an XML document or how many new elements are increased due to the data processing. From a viewpoint of the nature of this invention that nonkey elements are collectively handled, any method can be employed.

[1-4] Method of Converting Table-form XML Document and Practical Examples of Conversion According to First Embodiment

When the converting method according to the first embodiment is applied to a table-form XML document, a content character string including contents of nonkey elements is created, and the content character string is descried as the element content or the attribute value of a newly created element. Namely, when the converting method according to the first embodiment is applied to a table-form XML document, element description in each record in a table-form XML document has regularity, so that tag name conversion (or attribute name conversion to be described later) performed in an XML document not in the table form can be omitted.

In which case, information for discriminating between the key elements and the nonkey elements is described, and tag names of the nonkey elements (including their attribute names when having attributes; refer to item [1-5]) is related with a representative tag name (tag name of a new element) representing the tag names or the attribute names, and described in a conversion specification document, as will be described later with reference to FIG. 9. At the time of data structure conversion based on the conversion specification document, table-form conversion that omits the above tag name conversion and carries out only the above content conversion is performed on an XML document to be converted. At the time of reverse conversion, table-form reverse conversion that deduces tag names and attribute names of the nonkey elements from the representative tag name (tag name of the new element) on the basis of the conversion specification document, and restores the description of the nonkey elements to the original state is performed on an XML document (XML document undergone data processing) undergone the above table-form conversion.

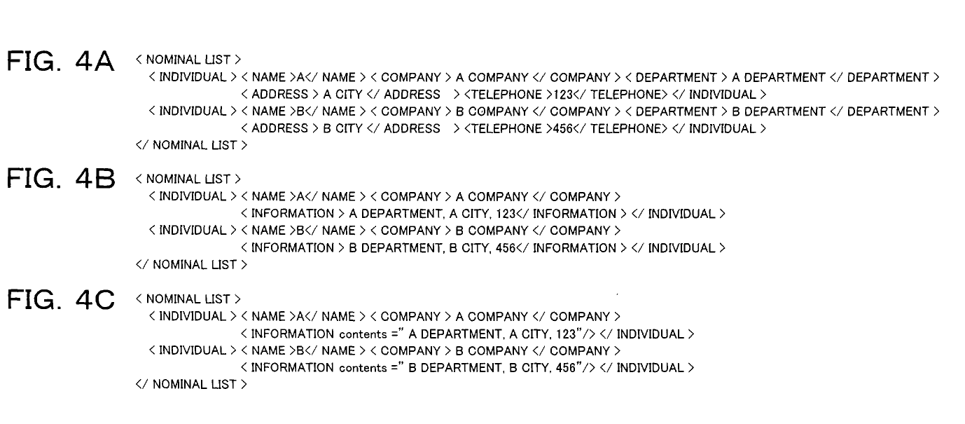

Now, practical results of conversion of a table-form XML document will be described with reference to FIGS. 4A through 4C.

An XML document that is an object of conversion shown in FIG. 4 has two records (tag names “individual”) and each of these records has elements of respective tag names “name”, “company”, “department”, “address” and “telephone”. Namely, these two records have the same kinds and the same number of elements. The XML document shown in FIG. 4A is in the table form.

FIGS. 4B and 4C show first and second practical examples of conversion obtained by applying the structured document converting method according to the first embodiment to the table-form XML document shown in FIG. 4A. Here, elements of tag names “name” and “company” are key elements, while elements of tag names “department”, “address” and “telephone” are nonkey elements.

When the converting method according to the first embodiment is applied to a table-form XML document, a representative tag name (tag name of a new element) is related with tag names “department”, “address” and “telephone” of nonkey elements in a conversion specification document as described above, elements constituting an XML document to be converted are separated into key elements that are objects of data processing on the XML document and nonkey elements that are not objects of the data processing, a new element is created, and content conversion is performed on the nonkey elements, whereas the key elements are described unchanged in a converted XML document without any conversion.

In a first practical example shown in FIG. 4B, a new element given a representative tag name “information” is created, a content character string of nonkey elements is created in CSV form by content conversion, and the content character string is described as the content of the new element.

Namely, in the first record of the converted XML document shown in FIG. 4B, a content character string “A department,A city,123” is described as an element content in an element of a tag name “information”. In the second record, a content character string “B department,B city,456” is described as an element content in an element of a tag name “information”. Incidentally, an XML document shown in FIG. 4B is obtained by converting the XML document shown in FIG. 4A according to a conversion specification document to be described later with reference to FIG. 9.

In a second practical example shown in FIG. 4C, a new element given a tag name “information” and an attribute name “contents” is created, a content character string of nonkey elements is then created in CSV form by content conversion, and the content character string is described as an attribute value corresponding to the attribute name “contents” of the new element. In this case, the new element is described as an empty element tag.

In the first record of a converted XML document shown in FIG. 4C, a content character string “A department,A city, 123” is described as the attribute value of an attribute name “contents” in an element of a tag name “information”. In the second record, a content character string “B department, B city, 456” is described as the attribute value of an attribute name “contents” in an element of a tag name “information”.

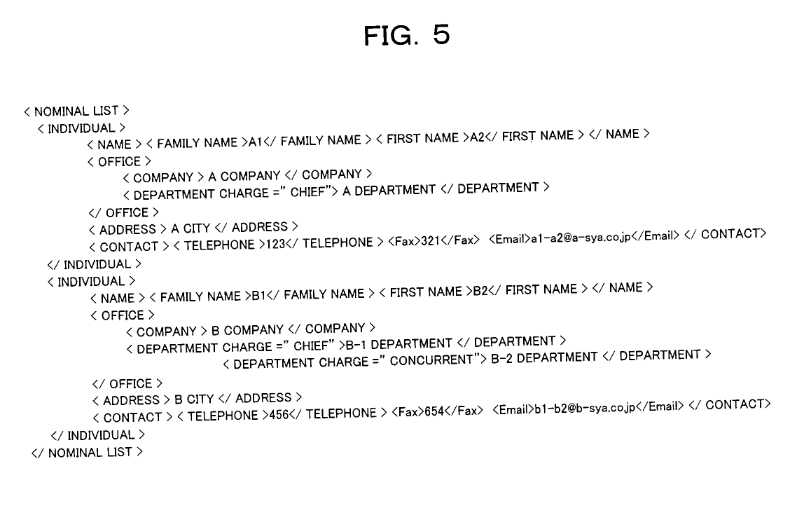

When an XML document to be converted is described in the table form as above, it is possible to readily know a tag name (including an attribute name when having an attribute) at the time of reverse conversion for restoring it to the original XML document. It is thereby possible to omit tag name conversion or attribute name conversion (attribute name conversion being going to be described later with reference to FIGS. 5 through 8). When a table-form XML document is converted, only description of a content character string of nonkey elements is sufficient, it is thus possible to omit description of tag names or attribute names.

[1-5] Method of Converting XML Document Having Hierarchical Structure and Attribute, and Practical Examples of Conversion According to First Embodiment

Having been described the case where nonkey elements in each record are in a single hierarchical layer and without attribute. The converting method according to the first embodiment can be also applied to the case where nonkey elements are in a plurality of hierarchical layers (when hierarchy is deep) by extending the above principle.

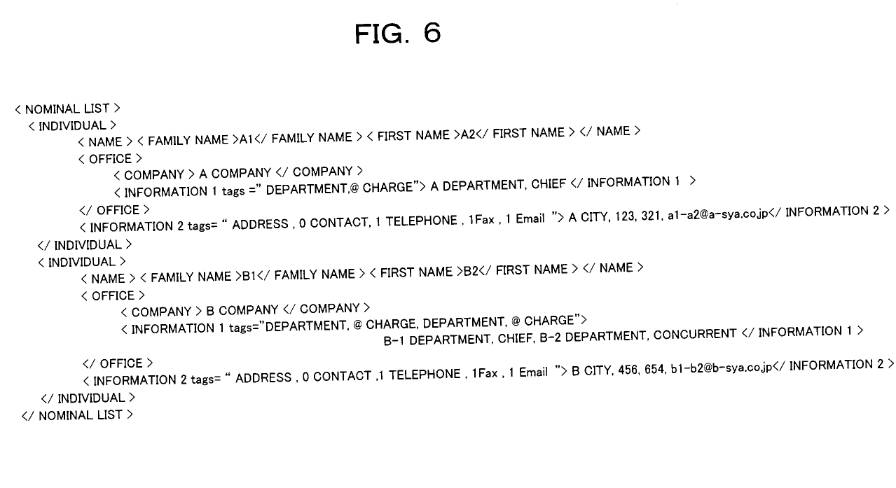

When nonkey elements are in a plurality of hierarchical layers, hierarchical structure identification information (a symbol or a character string; refer to FIGS. 6 through 8) representing that the nonkey elements are in a plurality of hierarchical layers is added to a tag name of each of the nonkey elements configuring the plural hierarchical layers in a tag name character string obtained by the above tag name conversion, according to the converting method of the first embodiment.

When a nonkey element has an attribute, attribute name identification information (a symbol; @, for example; refer to FIGS. 6 through 8) representing that a character string is an attribute name is added to the character string of the attribute name, according to the converting method of the first embodiment. In a tag name character string obtained by the above tag name conversion, an attribute name to which attribute name identification information is added as above is described after a tag name of a nonkey element having an attribute via a delimiter (comma, for example). In a content character string obtained by the above content conversion, an attribute value of the attribute is described after a content of a nonkey element having the attribute via a delimiter (comma, for example).

In a content character string, the attribute value is described at a position corresponding to a position of description of the attribute name in a tag name character string. Namely, a tag name character string and a content character string both connected in CSV form are created while a one-to-one relationship between a tag name and an attribute name of a nonkey element is kept, and an element content and an attribute content (attribute value) of the same is kept, and the tag name character string and the content character string are described in an XML document.

When a nonkey element has an attribute in a table-form XML document having the same kind and the same number of elements in each record, a conversion specification document is created, in which the tag name and the attribute name of the nonkey element are related with a representative tag name (tag name of a new element) representing tag names and attribute names. In a content character string of the new element in the converted XML document, element contents and attribute contents (attribute values) are described in an order correspondingly to the order of descriptions of the tags and attribute names in the conversion specification document.

Now, practical results of conversion of an XML document having a hierarchical structure and attributes will be described with reference to FIGS. 5 through 8.

An XML document to be converted shown in FIG. 5 has two records (tag names “individual”). Each of the records has each of elements of respective tag names “name”, “office”, “address” and “contact”. An element of a tag name “office” has elements of tag names “company” and “department” in a hierarchical structure. An element of a tag name “department” has an attribute of an attribute name “charge”. Incidentally, the first record has one element of a tag name “department”, whereas the second record has two elements of tag names of “department”. An element of a tag name “contact” has elements of tag names “telephone”, “fax” and “Email” in a hierarchical structure.

FIGS. 6 through 8 show first to third practical examples of results of conversion obtained by applying the structured document converting method according to the first embodiment to the XML document shown in FIG. 5. Here, elements of tag names “name” and “company” are key elements, and elements other than these are nonkey elements. Since an element of a tag name “office” has a hierarchical structure containing an element of a tag name “company”, an element of a tag name “office” is handled as a key element.

In the first concrete example shown in FIG. 6, the first new element given a tag name “information 1” and an attribute name “tags” is created in an element of a tag name “office,” and the second new element given a tag name “information 2” and an attribute name “tags” is created in the same hierarchical layer as the element of a tag name “name” or a tag name “office” in each record.

In an element of a tag name “information 1” in the first record, a tag name character string “department,@charge” is described as the attribute value of an attribute name “tags”, and a content character string “A department, chief” is described as the attribute content. In an element of a tag name “information 2” in the first record, a tag name character string “address,0contact,1telephone,1fax,1Email” is described as the attribute value of an attribute name “tags”, and a content character string “A city, 123,321,a1-a2@a-sya.co.jp” is described as the element content.

Similarly, in an element of a tag name “information 1” in the second record, a tag name character string “department,@charge,department,@charge” is described as the attribute value of an attribute name “tags”, and a content character string “B-1 department, chief,B-2 department, concurrent” is described as the element content. In an element of a tag name “information 2” in the second record, a tag name character string “address,0contact,1telephone,1fax,1Email” is described as the attribute value of an attribute value “tags, and a content character string “B city,456,654,b1-b2@b-sya.co.jp” is described as the element content.

Here, “@” added to the head of “charge” is attribute name identification information, which is information representing that “charge” is an attribute name. “0” added to the head of “contact” or “1” added to the head of “telephone”, “fax” or “Email” is hierarchical structure identification information, which represents that the element of a tag name added “1” thereto is in a lower hierarchical layer (an element included in an element content) of an element of a tag name added “0” thereto.

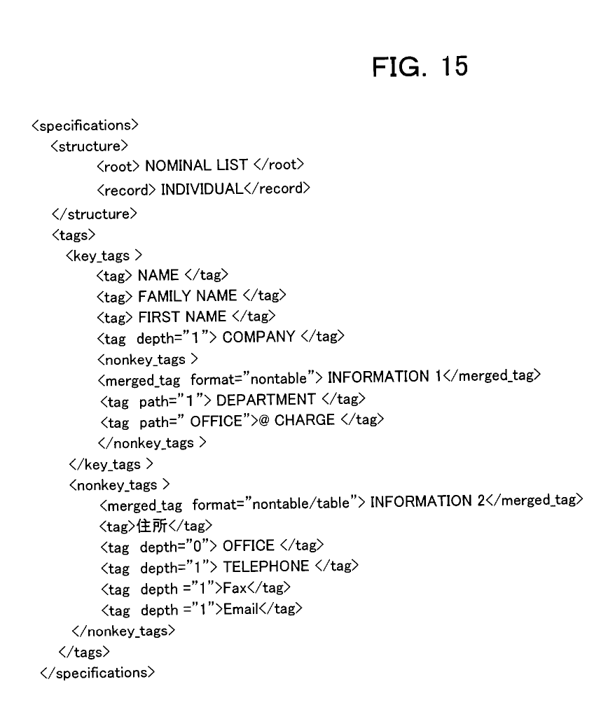

The XML document shown in FIG. 6 is obtained by converting the XML document shown in FIG. 5 according to a conversion specification document to be described later with reference to FIG. 15. Particularly, the XML document shown in FIG. 6 is obtained by setting “nontable” (signifying that this is not in the table form) as table form information of “information 1” and “information 2“in a conversion specification document shown in FIG. 15. Namely, in the example shown in FIG. 6, elements of tag names “address” and “contact” are of the same kind and the same number of elements in each record, so that the document can be handled as in the table form. However, “nontable” is set as the table form information, whereby the elements of tag names “address” and “contact” are handled as not in the table form.

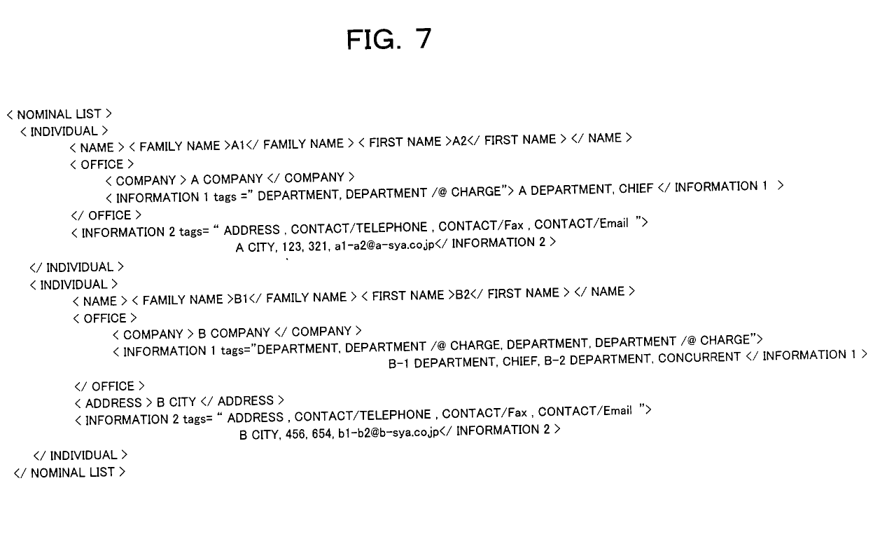

In the second practical example shown in FIG. 7, the first new element given a tag name “information 1” and an attribute name “tags” is created in the element of a tag name “office”, and the second new element given a tag name “information 2” and an attribute name “tags” is created in the same hierarchical layer as the elements of a tag name “name” and a tag name “office” in each record, like the example shown in FIG. 6.

In the element of a tag name “information 1” in the first record, a tag name character string “department,department/@charge” is described as the attribute value of an attribute name “tags”, and a content character string “A department,chief” is described as the element content, like the example shown in FIG. 6. In the second practical example shown in FIG. 7, in the element of a tag name “information 2” in the first record, a tag character string “address,contact/telephone,contact/fax,contact/Ema il” is described as the attribute value of an attribute name “tags”, and a content character string “A city,123,321,a1-a2@2-sya.co.jp” is described as the element content.

Similarly, in the element of a tag name “information 1” in the second record, a tag name character string “department, department/@charge,department, department/@charge” is described as the attribute value of an attribute name “tags”, and a content character string “B-1 department, chief, B-2 department, concurrent” is described as the element content. In the element of a tag name “information 2” in the second record, a tag name character string “address,contact/telephone,contact/fax,contact/Ema il” is described as the attribute value of an attribute name “tags”, and a content character string “B city,456,654,b1-b2@b-sya.co.jp” is described as the element content.

Here, a character string “contact/” added to the head of each of “telephone,” “fax,” or “Email” is hierarchical structure identification information, which represents that an element of a tag name added a character string “contact/” thereto is in a lower hierarchical layer (an element included in an element content) of an element of a tag name “contact.”Notation of the hierarchical position is known as XPath.

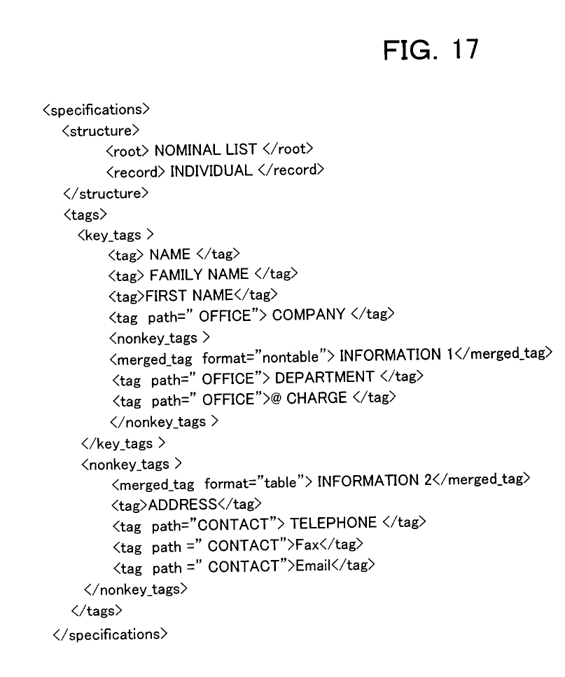

The XML document shown in FIG. 7 is obtained by converting the XML document shown in FIG. 5 according to a conversion specification document to be described later with reference to FIG. 17. Particularly, the XML document shown in FIG. 7 is obtained by setting “nontable” (representing that this is not in the table form) as the table form information on “information 1” and “information 2” in the conversion specification document shown in FIG. 17. In other words, in the example shown in FIG. 7, the elements of tag names “address” and “contact” can be handled as in the table form, but the elements of tag names “address” and “communication” are handled as not in the table form by setting “nontable” as the table form information.

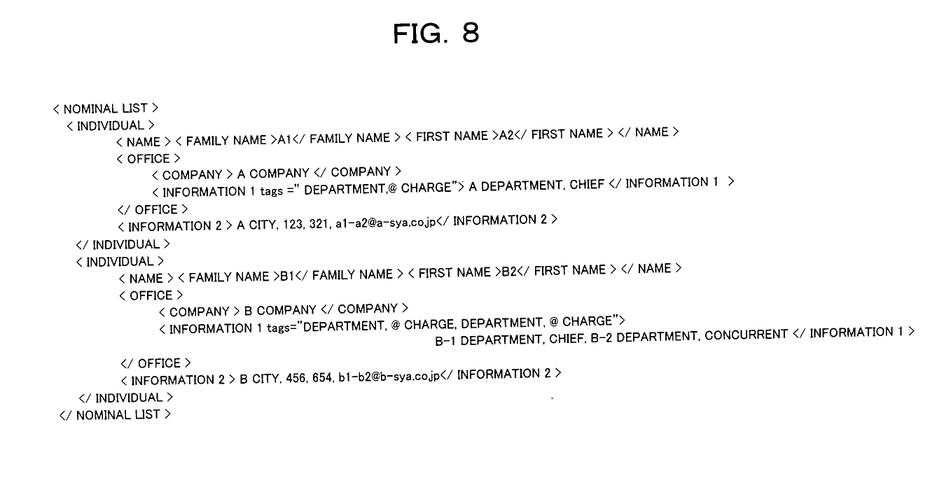

In the third practical example shown in FIG. 8, the first new element given a tag name “information 1” and an attribute name “tags” is created, and the second new element given a tag name “information 2” is created in the same hierarchical layer as the elements of tag names “name” and “office” in each record.

In the element of a tag name “information 1” in the first record, a tag name character string “department,department/@charge” is described as the attribute value of an attribute name “tags”, and a content character string “A department,chief” is described as the element content. By handling the elements of tag names “address” and “contact” as in the table form, a content character string “A city,123,321,a1-a2@a-sya.co.jp” is described as the element content in the element of a tag name “information 2” in the first record.

Similarly, in the element of a tag name “information 1” in the second record, a tag name character string “department,@charge,department, @charge” is described as the attribute value of an attribute name “tags,” and a content character string “B-1 department, chief, B-2 department,concurrent” is described as the element content. In the element of a tag name “information 2” in the second record, a content character string “B city,456,654,b1-b2@b-sya.co.jp” is described as the element content.

The XML document shown in FIG. 8 is obtained by converting the XML document shown in FIG. 5 according to a conversion specification document to be described later with reference to FIG. 15 or 17. Particularly, the XML document shown in FIG. 8 is obtained by setting “nontable” (representing that this is not in the table form) as the table form information on “information 1” and setting “table” (representing that this is in the table form) as the table form information on “information2” in a conversion specification document shown in FIG. 15 or 17.

Meanwhile, in each of the XML documents shown in FIGS. 6 through 8, key elements are described unchanged without any conversion, of course.

[1-6] Practical Examples of Conversion Specification Document and Style Sheet According to First Embodiment

[1-6-1] Conversion Specification Document and Style Sheet for Table-form Data

FIG. 9 shows a practical conversion specification document (XML document) used when the table-form XML document shown in FIG. 4A is converted.

In the conversion specification document shown in FIG. 9, a tag name “nominal list” of root and a tag name “individual” of record are described. Additionally, tag names “name” and “company” are described as the content of an element of a tag name “key_tags”, tag names “department”, “address” and “telephone” of nonkey elements are described as the content of an element of a tag name “nonkey_tags”, whereby information used to discriminate between key elements and nonkey elements is described. The content of the element of a tag name “nonkey_tags” includes an element of a tag name “merged_tag”, and a new element of a tag name (representative tag name) “information” is described as the content of this element to collect the nonkey elements. A conversion specification document as this gives a data structure conversion execution procedure for the XML document.

The XSLT converting unit 11 shown in FIG. 2 reads the conversion specification document shown in FIG. 9, and generates a style sheet for structure conversion (XSL sheet) shown in FIG. 10 and a style sheet for reverse conversion (XSL sheet) on the basis of the conversion specification document and an automatic conversion style sheet (automatic conversion XSL sheet; not shown). The style sheet for structure conversion shown in FIG. 10 is read by the XSLT structure converting unit 12, and used to perform data structure conversion on an XML document (input XML document) to be converted. The style sheet for reverse conversion shown in FIG. 11 is read by the XSLT reversely converting unit 13, and used to restore an XML document (extracted XML document, converted XML document) processed by the application software 30 to an XML document in the original form (XML document in which nonkey elements are restored to the original state).

When an XML document to be converted is table-form data, tag names of nonkey elements are related with a tag name (representative tag name) of a new element according to a style sheet for conversion/reverse conversion, thus do not appear in the converted XML document. Accordingly, it is possible to largely decrease the amount of data of an XML document after converted. Namely, if a conversion specification document and an automatic conversion style sheet are both prepared, or a style sheet for structure conversion/reverse conversion is prepared, tag names of nonkey elements becomes basically unnecessary in a converted XML document. When a style sheet as above is not prepared, it is possible to restore an XML document to the original XML document on the basis of regularity of arrangement of elements only by handling it as in the non-table form even if the XML document is in the table form.

[1-6-2] Conversion Specification Document for Tag Name Abbreviating Conversion

FIG. 12 shows a practical conversion specification document (XML document) for tag name abbreviating conversion according to the first embodiment of this invention. In the conversion specification document shown in FIG. 12, the relationships between tag names “department”, “address” and “telephone” and abbreviated tag names “A”, “B” and “C” are described for the purpose of tag name abbreviating conversion, so that the tag names “department”, “address” and “telephone” of nonkey elements in an XML document to be converted are replaced with abbreviated tag names “A”, “B” and “C”, respectively, in the converted XML document, as shown in FIG. 3C, for example. In the conversion specification document shown in FIG. 12, there are the similar descriptions to those in the conversion specification document shown in FIG. 9. However, in the conversion specification document shown in FIG. 12, each abbreviated tag name is related by “abbr” attribute of a tag name of each of nonkey elements of a tag name “nonkey_tags”, and described.

[1-6-3] Conversion Specification Document for Designating Table Form/Nontable Form

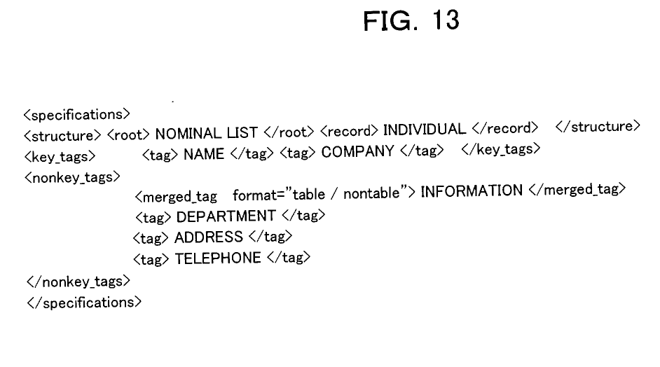

FIG. 13 shows a practical example of a conversion specification document having a function of designating a data form (table form or not) according to the first embodiment. In the conversion specification document shown in FIG. 13, there is description of the table form information on whether an XML document (nonkey elements) to be converted should be described in the table form or not. Namely, in the conversion specification document shown in FIG. 13, table form information is added as “format” attribute in the element of a tag name “merged_tag”, although there are similar descriptions to those in the conversion specification document shown in FIG. 9. When the table form is designated, “table”, for example, is described as the “format” attribute value. When nontable form is designated, “nontable”, for example, is described as the “format” attribute value.

When “table” is described as the “format” attribute value in the conversion specification document, the XSLT structure converting unit 12 shown in FIG. 2 executes a converting process (process of performing only content conversion, omitting tag name conversion) coping with the table form, and the XSLT reversely converting unit 13 shown in FIG. 2 executes reverse conversion coping with the table form. Conversely, when “nontable” is described as the “format” attribute value in the conversion specification document, the XSLT structure converting unit 12 shown in FIG. 2 executes a converting process (process performing both tag name conversion and content conversion), and the XSLT reversely converting unit 13 shown in FIG. 2 executes reverse conversion coping with the nontable form.

Accordingly, the end user can designate in a conversion specification document described in XML whether an XML document to be converted is in the table form or not using the “format” attribute. It is possible to instruct whether table-form conversion be performed or not, that is, which table-form conversion or nontable-form conversion be performed, using the “format” attribute, and automatically switch between execution and non-execution of table-form conversion or nontable-form conversion, that is, between table-form conversion/reverse conversion and nontable-form conversion/reverse conversion.

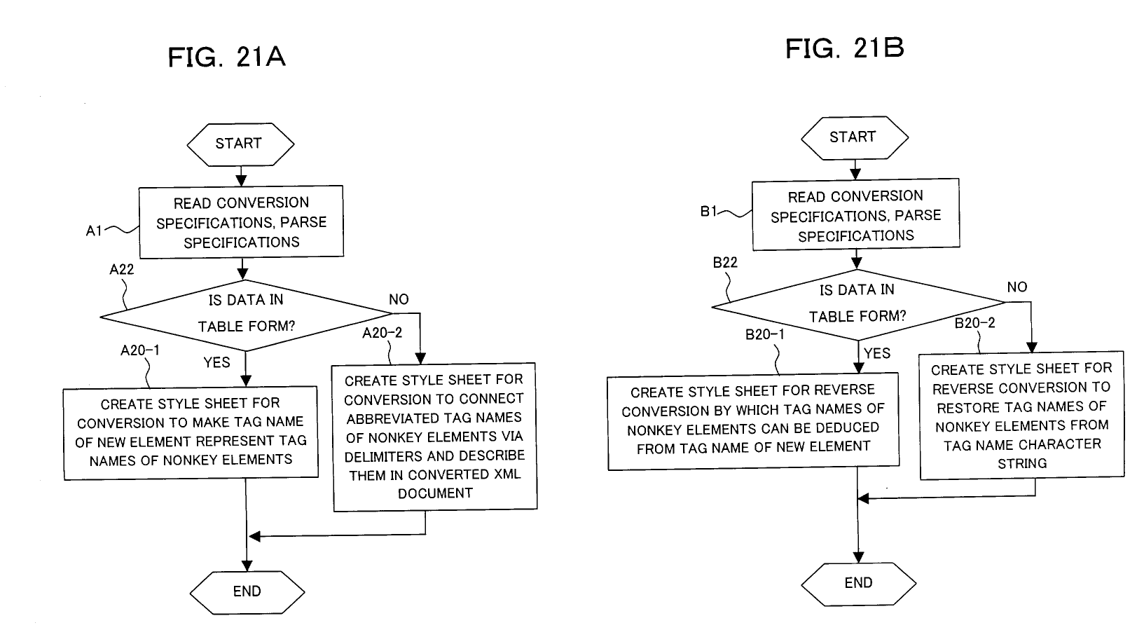

The above “format” attribute as the table form information is referred when it is determined whether the XSLT converting unit 11 shown in FIG. 2 creates a style sheet for structure conversion/reverse conversion coping with table-form data or a style sheet for structure conversion/reverse conversion coping with nontable-form data, as will be described later with reference to FIGS. 21A and 21B.

When a portion in the table form and a portion in the nontable form mix in one XML document to be converted, the table form information is designated by the “format” attribute in each element of a tag name “merged_tag” as shown in FIGS. 15 and 17, for example, whereby table-form conversion is performed on the portion in the table form, whereas nontable-form conversion is performed on the portion in the nontable form, as shown in FIG. 8, for example.

[1-6-4] Conversion Specification Document for Designating Execution/Non-execution of Abbreviating Conversion

FIG. 14 shows a practical example of a conversion specification document (XML document) having a function of designating the data form (representing whether tag name abbreviating conversion should be performed or not) according to the first embodiment. In the conversion specification document shown in FIG. 14, there is description of tag name abbreviating conversion information on whether tag name abbreviating conversion should be performed or not at the time of conversion. Namely, in the conversion specification document shown in FIG. 14, tag name abbreviating conversion information is added as “format” attribute in an element of a tag name “merged_tag”, although there are almost the same descriptions as those in the conversion specification document shown in FIG. 12. When tag name abbreviating conversion is to be executed, “abbr”, for example, is described as the “format” attribute value.

When a tag name and an abbreviated tag name are related and “abbr” is described as the “format” attribute value in the conversion specification document, the XSLT structure converting unit 12 shown in FIG. 2 executes tag name abbreviating conversion, and the XSLT reversely converting unit 13 shown in FIG. 2 executes a process of tag name decompressing conversion.

Accordingly, the end user can designate whether tag name abbreviating conversion should be performed or not using the “format” attribute in a conversion specification document described in XML. It is thus possible to automatically switch between execution and non-execution of tag name abbreviating conversion or tag name expanding conversion using the “format” attribute.

[1-6-5] Conversion Specification Document for XML Document Having Hierarchical Structure and Attribute

FIG. 15 shows a first practical example of a conversion specification document (XML document) used when nonkey elements in a record have the hierarchical structure and attributes. Particularly, the conversion specification document shown in FIG. 15 is used to convert the XML document shown in FIG. 5, which is an object of conversion, into the XML document shown in FIG. 6 or 8. Here, the hierarchical structure of elements is described using an attribute “depth”, and the attribute “depth” is added to the tag of a parent having a child.

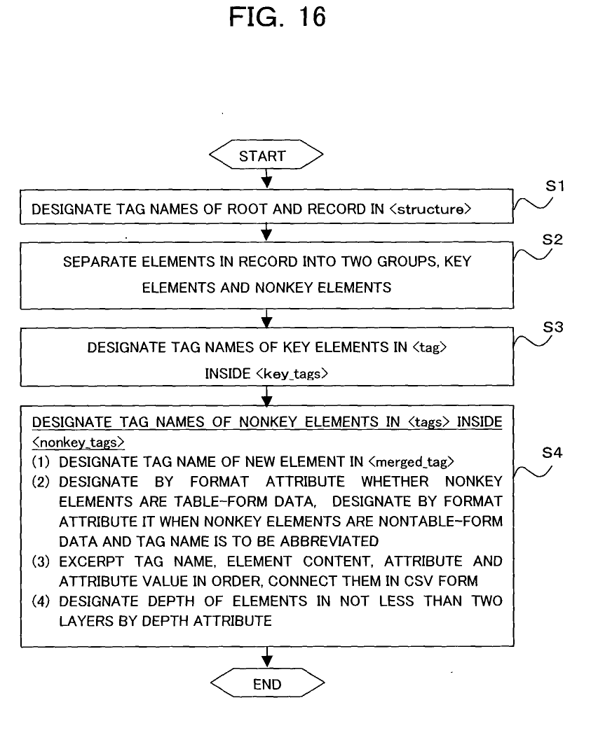

A procedure for creating a converting specification document as shown in FIG. 15 will be now described with reference to a flowchart (steps S1 through S4) shown in FIG. 16. Note that the procedure shown in FIG. 16 is a procedure for creating a conversion specifications when the number of hierarchical layers in a record is arbitrary, and nonkey elements have arbitrary attributes.

First, tag names of root and record are designated in an element “structure” (step S1). When the XML document shown in FIG. 5 is an object of conversion, for example, “nominal list” is designated as the tag name of the root, and “individual” is designated as the tag name of the record.

Elements in the record are separated into two groups, key elements and nonkey elements (step S2). In the example shown in FIGS. 5 and 15, the elements of tag names “name”, “last name”, “first name”, “office” and “company” are key elements, whereas the elements of tag names “department”, “address”, “contact”, “telephone”, “fax” and “Email” are nonkey elements.

the tag names of the key elements are designated in <tag> inside <key_tags> (step S3). The tag names of the nonkey elements are designated in <tag> inside <nonkey_tags> (step S4).

At step S4, information on the nonkey elements is described as a conversion specification document according to the following procedure (1) through (4).

Procedure (1): A tag name of a new element describing the nonkey elements collected into one is designated at <merged_tag> (refer to “information 1” or “information 2” in FIG. 15).

Procedure (2): Whether the nonkey element that should be collected into one is table-form data or not is designated at “format” attribute. When the nonkey elements are table-form data, “table” is described as the “format” attribute value. When the nonkey elements are nontable-form data, “nontable” is described as the “format” attribute value. When the nonkey elements are nontable-form data, and tag name abbreviating conversion to convert a tag name into an abbreviated tag name is to be performed, this effect is designated at the “format” attribute. When tag name abbreviating conversion is to be performed, “abbr” is described as the “format” attribute value.

Procedure (3): Tag name, element content, attribute and attribute content (attribute value) are excerpted in a predetermined order, and connected in the CSV form.

Procedure (4): Depth of elements in not less than two hierarchical layers (elements configuring the hierarchical structure) is designated at “depth” attribute (refer to depth=“0” or depth=“1” in FIG. 15).

In the above procedure, a conversion specification document is described in XML, as shown in FIG. 15.

FIG. 17 shows a second practical example of a conversion specification document (XML document) used when nonkey elements in a record are in a hierarchical structure and have attributes. Particularly, the conversion specification document shown in FIG. 17 is used to convert the XML document, which is an object of conversion, shown in FIG. 5 into the XML document described above with reference to FIG. 7 or 8. Here, a hierarchical structure of elements that become leaves are described using attribute “path”. The “path” attribute value is expressed by “XPath.”

The conversion specification document shown in FIG. 17 is similar to the conversion specification document shown in FIG. 15 excepting that the hierarchical structure is described using the attribute “path”, detailed description of which is thus omitted. The conversion specification document shown in FIG. 17 is created in the similar procedure to that described above with reference to FIG. 16.

The XML document shown in FIG. 6 or 7 is obtained by conversion according to the conversion specification document shown in FIG. 15 or 17. At the time of conversion of the XML document, “nontable” is set as the “format” attribute value, and whether the XML document to be converted is table-form data or not is not discriminated (that is, as nontable-form data). On the contrary, in the XML document shown in FIG. 8, “nontable” is set as the “format” attribute value of “information 1”, “table” is set as the “format” attribute value of “information 2”, the nonkey elements of table-form data are undergone table-form conversion, and the nonkey elements of nontable-form data are undergone nontable-form conversion.

[1-7] Practical Procedure for Converting Process in Converting Method According to First Embodiment

Next, converting process procedure in the structured document converting method according to the first embodiment of this invention will be described with reference to FIGS. 18 through 21.

FIGS. 18 and 19 show procedures for processing in the case where the data structure converting/reversely converting process is executed using DOM or XSLT by Java software. Incidentally, Java is an object-oriented programming language similar to C++ developed by Sun Microsystems, Inc., U.S.A.

FIG. 18 is a flowchart (steps A1 through A16) for illustrating a procedure for processing at the time of data structure conversion of an XML document that is an object of conversion on the basis of a conversion specification document. FIG. 19 is a flowchart (steps B1 through B15) for illustrating a procedure for processing at the time of reverse conversion of the data structure of a converted XML document (processed XML document) on the basis of the conversion specification document. The procedures for processing shown in FIGS. 18 and 19 are used when processing is executed on an XML document that is an object of conversion and a converted XML document on the basis of a conversion specification document without using the data structure converting/reversely converting mechanism 10 shown in FIG. 2.

When data structure conversion is performed on an XML document that is an object of conversion, as shown in FIG. 18, the processor reads a conversion specification document, and parses the conversion specifications on the basis of the description of the conversion specification document (step A1). The processor then reads the XML document to be converted, and starts a data structure converting process (step A2).

A tag of root of the XML document to be converted is copied on the converted XML document's side (step A3), and the next one record data is cut out from the XML document to be converted (step A4). After that, it is determined whether the process has been performed on all records (step A5). When the process has not been completed on all records (NO route at step A5), a tag of the next record is copied on the converted XML document's side (step A6), and the next element data is cut out from a record that is being processed (Step A7).

When the next element data is cut out, it is determined that the processing is not completed on all elements (NO route at step A8), and it is determined whether the element data cut out is a key element or not (step A9) When the element data cut out is a key element (YES route at step A9), the element cut out is copied as it is on the converted XML document's side (step A10), and the procedure goes back to the process at step A7.

When the element cut out is not a key element (NO route at step A9), it is determined whether the element is a nonkey element (step A11). When the element is not a nonkey element (NO route at step A11) some error processing is executed.

When the element is a nonkey element (YES route at step A11), a new element of a tag name beforehand designated in a conversion specification document is created (step S12). When a new element corresponding to the nonkey element has been created, this creating process is omitted.

When a new element is created at step A12, a tag name of the nonkey element is described as a tag name character string (attribute value) in the attribute of the new element. When a new element corresponding to the nonkey element has been created, a tag name of the nonkey element is connected to the tail of a tag name character string in the attribute of the new element via a delimiter in CSV form (step A13).

When a new element is created at step A12, a content of the nonkey element is described as a content character string in the content of the new element. When a new element corresponding to the nonkey element has been created, a content of the nonkey element is connected to the tail of a content character string in the content of the new element via a delimiter in CSV form (step A14). After that, the procedure goes back to the process at step A7. When the same character as the delimiter (here, a comma “,”) in the content of the nonkey element appears at step A14, the character (delimiter) in the content of the nonkey element is replaced with another identification character string (for example, entity reference description or the like), as described above.

When data of the next element is not cut out at step A7, it is determined that the process is completed on all elements (YES route at step A8), an end tag of the record that is being processed is outputted, and copied on the converted XML document's side (step A15), and the procedure goes back to the process at step A4. When the process is completed on all records (YES route at step A5), an end tag of the root is outputted, and copied on the converted XML document's side (step A16), and the converting process is terminated.

When data structure reverse conversion is performed on a converted XML document, as shown in FIG. 19, the processor first reads a conversion specification document, parses conversion specifications on the basis of description of the conversion specification document (step B1), reads an XML document to be reversely converted, and starts a data structure reversely converting process (step B2).

A tag of root of the XML document to be reversely converted is copied on the restored XML document's side (step B3), and data of the next one record is cut out from the XML document to be reversely converted (step B4). After that, it is determined whether the process is completed on all records (step B5) When the process is not completed on all records (NO route at step B5), a tag of the record is copied on the restored XML document's side (step B6), and the next element data is cut out from a record that is being processed (step B7).

When data of the next element is cut out, it is determined that the process is not completed on all elements (NO route at step B8), and it is determined whether the element cut out is a key element or not (step B9). When the element cut out is a key element (YES route at step B9), the element cut out is copied as it is on the restored XML document's side (step B10), and the procedure goes back to the process at step B7.

When the element cut out is not a key element (NO route at step B9), it is determined whether the element is merged nonkey elements or not (step B11) When the element is not merged nonkey elements (NO route at step B11), some error processing is executed.

When the above new element that is merged nonkey elements is cut out (YES route at step B11), tag names of nonkey elements are successively cut out from a tag character string (which is composed of tag names of nonkey elements connected in CSV form) described as the attribute value in the tag of the new element (step B12).

Contents of nonkey elements are successively cut out from a content character string (composed of contents of nonkey elements connected in CSV form) described in the content of the new element, nonkey elements are restored from the contents cut out and the tag names cut out at step B12 (step B13), and the procedure goes back to the process at step B7. When a content including an identification character string relating to a delimiter is cut out from the content character string of the new element at step B13, the identification character string is restored to the original delimiter.

When data of the next element is not cut out at step B7, it is determined that the process is completed on all elements (YES route at step B8). An end tag of the record that is being processed is outputted, and copied on the restored XML document's side (step B14), and the procedure goes back to the process at step B4. When the process is completed on all elements (YES route at step B5), an end tag of the root is outputted and copied on the restored XML document's side (step B15), and the reversely converting process is terminated.

FIGS. 20A through 20D show procedures for processing in the case where the data structure converting/reversely converting process according to the first embodiment is executed by only an XSLT processor. Namely, the procedures for processing shown in FIGS. 20A through 20D are applied when the process is executed on an XML document to be converted and a converted XML document on the basis of a conversion specification document using the data structure converting/reversely converting mechanism 10 shown in FIG. 2.

FIGS. 20A and 20B are flowcharts for illustrating procedures for creating a style sheet for conversion and a style sheet for reverse conversion (processing by the XSLT converting unit 11) according to the first embodiment.

FIG. 20C is a flowchart for illustrating a procedure for processing in the case where the XSLT structure converting unit 12 performs data structure conversion on an XML document to be converted on the basis of a style sheet for structure conversion. FIG. 20D is a flowchart for illustrating a procedure for processing in the case where the XSLT reversely converting unit 13 performs data structure reverse conversion on a converted XML document (processed XML document) on the basis of a style sheet for reverse conversion.

In prior to the process on an XML document to be converted, the XSLT converting unit 11 reads a conversion specification document described in XML, parses conversion specifications on the basis of description of the conversion specification document (step A1), and creates a style sheet for data structure conversion using the conversion specifications and an automatic conversion style sheet (step A20), as shown in FIG. 20A. Similarly, as shown in FIG. 20B, the XSLT converting unit 11 reads a conversion specification document described in XML, parses conversion specifications on the basis of description of the conversion specification document (step B1), and creates a style sheet for data structure reverse conversion using the conversion specifications and an automatic conversion style sheet (step B20).

When performing data structure conversion on an XML document to be convnerted, the XSLT structure converting unit 12 designates an XML document to be converted and a style sheet for structure conversion, and starts the converting process (step A21), as shown in FIG. 20C. After that, the XSLT structure converting unit 12 executes a process similar to the process at step A2 through A16 in FIG. 18.

Conversely, when performing data structure reverse conversion on an converted XML document, the XSLT reversely converting unit 13 designates an XML document to be reversely converted and a style sheet for reverse conversion, and starts a reversely converting process (B21), as shown in FIG. 20D. After that, the XSLT reversely converting unit 13 executes a process similar to the process at step B2 through B15 in FIG. 19.

As shown in FIG. 2, the application software 30 performs a process such as tag-dependent content retrieval or the like on a converted XML document, in which the number of elements has been decreased, fed from the XSLT structure converting unit 12 through the standard API (DOM) 20, thus the processing speed of the application software is largely increased.

When the application software 30 performs tag-dependent content retrieval on a converted XML document, an XML document (extracted XML document) describing a record hit in the tag-dependent content retrieval is extracted and outputted. The extracted XML document is reversely converted as above by the XSLT reversely converting unit 13, whereby a result of retrieval (XML document) the same as one obtained in the tag-dependent content retrieval on the original XML document by the application software 30 is obtained.

Since the XML document on which the XSLT reversely converting unit 13 performs reverse conversion is an XML document in which a small number of records extracted by the application software 30 is described, the overhead for reverse conversion by the XSLT reversely converting unit 13 causes little problem. Accordingly, the process performed the number of times by the application software 30 can be largely speed up by beforehand performing data structure conversion according to this embodiment, and the amount of the operation memory used can be largely decreased.

FIGS. 21A and 21B are flowcharts for illustrating a modification of the procedures for creating a style sheet for conversion and a style sheet for reverse conversion (processing by the XSLT converting unit 11) according to the first embodiment. The procedures for processing shown in FIGS. 21A and 21B are executed by the XSLT converting unit 11 in place of the procedures for processing described above with reference to FIGS. 20A and 20B when table form/nontable form is designated at the “format” attribute value in the conversion specification document shown in FIG. 13, 15 or 17.

Namely, in prior to the processing on an XML document to be converted, as shown in FIG. 21A, the XSLT converting unit 11 reads a conversion specification document described in XML, parses conversion specifications on the basis of description of the conversion specification document (step A1), and refers to “format” attribute value to determine whether data (XML document to be converted) is in the table form or not (step A22).

When the data is in the table form (YES route at step A22), the XSLT converting unit 11 creates a style sheet for structure conversion to make a tag name of a new element represent tag names of nonkey elements using the conversion specifications and an automatic conversion style sheet (step A20-1). When the data is in the nontable form (NO route at step A22), the XSLT converting unit 11 creates a style sheet for structure conversion to describe a tag name character string obtained by connecting tag names (or abbreviated tag names) of nonkey element via delimiters in a converted XML document (step A20-2).

As shown in FIG. 21B, the XSLT converting unit 11 reads a conversion specification document described in XML, parses conversion specifications on the basis of description of the conversion specification document (step B1), refers to “format” attribute value, and determines whether the data (XML document to be converted) is in the table form or not (step B22).

When the data is in the table form (YES route at step B22), the XSLT converting unit 11 creates a style sheet for reverse conversion by which tag names of nonkey elements can be deduced from a tag name of a new element using the conversion specifications and an automatic conversion style sheet (step B20-1). When the data is in the nontable form (NO route at step B22), the XSLT converting unit 11 creates a style sheet for structure conversion by which tag names of nonkey elements can be restored from a tag name character string using the conversion specifications and an automatic conversion style sheet (step B20-2).

[1-8] Effects of First Embodiment

In the structured document converting method according to the first embodiment of this invention, elements constituting an XML document to be converted are separated into key elements and nonkey elements. In a converted XML document, the key elements are described unchanged, whereas the nonkey elements (items that are not objects of data processing) are collected into one tag and described. In the converted XML document, the number of elements is largely decreased, and the nonkey elements can be collectively handled when the elements are expanded to a DOM tree, or at the time of data processing such as tag-dependent content retrieval or the like.

Particularly, an effect of decreasing the number of elements is remarkable in an XML document having a large number of nonkey elements that are not objects of data processing, or an XML document having a large number of elements in one record. For example, when the number of elements is reduced to half, a time required to expand the elements to a DOM tree or for tag-dependent content retrieval can be shortened to half. When an XML document to be converted is table-form data, the XML document is converted in the way described above with reference to FIG. 4B or 4C, whereby tag names of nonkey elements need not to be described in the converted XML document. Which sometimes allows the amount of data of an XML document before conversion to be reduced to about one-third in the converted XML document.

When the application software (application) 30 performs data processing on an XML document, only key elements are used. According to the first embodiment, it is possible to refer to a content of a key element using a tag name of the key element as usual because the key elements are described unchanged, thus the transparency of a converted XML document can be assured.

At this time, it becomes unnecessary to create a style sheet for each of various kinds of XML documents by creating a conversion specification document as an XML document and giving a conversion execution procedure. It is thus possible to perform data structure converting/reversely converting process according to the first embodiment on various kinds of XML documents without much time and labor. If a style sheet for conversion/reverse conversion instructing conversion/reverse conversion is created on the basis of the conversion specification document, it is possible to execute conversion/reverse conversion using the style sheet for conversion/reverse conversion by a standard XSLT processor. Namely, it is possible to execute the converting/reversely converting process according to the first embodiment in almost all types of XML system.

According to the converting method of the first embodiment, it is possible to provide a general-purpose converting technique, by which a data structure converting process of collecting nonkey elements into one element can be performed on various kinds of XML documents while securing the transparency to the application or the effectiveness of a data structure of a converted XML document. This can largely decrease a resource required for operation on XML documents, and realize a decrease in the amount of the memory used and an increase of the processing speed when the XML documents are processed.

Large data in EDI is not suited to be expanded to a DOM tree because there are several hundreds to several thousands of items (elements) per one record, thus the number of items is too many. Additionally, complex document operations are difficult since standard API (SAX: Simple API for XML), which cuts out document elements and only sends them in time series, is used therefor. However, the converting method of this embodiment can extremely effectively convert XML documents because the number of items (key elements) that are objects of data processing is not necessarily large even in data having a large number of items.

In tag conversion or content conversion, tag names or contents of nonkey elements are connected via delimiters such as commas or the like (in CSV form), as shown in FIGS. 3 through 8, so that a tag name character string or a content character string can be extremely readily created using a symbol never relating to tagging.

When nonkey elements are in a plurality of hierarchical layers, hierarchical structure identification information is added to a tag name in a tag name character string, whereby the hierarchical structure can be stored in a converted XML document. It is thereby possible to readily perform reverse conversion to restore a converted XML document into the original XML document according to the hierarchical structure identification information.

When a nonkey element has an attribute, an attribute name to which attribute name identification information (”@” in FIGS. 6 through 8) is added is described after a tag name having the attribute via a delimiter in a tag name character string, and a content character string in which contents of the nonkey elements are connected is created correspondingly to the arrangement of tag names in the tag name character string, whereby the attribute of the nonkey element can be stored in a converted XML document, as shown in FIGS. 6 through 8. It is there by possible to readily reversely convert a converted XML document into the original XML document according to the attribute name identification information.

Tag name abbreviating conversion is performed to replace a tag name of a nonkey element with an abbreviated tag name, as shown in FIGS. 3C and 3F, whereby the amount of data of a converted structured document can be decreased. At this time, whether tag name abbreviating conversion is to be performed or not is instructed by tag name abbreviating conversion information (“abbr” in “format” attribute value) in a conversion specification document, as shown in FIG. 14, thereby to automatically switch between execution and non-execution of the tag name abbreviating conversion or the tag name expanding conversion.

When an XML document to be converted is described in the table form, it is possible to readily deduce a tag name or an attribute name when reverse conversion is performed to restore the original XML document as described above, which allows tag name conversion or attribute name conversion to be omitted. Since description of only a content character string of nonkey elements suffices in a converted XML document, description of the tag names or attribute names can be omitted, which allows a large decrease of the amount of data of a converted XML document. At this time, whether table-form conversion is to be performed or not is instructed by table-form information (“table/nontable” in “format” attribute value) in a conversion specification document, as shown in FIGS. 13, 15 and 17, thereby to automatically switch between execution/non-execution of the table-form conversion or the table-form reverse conversion.

[2] Description of Second Embodiment

[2-1] Principle of Structured Document Converting Method According to Second Embodiment

Next, description will be made of the principle of a structured document converting method according to a second embodiment of this invention with reference to FIGS. 1A, 3A and 22.

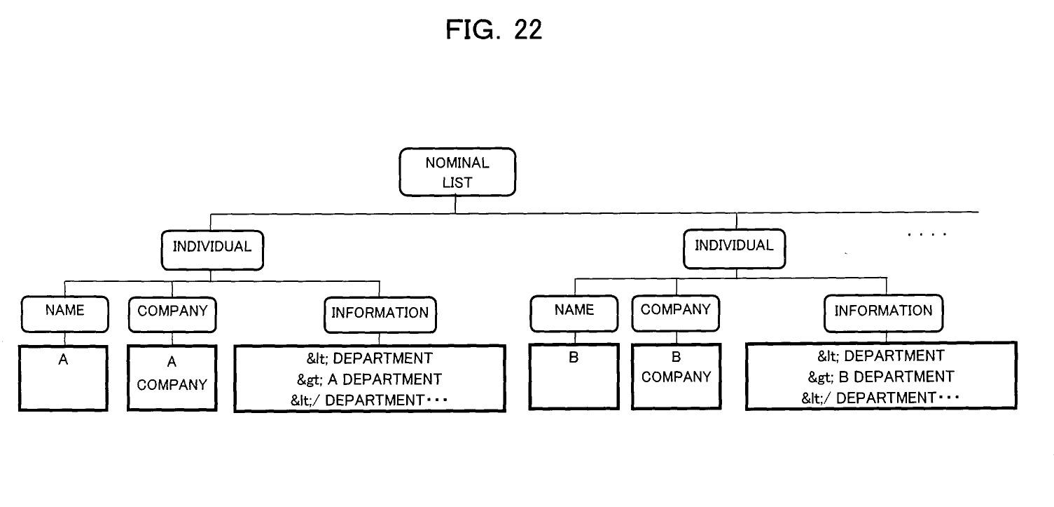

In the XML document described above with reference to FIGS. 1A and 3A, elements of tag names “name” and “company” are key elements, whereas elements of tag names “department”, “address” and “telephone” are nonkey elements. FIG. 22 shows a memory expanded form of a converted XML document obtained by applying a structured document converting method according to the second embodiment to the XML document in FIGS. 1A and 3A. Incidentally, the expanded form shown here is an expanded form on a memory used when the converted XML document is operated by the application software through standard API (DOM).

In the XML document shown in FIG. 22, a new element having a tag name “information” is created, and nonkey elements of tag names “department”, “address” and “telephone” are described as a content of the new element. When the nonkey elements are described as a content of the new element, tag symbols “<” and “>” in the nonkey element description are replaced with entity reference descriptions. Key elements of tag names “name” and “company” are described in their original form. Incidentally, only the leading part of an element content of the new element “information” is described in FIG. 22.

The XML document is converted in a way that nonkey elements in each record are collected into one element as this, so that the number of elements contained in the XML document, that is, the number of child elements in the tree expanded on the memory, can be largely decreased, and nonkey elements can be collectively handled at the time of expansion or data processing.

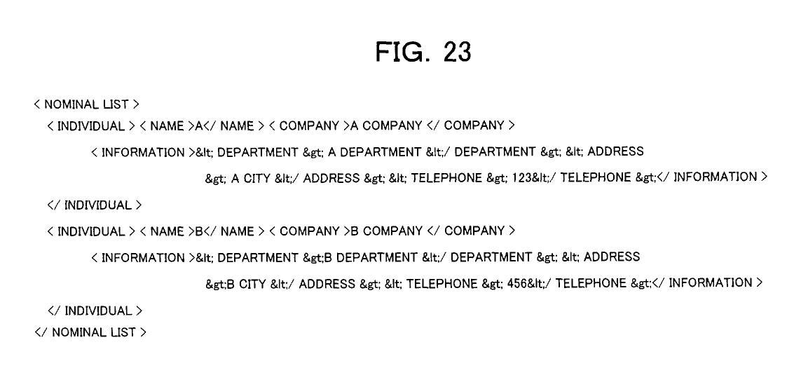

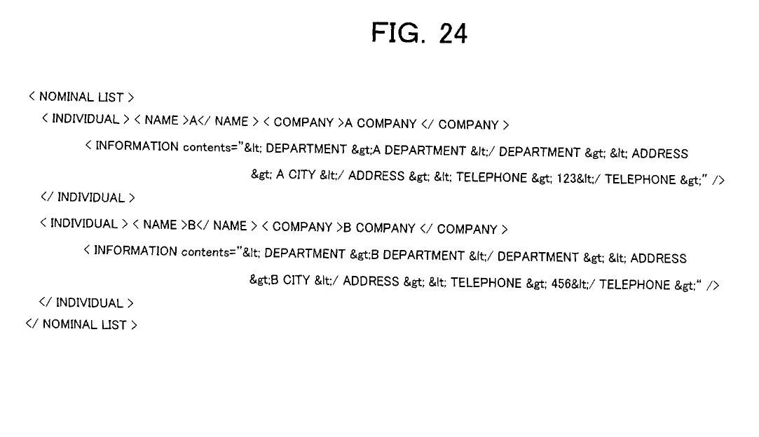

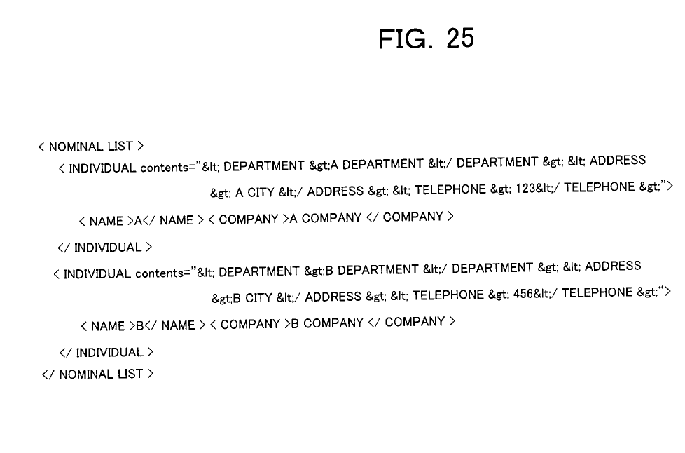

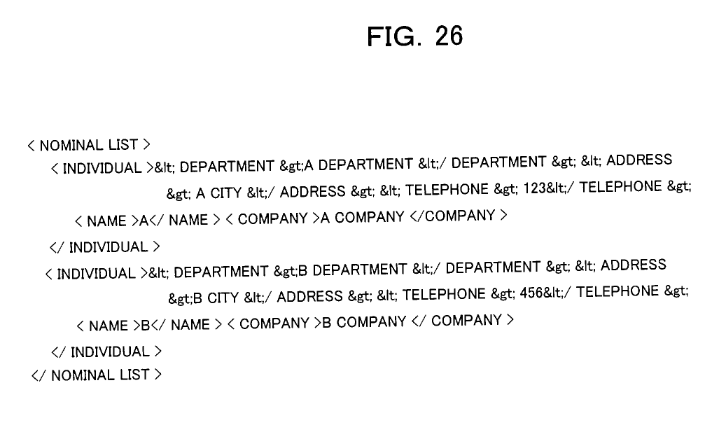

When nonkey elements in each record are collected into one element, a character string in which a symbol relating to tagging is replaced with a character string not relating to tagging in description of nonkey elements is created, and this character string is descried as the content of a new element (refer to FIG. 22 or 23), the attribute value of the new element (refer to FIG. 24), the attribute value of a parent element (refer to FIG. 25), or the content of the parent element (refer to FIG. 26), according to the second embodiment. Incidentally, FIG. 22 shows a DOM tree of a converted XML document in the case where the above character string is described as the content of a new element.

Particularly, symbols (tag symbols “<” and “>”) relating to tagging in nonkey elements are replaced with other character strings not relating to tagging in a manner of description called “entity reference”, in the second embodiment.

“Entity” stores data that can be a part of an XML document in any form such as a file, a replacement character string or the like. When “entity reference” is performed, “&entity name;” is described in an XML instance.

Generally, a relationship between an entity names and an original file name or character string is declared in document type definition (DTD). However, five entities “<”, “>”, “& ”, “'” and “”” relating to tagging shown in Table 1 below are allowed to be used without DTD. For example, when an entity (character desired to be replaced) “<” is described in an element content, “<” is replaced with a character string “&lt;” of entity reference description using an entity name “lt”. Similarly, “>” is replaced with “&gt;”, “&” with “&amp;”, “'” with “&apos;” and “”” with “&quot;”.

TABLE 1

| Character desired to | |
|---|---|
| be replaced | Entity name |
| < | lt |
| > | gt |
| & | amp |
| ' | apos |
| “ | quot |

The symbols “<” and “>” representing tags in an element content are replaced with entity reference character strings “&lt;” and “&gt;”, respectively, using the above entity reference description, so that tag symbols described in an element content are not processed as tags by a parser (parsing software). When nonkey elements are collected into one element, a series of nonkey elements, in which tag symbols are replaced with the entity reference character strings, are sandwiched between tags such as “<information></information>”, and are made the content of a new element of a tag name “information”, so that the series of nonkey elements are handled as a mere element content. This converting method is summarized as follows:

(1) A series of nonkey elements are extracted:

First record: <department>A department</department><address>A city</address><telephone>123</telephone>

Second record: <department>B department</department><telephone>456</telephone><telephone>789</telephone>

(2) Tag symbols are replaced with the entity reference character strings:

“<” is replaced with “&lt;”, and “>” is replaced with “&gt;”.

First record: &lt;department&gt;A department&lt;/department&gt;&lt;address&gt;A city&lt;/address&gt;&lt;telephone&gt;123&lt;/telep hone&gt;

Second record: &lt;department&gt;B department&lt;/department&gt;&lt;telephone&gt;456& lt;/telepohone&gt;&lt;telepohone&gt;789&lt;/teleph one&gt;

(3) A series nonkey elements to which entity reference has been applied are sandwiched between tags “<information></information>” so as to be collected into the content of one element.

First record: <information>&lt;department&gt;A department&lt;/department&gt;&lt;address&gt;A city&lt;/address&gt;&lt;telephone&gt;123&lt;/telep hone&gt;</information>

Second record: <information>&lt;department&gt;B department&lt;/department&gt;&lt;telephone&gt;456& lt;/telephone&gt;&lt;telephone&gt;789&lt;/telephon e&gt;</information>

[2-2] System and Flow of Converting/Reversely Converting Process According to Second Embodiment

The structured document converting method according to the second embodiment of this invention is applied to the system described above with reference to FIG. 2.

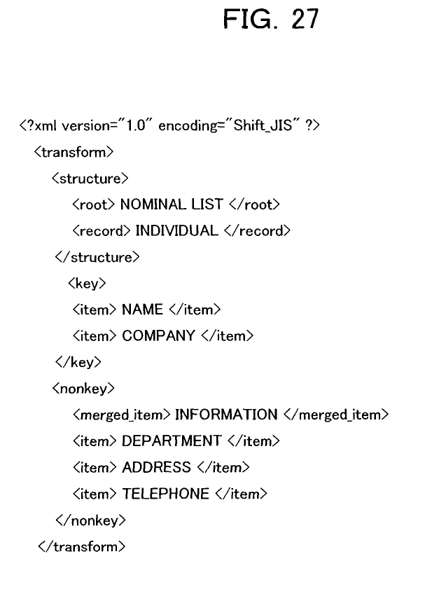

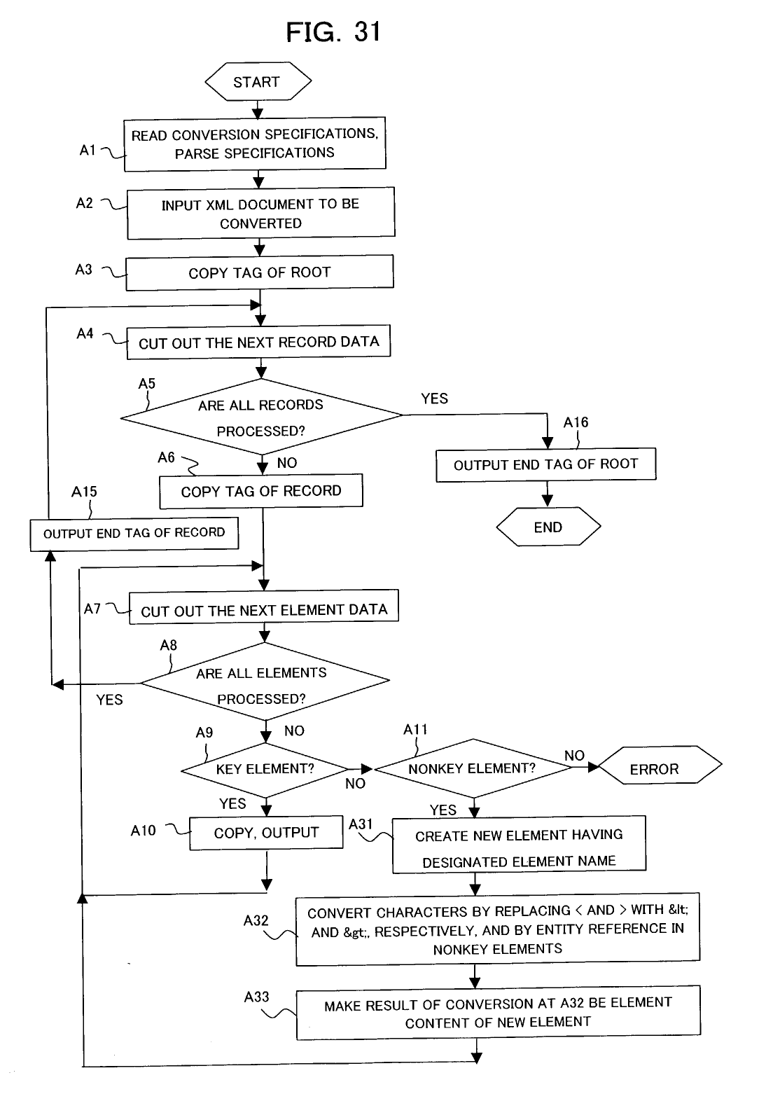

It is quite troublesome and takes much time to create a style sheet (XSL sheet) complying with each of various kinds of XML documents. In order to omit this, specifications (record name, key tag name, nonkey tag name, etc.) for converting the data structure of an XML document is created by an XML document (conversion specification document), a convertsion execution procedure is given, as will be described later with reference to FIG. 27, and conversion/reverse conversion of the XML document is executed on the basis of the conversion specification document, as will be described later with reference to FIGS. 31 through 38, according to the second embodiment.

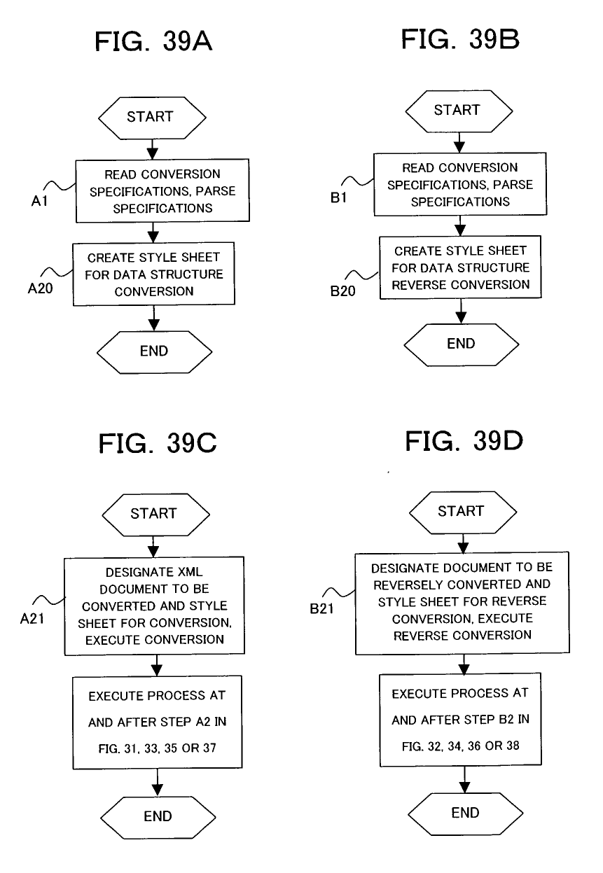

According to the second embodiment, a style sheet for conversion instructing a conversion execution procedure and a style sheet for reverse conversion instructing a reverse conversion execution procedure are automatically created on the basis of a given conversion specification document, and data structure conversion/reverse conversion is executed on an XML document by a structured document converting processor (XSLT processor) using the styel sheet, as will be described later with reference to FIGS. 39A through 39D. Since a style sheet gives an execution procedure for conversion/reverse conversion as this, it is possible to execute conversion/reverse conversion by a standard XSLT processor. It becomes thus possible to execute a converting/reversely converting process according to the second embodiment in any type of XML document system.

When a converting method according to the second embodiment is applied to the system shown in FIG. 2, the data structure converting/reversely converting mechanism (XSLT processor) 10 reads a conversion specification document as an XML document, reads an input XML document to be processed, converts the input XML document on the basis of conversion specifications (actually a style sheet for structure conversion), and outputs an XML document undergone predetermined data structure conversion. The converted XML document is undergone data processing (for example, tag-dependent content retrieval) by the application software through the standard API 20, so that an XML document after undergone the data processing is obtained. When tag-dependent content retrieval is performed as the data processing, a result of retrieval is obtained in the form of an extracted XML document. The extracted XML document is read by the data structure converting/reversely converting mechanism 10, and reversely converted into an XML document in the original data structure on the basis of conversion specifications (actually a style sheet for reverse conversion), so that an XML document is obtained as a final result of the data processing.

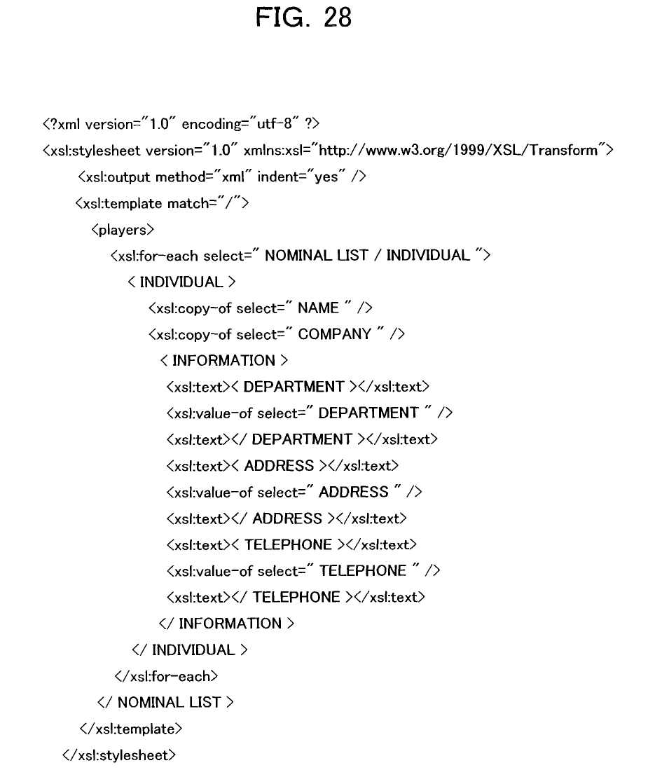

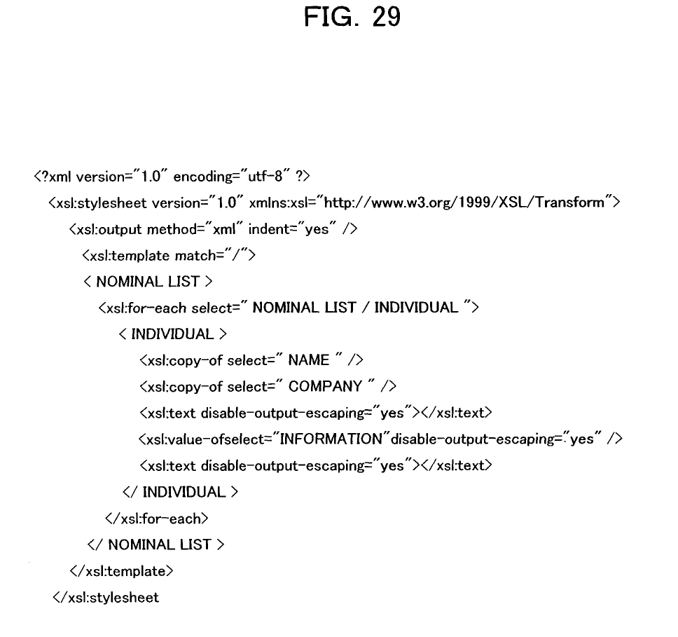

Meanwhile, a specification XML document for data structure conversion according to the second embodiment to be read by the XSLT converting unit 11 will be described later with reference to FIG. 27. A style sheet for structure conversion and a style sheet for reverse conversion created by the XSLT converting unit 11 will be described later with reference to FIGS. 28 and 29, respectively.

[2-3] XML Document Converting Method And Examples of Practical Conversion According to Second Embodiment

FIGS. 23 through 26 show first to fourth practical examples of results of conversion obtained by applying a structured document converting method according to the second embodiment to the table-form XML document shown in FIG. 4A, wherein tag names “name” and “company” are key elements, whereas elements of tag names “department”, “address” and “telephone” are nonkey elements.

In the first practical example shown in FIG. 23, elements constituting an XML document to be converted are separated into key elements and nonkey elements, a new element given a tag name “information” is created, tag symbols “<” and “>” in description of the nonkey elements are replaced with character strings “&lt;” and “&gt;” of entity reference description, respectively, to create a character string, and the character string is described as the content of the new element. The key elements are described unchanged even in a converted XML document without any conversion. At this time, information for discriminate between the key element and the nonkey elements, or information (tag name “information”) relating to the new element is described and designated in a conversion specification document. On the basis of the conversion specification document, data structure conversion is performed on the XML document to be converted, and reverse conversion is performed on the converted XML document to restore description of the nonkey elements to the original state.

In the second practical example shown in FIG. 24, elements constituting an XML document to be converted are separated into key elements and nonkey elements, a new element (empty element) given a tag name “information” and an attribute name “contents” is created, tag symbols “<” and “>” in description of the nonkey elements are replaced with character strings “&lt;” and “&gt;” of entity reference description, respectively, to create a character string, and the character string is described as the attribute value corresponding to the attribute name “contents” of the new element. The key elements are described unchanged even in a converted XML document without any conversion. At this time, information for discriminating between the key elements and the nonkey elements or information (tag name “information” and attribute name “contents”) relating to the new element is described and designated in a conversion specification document. On the basis of the conversion specification document, data structure conversion and reverse conversion are performed on the XML document to be converted and a converted XML document, respectively.

In the third practical example shown in FIG. 25, elements constituting an XML document to be converted are separated into key elements and nonkey elements, a new attribute name “contents” is given to a parent element (tag name “individual”) of the nonkey elements, tag symbols “<” and “>” in description of the nonkey elements are replaced with character strings “&lt;” and “&gt;” of entity reference description, respectively, to create a character string, and the character string is described as the attribute value of the attribute name “contents” of the parent element. The key elements are described unchanged even in a converted XML document without any conversion. At this time, information for discriminating between the key elements and the nonkey elements and information (tag name “individual” and attribute name “contents”) relating to the parent element are described and designated in a conversion specification document. On the basis of the conversion specification document, data structure conversion and reverse conversion are performed on the XML document to be converted and a converted XML document, respectively.

In the fourth practical example shown in FIG. 26, elements constituting an XML document to be converted are separated into key elements and nonkey elements, tag symbols “<” and “>” in description of the nonkey elements are replaced with character strings “&lt;” and “&gt;” of entity reference description, respectively, to create a character string, and the character string is described as the content of a parent element (tag name “individual”). The key elements are described unchanged without any conversion even in a converted XML document. At this time, information for discriminating between the key elements and the nonkey elements, and information (tag name “individual”) relating to the parent element are described and designated in a conversion specification document. On the basis of the conversion specification document, data structure conversion and reverse conversion are performed on the XML document to be converted and the converted XML document, respectively.

The converting method according to the second embodiment collects a plurality of nonkey elements into one element to collectively handle the nonkey elements as elements not relating to data processing while the application software executes the data processing. Which one of the various methods described above with reference to FIGS. 23 through 26 will be used as the converting method can be selected and designated in an automatic conversion style sheet or the like. Which one of the various methods is determined according to the amount of data of an XML document, or how many new elements are increased due to the data processing. In the viewpoint of the nature of this invention, any method can be employed.

[2-4] Practical Examples of Conversion Specification Document and Style Sheet According to Second Embodiment

FIG. 27 shows a practical conversion specification document (XML document) applied when the table-form XML document shown in FIG. 4A is converted. In this case, the XML document to be converted is table-form data. However, even if the XML document to be converted is nontable-form data, execution of conversion/reverse conversion is possible using the conversion specification shown in FIG. 27. The conversion specification document shown in FIG. 27 is for realizing the converting method described above with reference to FIG. 23.

In the conversion specification document shown in FIG. 27, a tag name “nominal list” of root and a tag name of record “individual” are described, tag names “name” and “company” of key elements are described as the content of an element of a tag name “key”, and tag names “department”, “address” and “telephone” of nonkey elements are described as the content of an element of a tag name “nonkey”, whereby information for discriminating between the key elements and the nonkey elements is described. The content of the element “nonkey” includes an element of a tag name “merged_item”. As the content of this element, there is described a tag name “information” of a new element to collect the nonkey elements into one. The above conversion specification document instructs an XML document data structure conversion execution procedure.

The XSLT converting unit 11 shown in FIG. 2 reads the conversion specification document shown in FIG. 27, and creates a style sheet (XSL sheet) for structure conversion shown in FIG. 28 and a style sheet (XSL sheet) for reverse conversion shown in FIG. 29 according to the conversion specification document and an automatic conversion style sheet (automatic conversion XML sheet; not shown). The style sheet for structure conversion shown in FIG. 28 is read by the XSLT structure converting unit 12, and used to perform data structure conversion on an XML document (input XML document) to be converted. The style sheet for reverse conversion shown in FIG. 29 is read by the XSLT reversely converting unit 13, and used to restore an XML document (extracted XML document, converted XML document) processed by the application software 30 into an XML document in the original form (XML document in which the nonkey elements are restored to the original state).

In the above examples, nonkey elements in each record are in a single hierarchical layer and does not have an attribute. However, the converting method according to this invention can be applied to a case where nonkey elements are in a plurality of hierarchical layers (when the hierarchy is deep) or have an attribute by extending the above principle. Namely, symbols relating to tags of nonkey elements are repalaced with character strings of entity reference description in each hierarchical layer, and a new element having results of the replacement as the element content is put in the same hierarchical layer, or a new element having results of replacement as the attribute value is put in the same hierarchical layer, or results of replacement are described as the element content of a parent element or the attribute value of a new attribute.

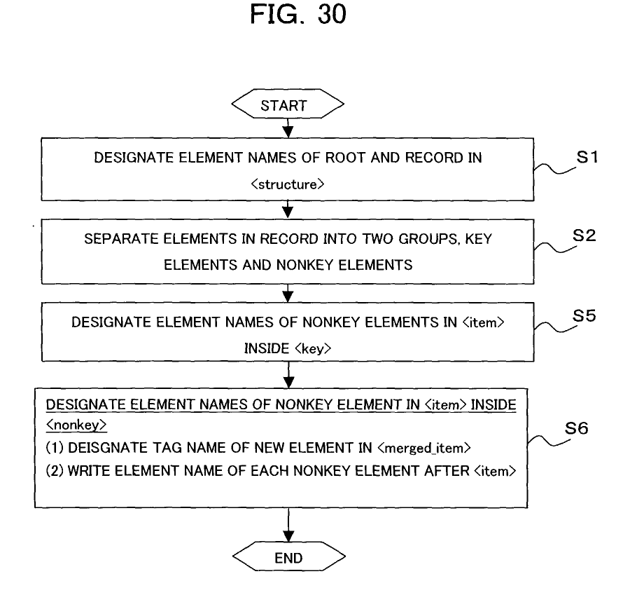

FIG. 30 is a flowchart (steps S1, S2, S5 and S6) for illustrating a procedure for creating a conversion specification document when nonkey elements in a record are in a hierarchical structure and have attributes according to the second embodiment. The procedure shown in FIG. 30 is a procedure of creating conversion specifications when the number of hierarchical layers is arbitrary, and nonkey elements have arbitrary attributes. A conversion specification document created in the manner shown in FIG. 30 is for realizing the converting method described above with reference to FIG. 23.

When a conversion specification document to be used when nonkey elements in a record are in a hierarchical structure and have attributes, tag names of root and record are designated by an element “structure”, as shown in FIG. 30 (step S1). Elements in the record are separated into two groups, key elements and nonkey elements (step S2). Tag names of the key elements are designated in <item>inside <key>(step S5). Tag names of the nonkey elements are designated in <item>inside <nonkey>(step S6).

At step S6, information about the nonkey elements is described as a conversion specification document in the following procedure (1) and (2):

Procedure (1): A tag name of a new element describing the collected nonkey elements is designated in <merged_item>:

Procedure (2): A tag name of each of the nonkey elements is described after <item>.

[2-5] Practical Converting Process Procedure in Converting Method According to Second Embodiment

Next, description will be made of procedures for a converting process in the structured document converting method according to the second embodiment of this invention with reference to FIGS. 31 through 39D.

FIGS. 31 through 38 show procedures for processing applied when a data structure converting/reversely converting process is executed by Java software using DOM, XSLT or the like, like the procedures described above with reference to FIGS. 18 and 19. At Steps in FIGS. 31 through 38 denoted by the same step numbers in FIGS. 18 and 19, like or corresponding processes are performed, descriptions of which are thus omitted. In the following descriptions, descriptions of processes at steps denoted by step numbers A1 through A11, A15, A16, B1 through B11, B14 and B15 are omitted. Procedures for processing shown in FIGS. 31 through 38 are applied when a process on an XML document to be converted or a converted XML document on the basis of a conversion specification document without the data structure converting/reversely converting mechanism 10 shown in FIG. 2.

[2-5-1] First Example of Procedure for Converting/Reversely Converting Process

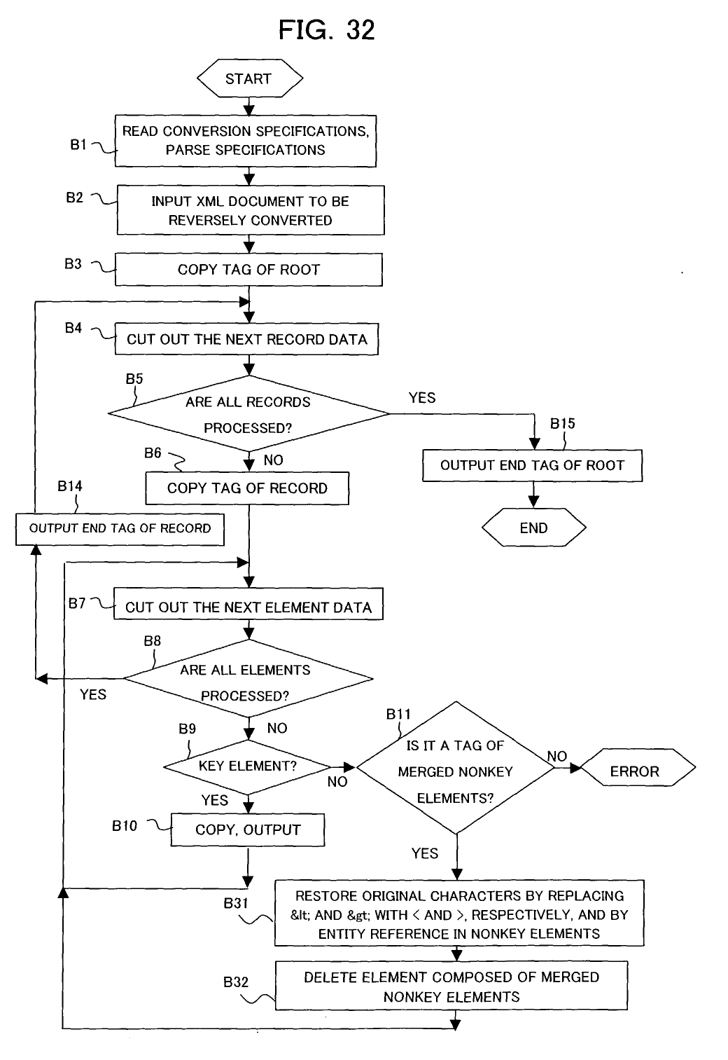

FIG. 31 is a flowchart for illustrating a first example of a procedure for processing applied when data structure conversion is performed on an XML document to be converted on the basis of a conversion specification document. FIG. 32 is a flowchart for illustrating a first example of a procedure for processing applied when reverse conversion is performed on a converted XML document (processed XML document) on the basis of the conversion specification document. The first examples corresponds to the converting method described above with reference to FIG. 23.

In the first example of the converting processing procedure shown in FIG. 31, when element data cut out at step A7 is a nonkey element (YES route at step All), a new element of a tag name “information” (<information>tag) beforehand designated in the conversion specification document is created (step A31). When a new element corresponding to the nonkey element has been created, this creating process is omitted.

Tag symbols “<” and “>” in description of the nonkey element are replaced with character strings “&lt;” and “&gt;” of entity reference description, respectively (step A32). At step A32, when the same character as a symbol (refer to table 1) relating to tagging appears in the content of the nonkey element, the character is replaced with a character string of entity reference description.

When a new element is created at step A31, a replacement resulting character string at step A32 is described as the content of the new element. When a new element corresponding to the nonkey element has already been created, the replacement resulting character string at step A32 is connected to the tail of a replacement resulting character string in the content of the new element, and described (step A33). After that, the procedure goes back to the process at Step A7.

In the first example of the procedure for the reversely converting process shown in FIG. 32, when a new element (<information>tag) obtained by collecting nonkey elements is cut out at step B7 (YES route at step B11), character strings “&lts;” and “&gt;” in description of the content of the new element are restored to the original tag symbols “<” and “>”, respectively (step B31). When another character string of entity reference description is included in the content of the new element at step B31, the character string is restored to the original symbol relating to tagging (refer to table 1). Description of the element (<information>tag) obtained by collecting the nonkey elements is deleted in a restored XML document (step B32), and the procedure goes back to the process at step B7.

[2-5-2] Second Example of Converting/Reversely Converting Processing Procedure

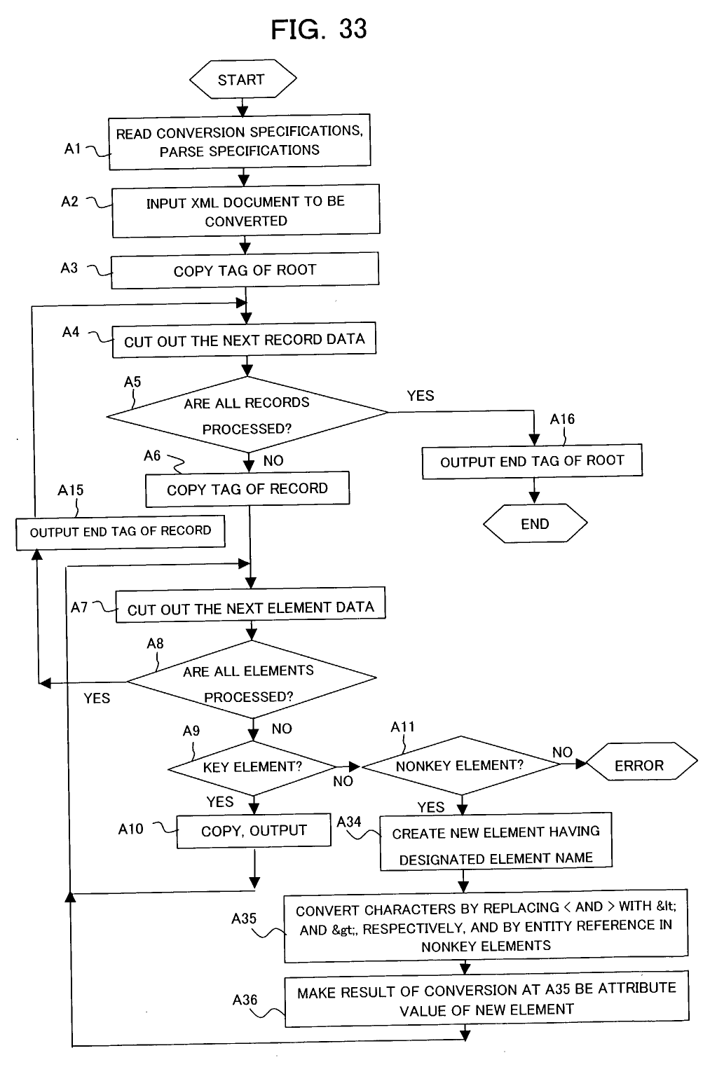

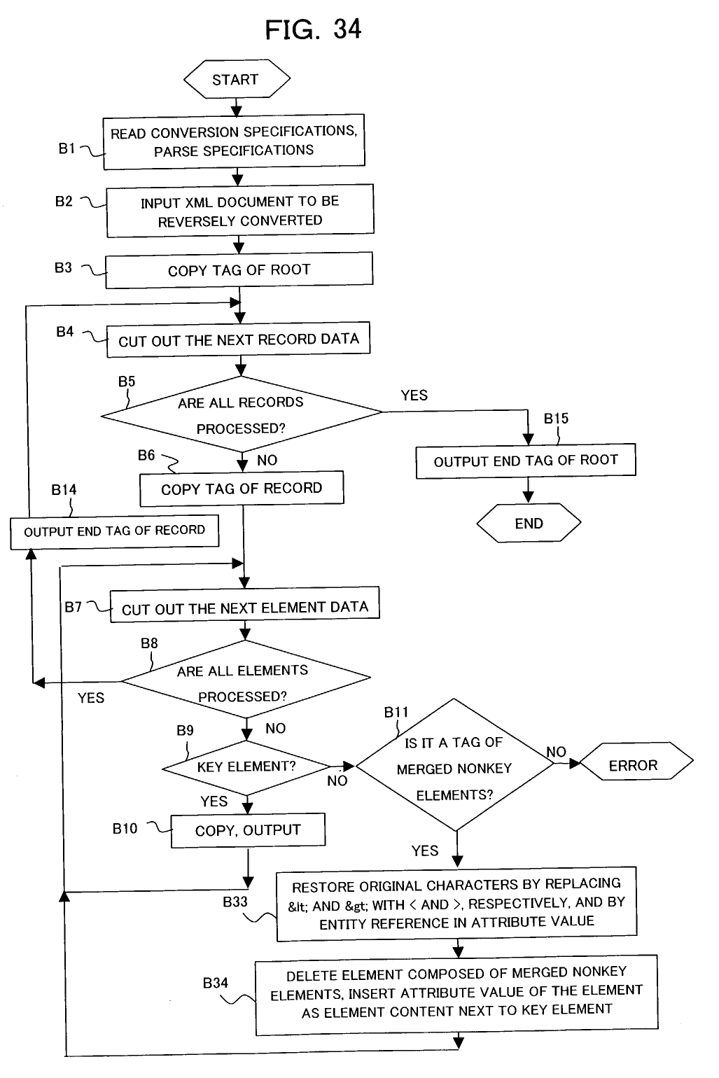

FIG. 33 is a flowchart for illustrating a second example of a processing procedure applied when data structure conversion is performed on an XML document to be converted on the basis of a conversion specification document. FIG. 34 is a flowchart for illustrating a second example of a processing procedure applied when data structure reverse conversion is performed on a converted XML document (processed XML document) on the basis of the conversion specification document. The second examples correspond to the converting method described above with reference to FIG. 24.

In the second example of the converting process procedure shown in FIG. 33, when element data cut out at step A7 is a nonkey element (YES route at step All), a new element (<information>tag) given a tag name “information” and an attribute name “contents” is created (step A34). When a new element corresponding to the nonkey element has been already created, this creating process is omitted.

Tag symbols “<” and “>” in description of the nonkey element are replaced with character strings “&lt;” and “&gt;” of entity reference description, respectively (step A35). When the same character as a symbol relating to tagging (refer to table 1) appears in the content of the nonkey element, the character is replaced with a character string of entity reference description.

When a new element is created at step A34, a replacement resulting character string at step A35 is described as the “contents” attribute value of the new element. When a new element corresponding to the nonkey element has been already created, the replacement resulting character string at step A35 is connected to the tail of a replacement resulting character string in the “contents” attribute value of the new element, and described (step A36). After that, the procedure goes back to the process at step A7.

In the second example of the reversely converting process procedure shown in FIG. 34, when a new element (<information>tag) obtained by collecting nonkey elements is cut out at step B7 (YES route at step B11), character strings “&lt;” and “&gt;” in description of “contents” attribute value of the new element are restored to the original symbols “<” and “>”, respectively (step B33). When another character string of entity reference description is included in the “contents” attribute value of the new element at step B33, the character string is restored to an original symbol relating to tagging (refer to table 1).

Description of the element (<information>tag) obtained by collecting the nonkey elements is deleted in a restored XML document, and the “contents” attribute value (restored result at step B33) of this element (<information>tag) is inserted adjacent to a key element as the element content (step B34). After that, the procedure goes back to the process at step B7.

[2-5-3] Third Example of Converting/Reversely Converting Processing Procedure

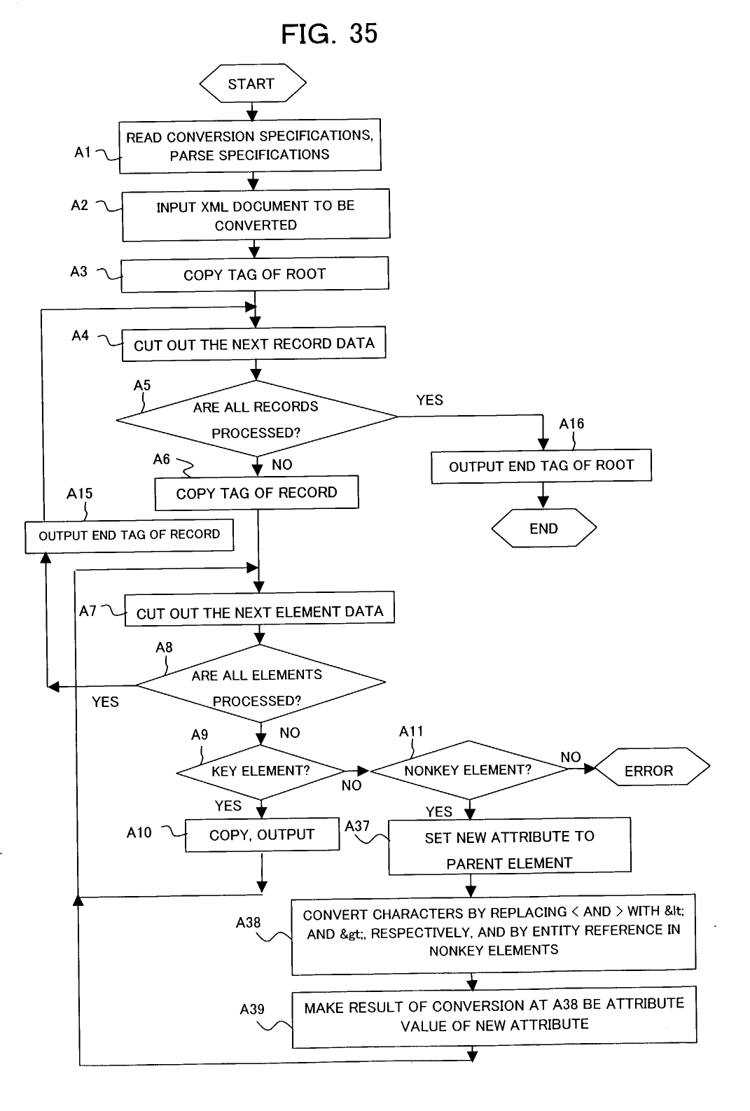

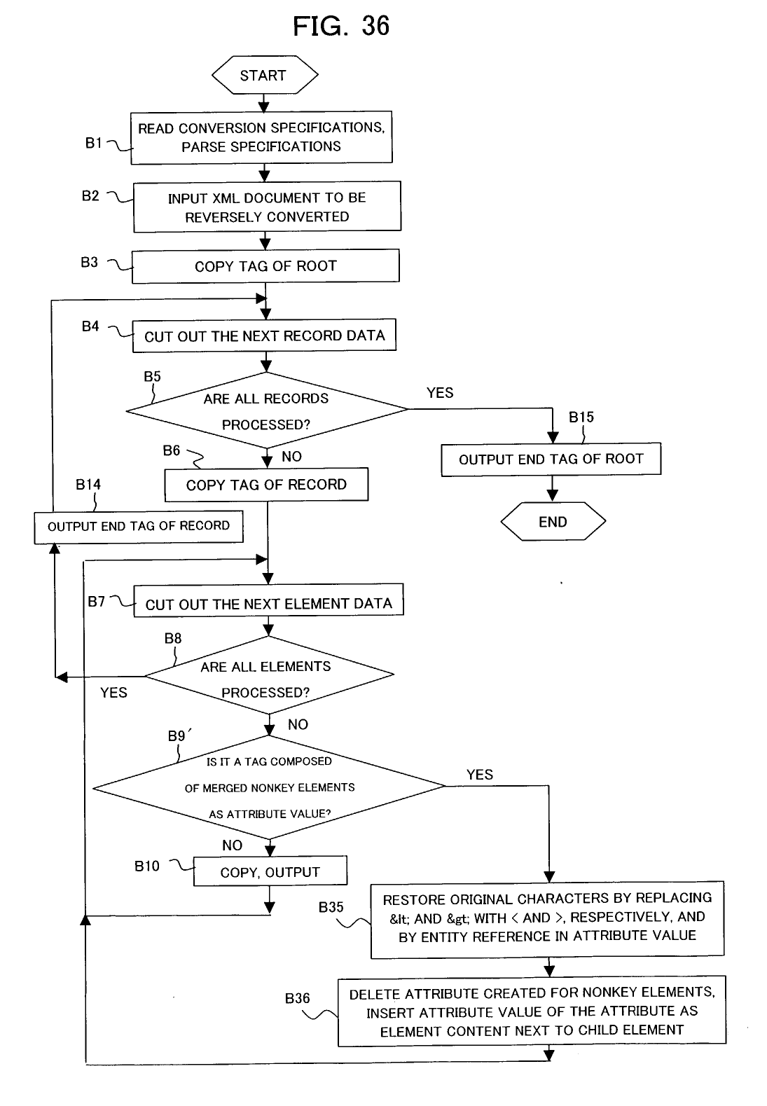

FIG. 35 is a flowchart for illustrating a third example of a processing procedure applied when data structure conversion is performed on an XML document to be converted on the basis of a conversion specification document. FIG. 36 is a flowchart for illustrating a third example of a processing procedure applied when data structure reverse conversion is performed on a converted XML document (processed XML document) on the basis of the conversion specification document. The third examples to be described here correspond to the converting method described above with reference to FIG. 25.

The third example of the converting process procedure shown in FIG. 35, when element data cut out at step A7 is a nonkey element (YES route at step All), a new attribute of an attribute name “contents” is set to a parent element (<individual>tag) (step A37). When a new attribute has been already set, this creating process is omitted.

Tag symbols “<” and “>” in description of the nonkey element are replaced with character strings “&lt;” and “&gt;” of entity reference description, respectively (step A38). When the same character as a symbol relating to tagging (refer to table 1) appears in the content of the nonkey element at step A38, this character is replaced with a character string of entity reference description.

When a new attribute is set at step A37, a replacement resulting character string at step A38 is described as “contents” attribute value of a parent element. When a new attribute corresponding to the nonkey element has been already set, the replacement resulting character string at step A37 is connected to the tail of a replacement resulting character string in the “contents” attribute value of the parent element, and described (step A39). After that, the procedure goes back to the process, at step A7.

In a third example of the reversely converting process procedure shown in FIG. 36, a process at step B9′ is performed in place of the processes at steps B9 and B11 described above. At step B9′, it is determined whether an element cut out at step B7 is a merging parent element (here, “<individual>tag having “contents” attribute value) obtained by collecting nonkey elements into “contents” attribute value.

When the element is not a merging parent element (NO route at step B9′), the procedure goes to the process at step B10 described above. When the element is a merging parent element (YES route at step B9′), character strings “&lt;” and “&gt;” in description of the “contents” attribute value of the parent element are restored to the original tag symbols “<” and “>”, respectively (step B35). When another character string of entity reference description is included in the “contents” attribute value of the parent element at step B35, the character string is restored to an original symbol relating to tagging (refer to table 1).

Description of an attribute set for nonkey elements in the parent element is deleted in a restored XML document, and the “contents” attribute value (restored result at step B35) of the attribute is inserted next to description of the original child element (step B36), and the procedure goes back to the process at step B7.

[2-5-4] Fourth Example of Converting/Reversely Converting Process Procedure

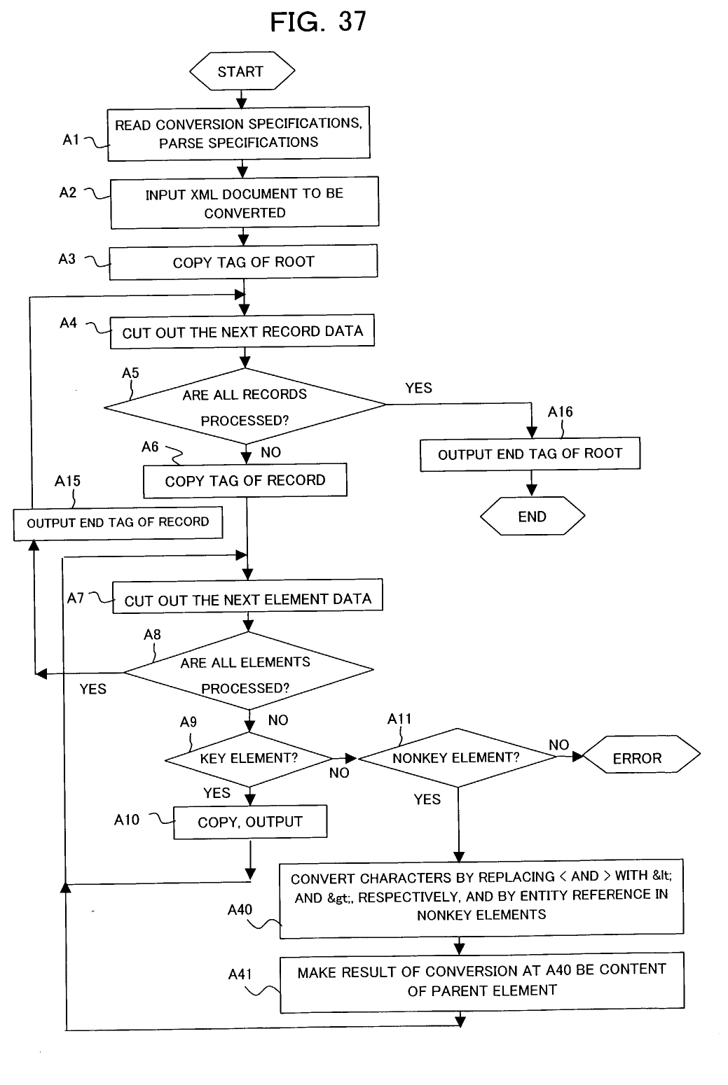

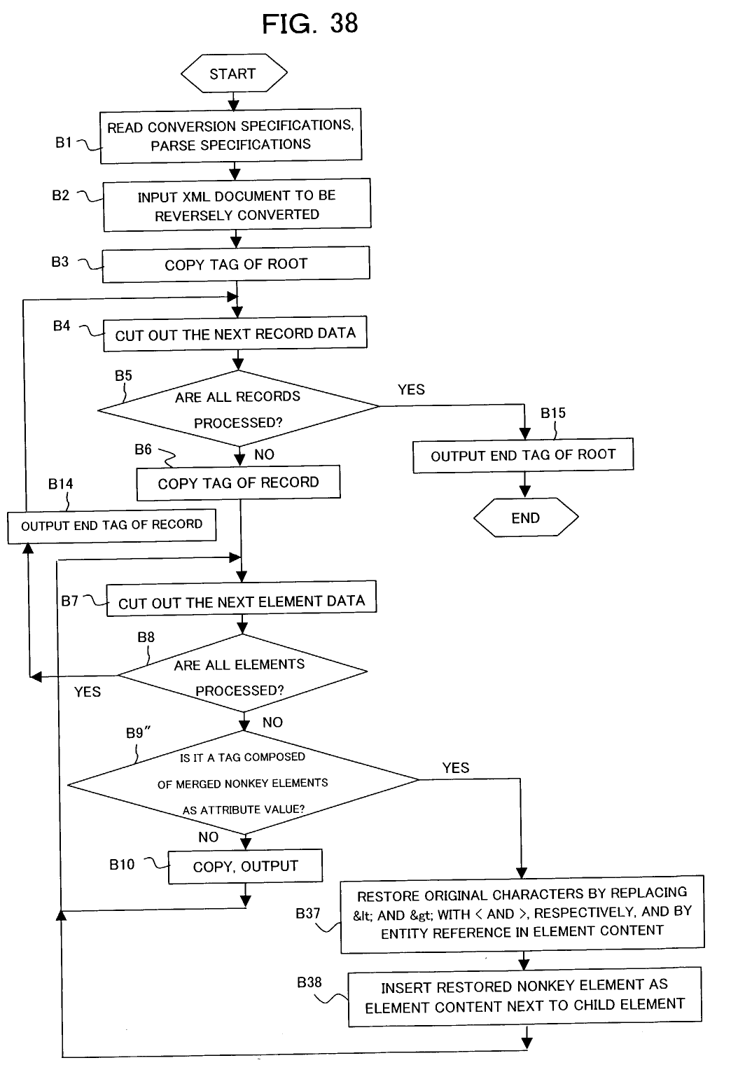

FIG. 37 is a flowchart for illustrating a fourth example of a processing procedure applied when data structure conversion is performed on an XML document to be converted on the basis of a conversion specification document. FIG. 38 is a flowchart for illustrating a fourth example of a processing procedure applied when data structure reverse conversion is performed on a converted XML document (processed XML document) on the basis of the conversion specification document. The fourth examples to be described here correspond to the converting method described above with reference to FIG. 26.

In the fourth example of the converting process procedure shown in FIG. 37, when element data cut out at step A7 is a nonkey element (YES route at step A11) tag symbols (“<” and “>”) in the description of nonkey element are replaced with character strings “&lt;” and “&gt;” of entity reference description, respectively (step A40). When the same character as a symbol relating to tagging (refer to table 1) appears in the content of the nonkey element at step A40, the character is replaced with a character string of entity reference description. A replacement resulting character string at step A40 is described as the content of a parent element (<individual>tag) of the nonkey element (step A41). After that, the procedure goes back to the process at step A7.

In the fourth example of the reversely converting process procedure shown in FIG. 38, a process at step B9″ is executed in place of the process at step B9′ described above. At step B9″, it is determined whether the element cut out at step B7 is a merging parent element obtained by collecting nonkey elements as the element content.

When the element is not a merging parent element (NO route at step B9″), the procedure goes to the process at step B10 described above. When the element is a merging parent element (YES route at step B9″), character strings “&lt;” and “&gt;” in description of the element content of the parent element are restored to original tag symbols “<” and “>”, respectively (step B37). When another character string of entity reference description is included in the element content of the parent element, the character string is restored to an original symbol relating to tagging (refer to table 1). A result restored at step B37 is inserted as the element content next to the description of the original child element in a restored XML document (step B38). After that, the procedure goes back to the process at step B7.

[2-5-5] Fifth Example of Converting/Reversely Converting Process Procedure

FIGS. 39A through 39D show processing procedures applied when data structure converting/reversely converting process according to the second embodiment is executed by only an XSLT processor. Namely the processing procedures shown in FIGS. 39A through 39D are processing procedures at the time that a process is executed on an XML document to be converted or a converted XML document on the basis of a conversion specification document using the data structure converting/reversely converting mechanism 10 shown in FIG. 2.

FIGS. 39A and 39B are flowcharts for illustrating procedures for creating a style sheet for conversion and a style sheet for reverse conversion (processing at the XSLT converting unit 11) according to the second embodiment.

FIG. 39C is a flowchart for illustrating a processing procedure (fifth example of the converting process procedure) applied when the XSLT structure converting unit 12 performs data structure conversion on an XML document to be converted on the basis of a style sheet for structure conversion according to the second embodiment. FIG. 39D is a flowchart for illustrating a processing procedure (fifth example of the reversely converting process procedure) applied when the XSLT reversely converting unit 13 performs data structure reverse conversion on a converted XML document (processed XML document) on the basis of a style sheet for reverse conversion according to the second embodiment.

In prior to a process on an XML document to be converted, the XSLT converting unit 11 reads a conversion specification document described in XML, and parses conversion specifications on the basis of the description of the conversion specification document (step A1), as shown in FIG. 39A. The XSLT converting unit 11 creates a style sheet for data structure conversion using the conversion specifications and an automatic conversion style sheet (step A20). Similarly, as shown in FIG. 39B, the XSLT converting unit 11 reads the conversion specification document described in XML, and parses conversion specifications on the basis of description of the conversion specification document (step B1). The XSLT converting unit 11 creates a style sheet for data structure reverse conversion using the conversion specifications and an automatic conversion style sheet (step B20). Incidentally, the processing procedures described above with reference to FIGS. 39A and 39B are similar to those described with reference to FIGS. 20A and 20B in the first embodiment.

When data structure conversion is performed on an XML document to be converted, as shown in FIG. 39C, the XSLT structure converting unit 12 designates an XML document to be converted and a style sheet for structure conversion, and starts the converting process (step A21). After that, the XSLT structure converting unit 12 executes a process similar to the process at and after step A2 in FIG. 31, 33, 35 or 37 according to a method selected from among the four converting methods (the converting methods described above with reference to FIGS. 23 through 26).

When data structure reverse conversion is performed on a converted XML document, as shown in FIG. 39D, the XSLT reversely converting unit 13 designates an XML document to be converted conversion and a style sheet for reverse conversion, and starts a reversely converting process (step B21). After that, the XSLT reversely converting unit 13 executes a process similar to the process at and after step B2 shown in FIG. 32, 34, 36 or 38 according to a method selected from among the four converting methods (converting methods having described with reference to FIGS. 23 through 36).

According to the second embodiment, the application software 30 performs a process such as tag-dependent content retrieval or the like on a converted XML document, in which the number of elements is decreased, fed from the XSLT structure converting unit 12 through the standard API (DOM) 20, as shown in FIG. 2. Like the first embodiment, the processing speed of the application software 30 is largely increased.

[2-6] Effects of Second Embodiment

In the structured document converting method according to the second embodiment of this invention, elements constituting an XML document to be converted are separated into key elements and nonkey elements. The XML document to be converted is converted to an XML document, in which the key elements are described unchanged, whereas the nonkey elements are collected into one tag, and tag symbols in description of the nonkey elements are replaced with character strings not relating to tagging. The method according to the second embodiment can provide the similar effects and advantages to those provided by the structured document converting method according to the first embodiment. It is possible to extremely readily convert an XML document by replacing tag symbols “<” and “>” with character strings “&lt;” and “&gt;” of entity reference description, respectively.

[3] Description of Third Embodiment

[3-1] Principle of Structured Document Converting Method According to Third Embodiment

Next description will be made of the principle of a structured document converting method according to a third embodiment of this invention with reference to FIGS. 1A, 3A and 40.

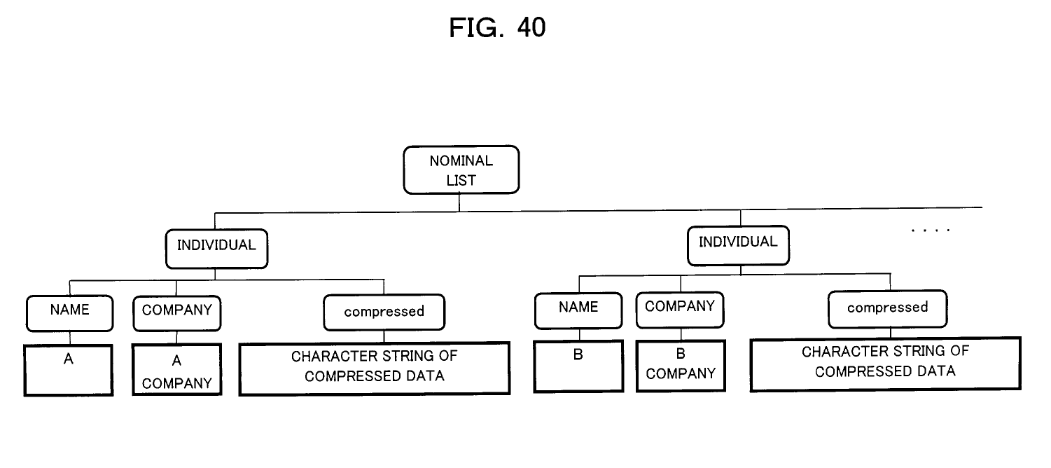

In the XML document described above with reference to FIGS. 1A and 3A, elements of tag names “name” and “company” are assigned as key elements, whereas elements of tag names “department”, “address” and “telephone” are assigned as nonkey elements. FIG. 40 shows a memory expansion form of a converted XML document obtained by applying a structured document converting method according to the third embodiment to the above XML document. Incidentally, the expansion form shown here is an expansion form on a memory at the time that the application software operates a converted XML document through the standard API (DOM).

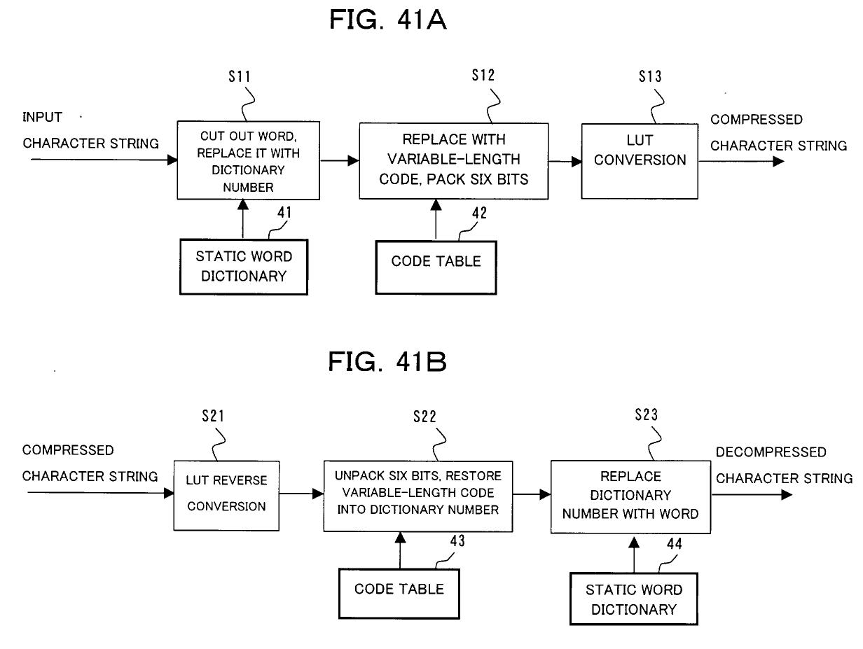

In the XML document shown in FIG. 40, a new element given a tag name “compressed” is created, and a compressed character string obtained by compressing a character string that is obtained by collecting the nonkey elements of the tag names “department”, “address” and “telephone” into one is described as the content of the new element. The compressed character string is obtained by compressing a character string obtained by collecting the nonkey elements into one in a data converting method of this invention to be described later with reference to FIG. 41A. The key elements of the tag names “name” and “company” are described unchanged.

In a converted XML document, nonkey elements collected into one element in each record is converted into a compressed character string in a predetermined data converting method, and described as above, whereby the number of elements contained in the XML document, that is, the number of elements of child elements in a tree expanded on the memory, can be largely decreased, and the nonkey elements can be collectively handled at the time of expansion or data processing.

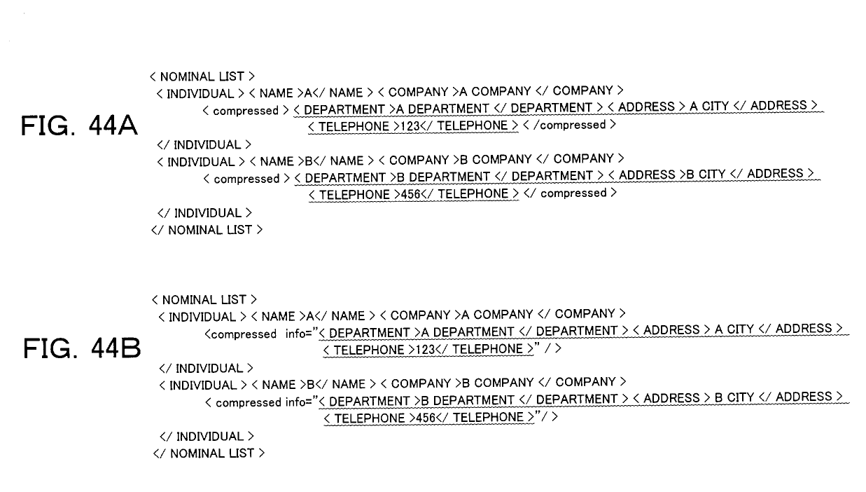

The compressed character string may be described as the content of a new element (refer to FIGS. 40 and 44A), or described as the attribute value of the new element (refer to FIG. 44B) in a converted XML document. FIG. 40 for illustrating the principle of the converting method according to the third embodiment shows a DOM tree of a converted XML document in the case where the above compressed character string is described as the content of a new element.

[3-2] Data Converting Method (Data Compressing/Decompressing Method) According to Third Embodiment

Generally, a compressed file cannot be put in an XML document composed of only character codes since the compressed file is binary data, as described above in Known Technique 3.

According to the data converting method of this invention, binary compressed data is converted into character codes, so that the compressed data (compressed character string) can be described as an element content or an attribute value of an XML document.

At that time, it must be noted that a character code having a special meaning in a structured document should not be included in a set of character codes used in a compressed character string. In the case of XML documents, character codes having the above special meanings are symbols “<”, “>”, “&”, “”” and “'” relating to tagging shown in Table 1.

XML documents can be in various character code systems (UTF-8, UTF-16, Shift_JIS, EUC and the like). For this, if compressed data is expressed simply by character codes, a compressed character string expressing the compressed data would be automatically converted when the character code system of the XML document is converted. As a result, there is a possibility that the compressed data cannot be restored to the original state.

In consideration of the above point that should be paid attention and disadvantage, the data converting method of this invention employs ASCII codes in which character codes relating to tagging are eliminated as character codes expressing compressed data (compressed character strings). ASCII codes are a character code set commonly included in various character code systems. Only if a compressed character string is described in ASCII codes, it is possible to maintain a bit string configuring a compressed character string in the original state without converted even when a character code system of an XML document including the compressed character string is converted.

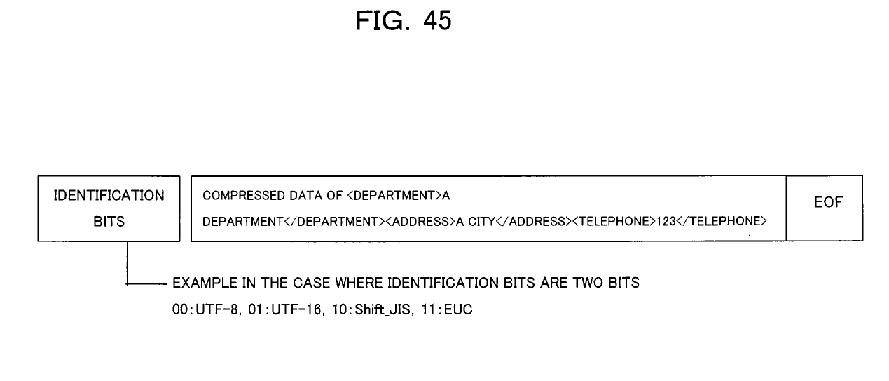

As will be described later with reference to FIG. 45, information representing a type of a character code system used in compressing a compressed character string is given to the compressed character string, whereby a type of the character code system of restored data can be recognized from the compressed character string. The character code system is agreed with the present character code system of the XML document to keep conformity of the character code system of the whole XML document.

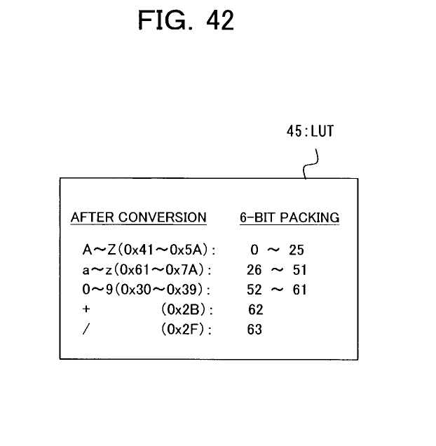

Now, more detailed description will be made of the data converting method (data compressing/decompressing method) according to the third embodiment with reference to FIGS. 41A, 41B and 42. FIG. 41A is a diagram for illustrating a flow of a data converting process (compressing process). FIG. 41B is a diagram for illustrating a flow of a data reversely converting process (decompressing process) FIG. 42 is a diagram showing a practical example of a lookup table (LUT) for character code conversion according to the third embodiment.

When an input character string (character string constituting nonkey elements in this embodiment) is compressed and packed into character codes, the input character string is collated with a word (character string) registered in a static word dictionary for compression (static dictionary) 41, a word longest-matched with a word in the word dictionary 41 is successively cut out from the input character string, and the word cut out is replaced with a dictionary number corresponding to the word, as shown in FIG. 41A (step S11).

Meanwhile, a data compression method with the static word dictionary 41 is a known technique using a dictionary beforehand created, which is disclosed in Japanese Patent Laid-Open Publication Nos. 1991-247167 (Dictionary registration method and data compression method), 1992-80813 (Dictionary Initialization Method), 1994-222903 (Method and means providing static dictionary structures for compressing character data and expanding compressed data), etc. The static word dictionary 41 or 44 according to the third embodiment is beforehand created by examining the frequencies of appearance of samples.

Next, a code table 42, in which code words of variable lengths assigned according to the frequencies of appearance are collected, is referred, a variable-length code corresponding to the dictionary number of fixed-length bits is taken out, the dictionary number is replaced with a variable-length code, and a bit packing process is performed so that the variable-length code becomes data of each byte. At this time, byte packing is performed to pack each six bits of binary data obtained by variable length coding into data of each byte (step S12). Namely, at step S12, variable length coding (statistical data compression) is performed to assign a shorter variable length code to a word or a character string (dictionary number in this embodiment) to be converted having a higher frequency of appearance, each six bits of binary data obtained by the variable length coding is packed into conversion data of one byte and outputted.

After that, each conversion data of one byte (data of one byte in which six bits are packed) is converted to a code of the character code using a lookup table (LUT) for character code conversion 45 as shown in FIG. 42, for example, and a result of conversion is outputted as a compressed character string (step S13).

The LUT 45 is used for character code conversion (BASE 64 coding) at the time of six-bit packing as above, which sets the relationships between values 0-63 each expressed by six bits and codes of character codes corresponding to respective values 0-63. Particularly, the LUT 45 shown in FIG. 42 is so created as to relate six-bit values 0-63 with character codes of A-Z(0×41-0×5A), a-z(0×61-0×7A), 0-9(0×30-0×39), +(0×2B) and/(0×2F).

A set of ASCII codes in the LUT 45 does not include tag symbols “<” and “>”. Namely, a set of ASCII codes excluding character codes relating to tagging in XML documents is registered in the LUT 45. In LUT converting process at step S13, it is unnecessary to perform a special escape process such as to convert a tag symbol to another character string not relating to tagging.

With the LUT 45 as above, six-bit data packed into each conversion data is converted to a character code according to ASII codes (code corresponding to a printable character of ASCII codes), and a character code obtained for each conversion code is outputted as a result of compressing conversion, that is, a compressed character string.

When the compressed character string compressed as above is restored to the original character string, as shown in FIG. 41B, LUT reverse conversion is performed to convert each character code of the compressed character string is converted into a numeral value (six-bit value) of 0-63 on the basis of the LUT 45 (step S21).

After that, a process of cancelling six-bit-packing, that is, depacking (unpacking) is performed to take out six-bit data from each conversion data of one byte, and binary data taken out is restored into a dictionary number of a fixed-length bit on the basis of a code table 43 (step S22).

Each dictionary number restored at step S22 is collated with a dictionary number of a static word dictionary for restoration (static dictionary) 44 to read a word (character string) corresponding to each dictionary number, and each dictionary number is replaced with a word (character string) read out, whereby the dictionary number is restored into the original character string (step S23).

Next, description will be made of a converting/reversely converting process on an XML document, which is a representative of structured documents, using the above data compressing/decompressing method.

[3-3] System and Flow of Converting/Reversely Converting Process According to Third Embodiment

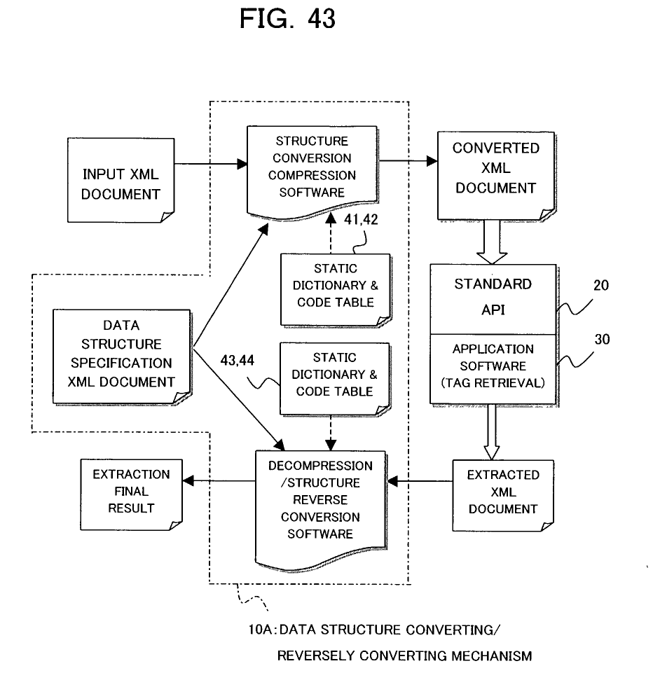

FIG. 43 is a diagram for illustrating a system to which a structured document converting method according to the third embodiment of this invention is applied and a flow of a converting/reversely converting process in the system.

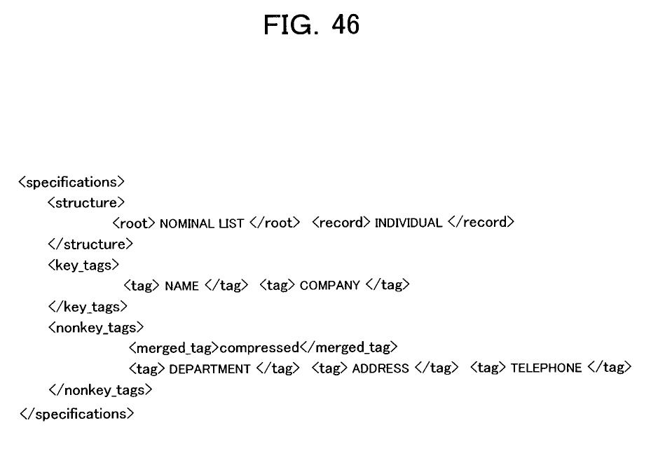

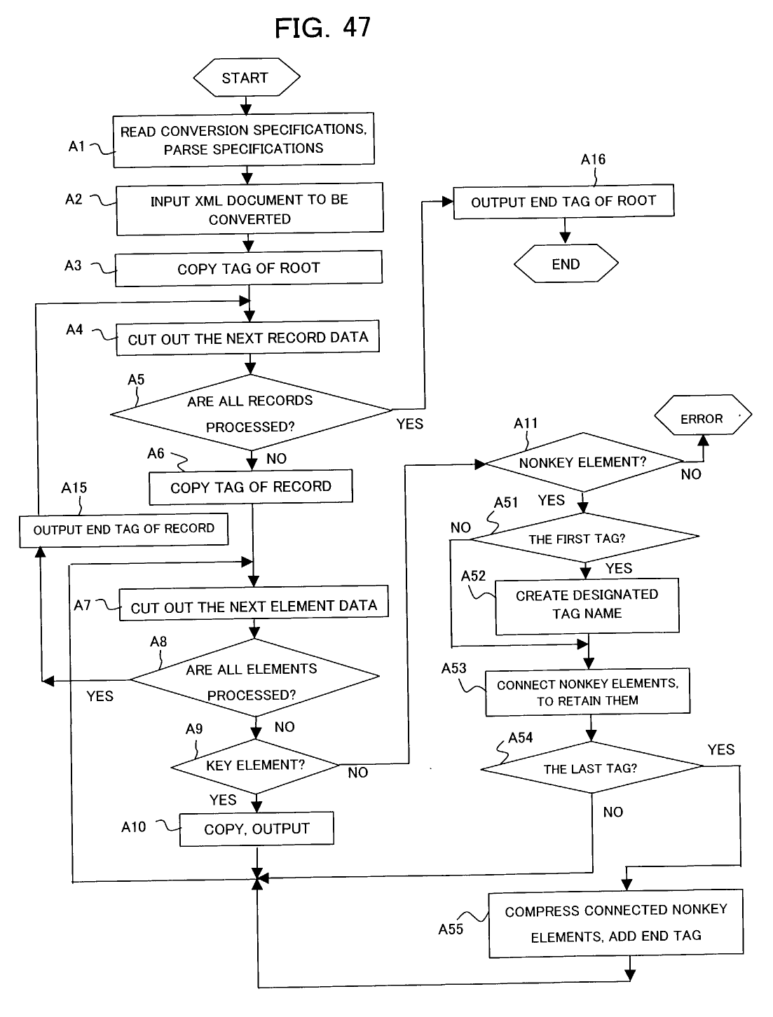

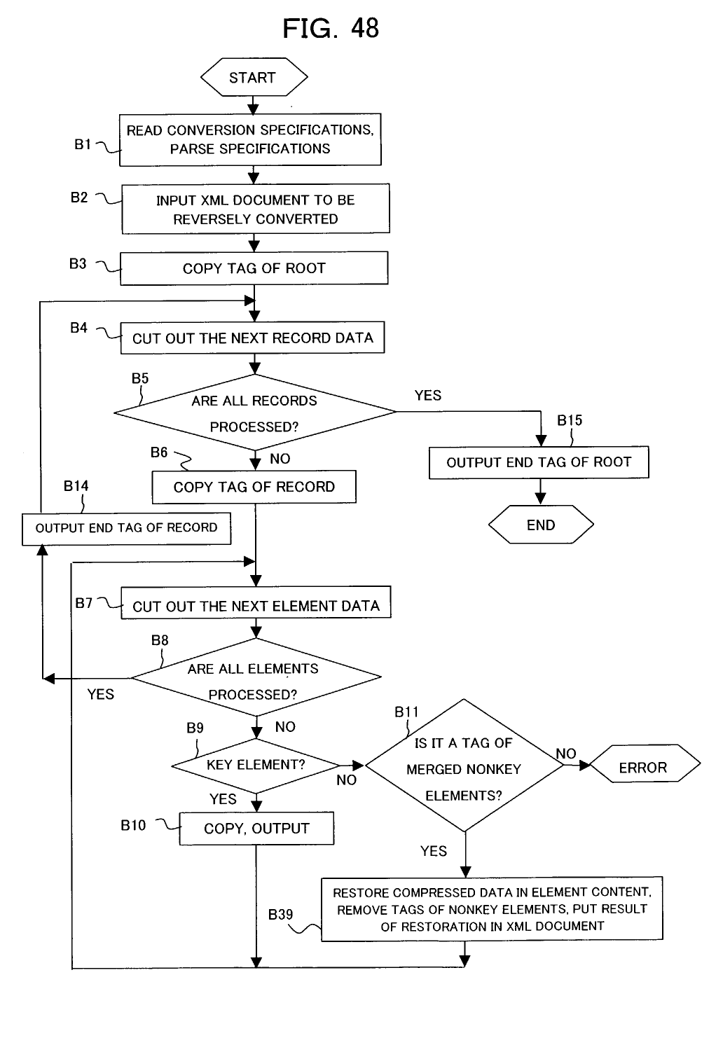

It is quite troublesome to create a style sheet (XSL sheet) coping with each of various types of XML documents. In order to omit this trouble, specifications (record name, key tag name, nonkey tag name, etc.) to convert the data structure of an XML document is created by an XML document (conversion specification document) to give a conversion execution procedure as will be described later with reference to FIG. 46, and conversion/reverse conversion of the XML document is performed on the basis of the conversion specification document as will be described later with reference to FIGS. 47 and 48, in the third embodiment.

A system shown in FIG. 43 comprises a data structure converting/reversely converting mechanism (processor) 10A, a standard API 20 and application software 30. The data structure converting/reversely converting mechanism 10A reads a conversion specification document (XML document) describing information for discriminating between key elements and nonkey elements, and information relating to new elements (elements describing compressed character strings), performs a converting process on an input XML document by structure conversion compression software obtained on the basis of the conversion specification document, and outputs a converted XML document.

The data structure converting/reversely converting mechanism 10A operating by structure conversion compression software creates a new element given a predetermined tag name (“compressed” in this embodiment), and compresses a character or a character string constituting a nonkey element in the data compressing method having been described above with reference to FIG. 41A using the static word dictionary for compression 41, the code table 42 and the LUT 45 to create a compressed character string. The data structure converting/reversely converting mechanism 10A then describes the compressed character string as the content or attribute of the new element in a converted XML document, while describing key elements unchanged in the converted XML document.

The converted XML document is undergone a data processing (tag-dependent content retrieval, for example) by the application software 30 through the standard API 20, and an XML document undergone the data processing is obtained. When tag-dependent content retrieval is performed as the data processing, a result of retrieval is obtained in the form of an extracted XML document. The extracted XML document is read by the data structure converting/reversely converting mechanism 10A. The data structure converting/reversely converting mechanism 10A performs reversely converting process on the extracted XML document by decompression/data structure reverse conversion software obtained by the above conversion specification document, and outputs a final result of extraction.

Namely, the data structure converting/reversely converting mechanism 10A operating by the decompression/structure reverse conversion software restores a compressed character string in an element given a predetermined tag name (“compressed” in this embodiment) into the original character string of nonkey elements using the static word dictionary for restoration 43, the code table 44 and the LUT 45 in the data restoring method described above with reference to FIG. 41B, restores the document to an XML document in the original structure, and outputs it. Whereby, the XML document is obtained as a final result of the data processing.

At this time, the application software 30 performs a process such as tag-dependent content retrieval or the like on a converted XML document, in which the number of elements has been decreased, from the data structure converting/reversely converting mechanism 10A through the standard API (DOM) 20, as shown in FIG. 43. The processing speed by the application software 30 is thus largely increased, like the first and second embodiments.

When the application software 30 performs tag-dependent content retrieval on a converted XML document, an XML document (extracted XML document) describing a record hit in the tag-dependent content retrieval is extracted and outputted. The extracted XML document is reversely converted by the data structure converting/reversely converting mechanism 10A, so that a result of retrieval (XML document) quite identical to one obtained when the application software 30 has performed tag-dependent content retrieval on the original XML document.

Since an XML document on which the data structure converting/reversely converting mechanism 10A performs reverse conversion is an XML document extracted by the application software 30 in which a small number of records are described, the overhead of reverse conversion by the data structure converting/reversely converting mechanism 10A causes little problem. Accordingly, by beforehand performing data structure conversion according to this embodiment, the process performed a large number of times by the application software 30 can be largely speed up, and the amount of the operational memory used can be largely decreased.

[3-4] XML Document Converting Method and Practical Example of Conversion According to Third Embodiment

FIGS. 44A and 44B show first and second practical examples of results of conversion obtained by applying the structure document converting method according to the third embodiment to a table-form XML document shown in FIG. 4A. Wherein, elements of tag names “name” and “company” are key elements, whereas elements of tag names “department”, “address” and “telephone” are nonkey elements. Incidentally, portions underlined by wavy lines in FIGS. 44A and 44B are parts (character strings) to be undergone a compressing process in the data compressing method described above with reference to FIG. 41A.

In the first practical example shown in FIG. 44A, elements constituting an XML document to be converted are separated into key elements and nonkey elements, a new element given a tag name “compressed” is created, the nonkey elements are collected into one and compressed in the data compressing method described above with reference to FIG. 41A to create a compressed character string. The compressed character string is described as the content of the new element. The key elements are described unchanged without any conversion in an converted XML document.

In the first record of a converted XML document shown in FIG. 44A, a compressed character string obtained by compressing a series of nonkey elements <department>A department</department><address>A city</address><telephone>123</telephone>in the data compressing method described above with reference to FIG. 41A is described as the element content of an element of a tag name “compressed.” In the second record, a compressed character string obtained by compressing a series of nonkey elements <department>B department</department><address>B city</address><telepohone>456</telephone>in the data compressing method described above with reference to FIG. 41A is described as the element content of an element of a tag name “compressed”.

In the second practical example shown in FIG. 44B, elements constituting an XML document to be converted are separated into key elements and nonkey elements, a new element (empty element) given a tag name “compressed” and an attribute name “info” is created, the nonkey elements are collected into one and compressed in the data compressing method described above with reference to FIG. 41A to create a compressed character string. The compressed character string is described as the attribute value corresponding to the attribute name “info” of the new element. The key elements are described unchanged without any conversion in a converted XML document.

In the first record in the converted XML document shown in FIG. 44B, a compressed character string obtained by compressing a series of nonkey elements <department>A department</department><address>A city</address><telephone>123</telephone>in the data compressing method described above with reference to FIG. 41A is described as the attribute value of an attribute name “info” of an element of a tag name “compressed”. In the second record, a compressed character string obtained by compressing a series of nonkey elements <department>B department</department><address>B city</address><telephone>456</telephone>in the data compressing method described above with reference to FIG. 41A is described as the attribute value of an attribute name “info” of an element of a tag name “info”.

Although XML documents can include only character codes, compressed data (compressed character string) obtained in the compressing method described above can be described unchanged in an XML document because it is described by character codes. In XML documents, tag symbols “<” and “>” have special meanings, but character codes of compressed data are printable characters in ASCII codes excluding the tag symbols. For this, even if compressed data is described as an element content or an attribute value, the entire is assumed to be text.

In the converting method according to the third embodiment, a plurality of nonkey elements are collected into one element, thus the nonkey elements can be handled as elements not relating to data processing while the application software executes the data processing, like the first and second embodiment. Which one of the methods described above with reference to FIGS. 44A and 44B is to be used as the converting method can be selected and designated in the conversion specification document or the like. Either one of these converting methods is to be used is determined according to the amount of data of an XML document or how many elements are increased due to the data processing. In consideration of the principle of this invention that nonkey elements are collected and handled, either way can be employed.

As shown in FIG. 45, identification bits (here, two bits) as information representing a type of the character code system of an XML document at the time of compression are added to the head of a compressed character string (compressed data) described in a converted XML document, according to the third embodiment.

If the character code system of an XML document is fixed to, for example, UTF-8 and the character code system is not converted at all, no problem would occur. However, XML documents can be in UTF-16, Shift_JIS, EUC, etc. other than UTF-8. When the character code system is changed, the present invention copes with it as follows:

If a specific character code system is selected as the character code system of a compressed character string, the character code system of the compressed character string would be automatically converted when the character code system of the XML document is changed from one at the time of compression, which generally causes a change in arrangement of bits, generally. This further causes possibility that the compressed character string cannot be restored to the original state.

According to this invention, a compressed character string is described in ASCII codes commonly included in all character code systems, so that the arrangement of bits in the compressed character string is not changed even when the character code system of the original XML document is converted. It is thus possible to normally restore the compressed character string.

When the character code system of an XML document is converted to the arbitrary character code system from one at the time of compression, it is necessary to restore a compressed character string to recognize a type of the character code system, and match the character code system with a character code system of the XML document at present (at the time of reverse conversion). According to the third embodiment, identification bits for identifying a type of the character code system at the time of compression are added to the header of compressed data, as shown in FIG. 45.

When types of the character code system to be identified is four, UTF-8, UTF-16, Shift_JIS and EUC, two bits of identification bits are set. In this case, there are defined that “00” represents UTF-8, “01” represents UTF-16, “10” represents Shift_JIS and “11” represents EUC, for example. The identification bits are added to a series of nonkey elements to be compressed, and converted to a compressed character string along with the nonkey elements in the data compressing method described above with reference to FIG. 41A.

[3-5] Practical Example of Conversion Specification Document According to Third Embodiment

FIG. 46 shows a practical conversion specification document (XML document) applied when the table-form XML document shown in FIG. 4A is converted. Here, the XML document to be converted is table-form data. However, even if the XML document to be converted is nontable-form data, conversion/reverse conversion is possible using the conversion specification document shown in FIG. 46. The conversion specification document shown in FIG. 46 is for accomplishing the converting method described above with reference to FIG. 44A.

The conversion specification document shown in FIG. 46 describes a tag name “nominal list” of root and a tag name “individual” of record. Additionally, there are described tag names “name” and “company” of key elements as the content of an element of a tag name “key_tags”, and tag names “department”, “address” and “telephone” of nonkey elements as the content of an element of a tag name “nonkey_tags”, whereby information for discriminating between the key elements and the nonkey elements is described. The content of an element of a tag name “nonkey_tags” includes an element of a tag name “merged_tag”, and a tag name “compressed” of a new element for collecting the nonkey elements into one is described as the content of the element. The conversion specification document as above instructs a procedure for execution of XML document data structure conversion.

[3-6] Practical Converting Process Procedure in Converting Method According to Third Embodiment

Now, description will be made of converting process procedures in the structured document converting method according to the third embodiment of this invention, with reference to FIGS. 47 and 48. Incidentally, at steps in FIGS. 47 and 48 denoted by the same step numbers as those in FIGS. 18 and 19, processes identical or almost identical to those described above with reference to FIGS. 18 and 19 are executed, descriptions of which are thus omitted. In the following description, descriptions of processes at steps A1 through A11, A15, A16, B1 through B11, B14 and B15 are omitted.

FIG. 47 is a flowchart for illustrating a processing procedure applied when data structure conversion is performed on an XML document to be converted on the basis of a conversion specification document. FIG. 48 is a flowchart for illustrating a processing procedure applied when data structure reverse conversion is performed on a converted XML document (processed XML document) on the basis of the conversion specification document.

According to the third embodiment, the data structure converting/reversely converting mechanism 10A executes the structure conversion compression software or decompression structure reverse conversion software described above with reference to FIG. 43 to read a conversion specification document according to the flowchart shown in FIG. 47 or 48, and executes a converting/reversely converting process (data compressing/decompressing process) while referring to the code table 41 or 44, the static word dictionary for compression or decompression 42 or 43, and the LUT 45.

In the procedure for a converting process shown in FIG. 47, when an element data cut out at step A7 is a nonkey element (YES route at step A11), it is determined whether the nonkey element is the first one in a group of nonkey elements to be collected into one element (step A51). When the nonkey element is the first one (YES route at step A51), the start tag of a tag name “compressed” beforehand designated in a conversion specification document is created (step A52), and the nonkey element cut out this time is retained (step A53).

When the nonkey element is not the first one (NO route at step A51), that is, when a new element corresponding to a nonkey element has been already created, the procedure jumps over a process of creating a start tag at step A52, and the nonkey element cut out this time is connected to the tail of a nonkey element having been already cut out and retained (step A53).

After that, it is determined whether the nonkey element is the last one in the group of nonkey elements to be collected into one element (step A54). When the nonkey element is not the last one (NO route at step A54), the procedure goes back to the process at step A7.

When the nonkey element is the last one (YES route at step A54), identification bits representing a type of the character code system are added to nonkey elements collected at step A53, a compressing process is performed on it in the data compressing method described above with reference to FIG. 41A, and a compressed character string is obtained. The compressed character string is described as the content of the new element after the start tag of a tag name “compressed”, and the end tag of the tag name “compressed” is created and added thereafter (step A55) After that, the procedure goes back to the process at step A7.

Here is described a case where a process corresponding to the converting method described above with reference to FIG. 44A is performed. When the converting method described above with reference to FIG. 44B is employed, an empty tag having a tag name “compressed” and an attribute name “info” is created as a new element at step A52, and a compressed character string is described as the attribute value of “info” attribute of the new element (empty element) at step A55.

In a procedure for an reversely converting process shown in FIG. 48, when a new element (<compressed>tag) obtained by collecting nonkey elements is cut out at step B7 (YES route at step B11) a compressed character string described as the content (or an attribute value) of the new element is read out, an original character string configuring nonkey elements is restored from the compressed character string in the data decompressing method described above with reference to FIG. 41B, description of a tag of the nonkey elements is deleted, restored nonkey elements are described in a restored XML document (step B39), and the procedure goes back to the process at Step B7.

[3-7] Effects of Third Embodiment

In the structured document converting method according to the third embodiment of this invention, elements constituting an XML document to be converted are separated into key elements and nonkey elements. The key elements are described unchanged, whereas characters or character strings configuring the nonkey elements are collected into one tag. The XML document to be converted is converted into an XML document in which the nonkey element collected into one tag is described as a character code string (compressed character string) obtained by compressing them in the data compressing method shown in FIG. 41A. The third embodiment can provide effects and advantages similar to those provided by the first and second embodiments, and can largely decrease the amount of data of a converted XML document.

The third embodiment provides a compressing convertion technique that can obtain a result of compression in the form of character codes, and put them in an XML document while efficiently compressing the XML document by using the data compressing method described above with reference to FIG. 41A. Accordingly, a resource required for operation on an XML document is largely decreased, the amount of a memory used when the XML document is processed is decreased, and the processing speed is increased.

As character codes expressing compressed data, ASCII codes excluding symbols (“<”, “>”, “&”, “”” and “'” in XML documents, for example) relating to tagging are used. Therefore, no symbol relating to tagging is present in compressed character strings in a converted XML document, it is thus possible to certainly prevent erroneous processing from occurring in the data processing.

Since ASCII codes are a character code set commonly included in various character code systems, a bit string constituting a compressed character string using ASCII codes is not affected by conversion of the character code system and can be kept in the original state even when the character code system of a converted XML document is converted. The compressed character string included in the converted XML document whose character code has been converted can be appropriately restored to the original nonkey elements.

As shown in FIG. 45, identification bits representing a type of the character code system at the time of compression are added to a compressed character string, whereby a type of the character code system of data restored from the compressed character string can be recognized. The character code system is matched with the present character code system of the XML document, thereby keeping matching of the character code system of the whole XML document.

In prior to conversion of nonkey elements to a compressed character string, a character string configuring nonkey elements is replaced with a dictionary number using the static word dictionary 41 beforehand created, thereby to more shorten a character string that is an object of variable-length coding. This allows improvement of the compression efficiency, and a decrease in data amount of a converted XML document.

[4] Others

Note that the prevent invention is not limited to the above embodiments, but may be modified in various ways without departing from the scope of the invention.

For example, the structure documents are XML documents in the above embodiments, but this invention is not limited to this. The present invention may be applied to other various structured documents as in the above embodiments, and provide the similar effects and advantages.

What is claimed is:

1. A structured document converting method comprising the steps of:
separating elements constituting a structured document to be converted into key elements that are objects of data processing on said structured document and nonkey elements that are not objects of the data processing;
creating a new element given a predetermined tag name and a predetermined attribute name;
performing tag name conversion to create a tag name character string including tag names of said nonkey elements and describe said tag name character string as an attribute value corresponding to said predetermined attribute name in said new element;
performing content conversion to create a content character string including contents of said nonkey elements and describe said content character string as a content of said new element; and
describing said key elements unchanged in a converted structured document.

2. A structured document converting method comprising the steps of:
separating elements constituting a structured document to be converted into key elements that are objects of data processing on said structured document and nonkey elements that are not objects of the data processing;
creating a new element given a predetermined tag name, a predetermined first attribute name and a predetermined second attribute name;
performing tag name conversion to create a tag name character string including tag names of said nonkey elements and describe said tag name character string as a first attribute value corresponding to said first attribute name in said new element;
performing content conversion to create a content character string including contents of said nonkey elements and describe said content character string as a second attribute value corresponding to said second attribute name in said new element; and
describing said key elements unchanged in a converted structured document.

3. A structured document converting method comprising the steps of:
separating elements constituting a structured document to be converted into key elements that are objects of data processing on said structured document and nonkey elements that are not objects of the data processing:
performing tag name conversion to create a new element given a tag name character string, which is containing tag names of said nonkey elements, as a predetermined tag name;
performing content conversion to create a content character string including contents of said nonkey elements and describe said content character string as a content of said new element; and
describing said key elements unchanged in a converted structured document.

4. The structured document converting method according to claim 1, wherein said tag name character string is created by connecting tag names of said nonkey elements via (a) delimiter(s).

5. The structured document converting method according to claim 2, wherein said tag name character string is created by connecting tag names of said nonkey elements via (a) delimiter(s).

6. The structured document converting method according to claim 3, wherein said tag name character string is created by connecting tag names of said nonkey elements via (a) delimiter(s).

7. The structured document converting method according to claim 4, wherein when said nonkey elements are in a plurality of hierarchical layers, hierarchical structure identification information is added to tag names of said nonkey elements in said tag name character string.

8. The structured document converting method according to claim 5, wherein when said nonkey elements are in a plurality of hierarchical layers, hierarchical structure identification information is added to tag names of said nonkey elements in said tag name character string.

9. The structured document converting method according to claim 6, wherein when said nonkey elements are in a plurality of hierarchical layers, hierarchical structure identification information is added to tag names of said nonkey elements in said tag name character string.

10. The structured document converting method according to claim 4, wherein when said nonkey element has an attribute, an attribute name of said attribute, to which attribute name identification information is added, is described after a tag name of said nonkey element having the attribute via a delimiter in said tag name character string; and
said content character string is created by connecting contents of said nonkey elements via (a) delimiter(s), and an attribute value of said attribute is described via a delimiter after a content of said nonkey element having the attribute in said content character string.

11. The structured document converting method according to claim 5, wherein when said nonkey element has an attribute, an attribute name of said attribute, to which attribute name identification information is added, is described after a tag name of said nonkey element having the attribute via a delimiter in said tag name character string; and
said content character string is created by connecting contents of said nonkey elements via (a) delimiter(s), and an attribute value of said attribute is described via a delimiter after a content of said nonkey element having the attribute in said content character string.

12. The structured document converting method according to claim 6, wherein when said nonkey element has an attribute, an attribute name of said attribute, to which attribute name identification information is added, is described after a tag name of said nonkey element having the attribute via a delimiter in said tag name character string; and
said content character string is created by connecting contents of said nonkey elements via (a) delimiter(s), and an attribute value of said attribute is described via a delimiter after a content of said nonkey element having the attribute in said content character string.

13. The structured document converting method according to claim 1, wherein said content character string is created by connecting contents of said nonkey elements via (a) delimiter(s).

14. The structured document converting method according to claim 2, wherein said content character string is created by connecting contents of said nonkey elements via (a) delimiter(s).

15. The structured document converting method according to claim 3, wherein said content character string is created by connecting contents of said nonkey elements via (a) delimiter(s).

16. The structured document converting method according to claim 1, wherein a conversion specification document, which is describing information for discriminating between said key elements and said nonkey elements and describing information on said new element, is created; and
on said structured document to be converted, conversion of description of said nonkey elements is performed on the basis of said conversion specification document.

17. The structured document converting method according to claim 2, wherein a conversion specification document, which is describing information for discriminating between said key elements and said nonkey elements and describing information on said new element, is created; and
on said structured document to be converted, conversion of description of said nonkey elements is performed on the basis of said conversion specification document.

18. The structured document converting method according to claim 3, wherein a conversion specification document, which is describing information for discriminating between said key elements and said nonkey elements and describing information on said new element, is created; and
on said structured document to be converted, conversion of description of said nonkey elements is performed on the basis of said conversion specification document.

19. The structured document converting method according to claim 16, wherein on a structured document undergone said conversion, reverse conversion is performed on the basis of said conversion specification document to restore description of said nonkey elements to an original state.

20. The structured document converting method according to claim 17, wherein on a structured document undergone said conversion, reverse conversion is performed on the basis of said conversion specification document to restore description of said nonkey elements to an original state.

21. The structured document converting method according to claim 18, wherein on a structured document undergone said conversion, reverse conversion is performed on the basis of said conversion specification document to restore description of said nonkey elements to an original state.

22. The structured document converting method according to claim 19, wherein a tag name of said nonkey element is related with an abbreviated tag name which is shorter than said tag name and can specify said tag name, and described in said conversion specification document;
tag name abbreviating conversion is performed on the basis of said conversion specification document at the time of said conversion to replace said tag name of said nonkey element with said abbreviated tag name; and
tag name expanding conversion is performed on the basis of said conversion specification document at the time of reverse conversion to replace said abbreviated tag name with said tag name of said nonkey element.

23. The structured document converting method according to claim 20, wherein a tag name of said nonkey element is related with an abbreviated tag name which is shorter than said tag name and can specify said tag name, and described in said conversion specification document;
tag name abbreviating conversion is performed on the basis of said conversion specification document at the time of said conversion to replace said tag name of said nonkey element with said abbreviated tag name; and
tag name expanding conversion is performed on the basis of said conversion specification document at the time of reverse conversion to replace said abbreviated tag name with said tag name of said nonkey element.

24. The structured document converting method according to claim 21, wherein a tag name of said nonkey element is related with an abbreviated tag name which is shorter than said tag name and can specify said tag name, and described in said conversion specification document;
tag name abbreviating conversion is performed on the basis of said conversion specification document at the time of said conversion to replace said tag name of said nonkey element with said abbreviated tag name; and
tag name expanding conversion is performed on the basis of said conversion specification document at the time of reverse conversion to replace said abbreviated tag name with said tag name of said nonkey element.

25. The structured document converting method according to claim 22, wherein tag name abbreviating conversion information about whether said tag name abbreviating conversion is performed or not at the time of said conversion is described in said conversion specification document; and
execution/non-execution of said tag name abbreviating conversion and said tag name expanding conversion is selected on the basis of said tag name abbreviating conversion information in said conversion specification document at the time of said conversion or said reverse conversion.

26. The structured document converting method according to claim 23, wherein tag name abbreviating conversion information about whether said tag name abbreviating conversion is performed or not at the time of said conversion is described in said conversion specification document; and
execution/non-execution of said tag name abbreviating conversion and said tag name expanding conversion is selected on the basis of said tag name abbreviating conversion information in said conversion specification document at the time of said conversion or said reverse conversion.

27. The structured document converting method according to claim 24, wherein tag name abbreviating conversion information about whether said tag name abbreviating conversion is performed or not at the time of said conversion is described in said conversion specification document; and
execution/non-execution of said tag name abbreviating conversion and said tag name expanding conversion is selected on the basis of said tag name abbreviating conversion information in said conversion specification document at the time of said conversion or said reverse conversion.

28. The structured document converting method according to claim 1, wherein when said structured document to be converted is described in a table form in which kinds and the number of elements in each record are identical, a conversion specification document, which is describing information for discriminating between said key elements and said nonkey elements and describing information for relating tag names of said nonkey elements with a representative tag name as said predetermined tag name representing said tag names, is created; and
on said structured document to be converted, table-form conversion omitting said tag name conversion performing only said content conversion is performed on the basis of said conversion specification document.

29. The structured document converting method according to claim 2, wherein when said structured document to be converted is described in a table form in which kinds and the number of elements in each record are identical, a conversion specification document, which is describing information for discriminating between said key elements and said nonkey elements and describing information for relating tag names of said nonkey elements with a representative tag name as said predetermined tag name representing said tag names, is created; and
on said structured document to be converted, table-form conversion omitting said tag name conversion performing only said content conversion is performed on the basis of said conversion specification document.

30. The structured document converting method according to claim 3, wherein when said structured document to be converted is described in a table form in which kinds and the number of elements in each record are identical, a conversion specification document, which is describing information for discriminating between said key elements and said nonkey elements and describing information for relating tag names of said nonkey elements with a representative tag name as said predetermined tag name representing said tag names, is created; and
on said structured document to be converted, table-form conversion omitting said tag name conversion performing only said content conversion is performed on the basis of said conversion specification document.

31. The structured document converting method according to claim 28, wherein tag names of said nonkey elements are deduced from said representative tag name on the basis of said conversion specification document, and table-form reverse conversion is performed on a structured document undergone said table-form conversion to restore description of said nonkey elements to an original state.

32. The structured document converting method according to claim 29, wherein tag names of said nonkey elements are deduced from said representative tag name on the basis of said conversion specification document, and table-form reversion conversion is performed on a structured document undergone said table-form conversion to restore description of said nonkey elements to an original state.

33. The structured document converting method according to claim 30, wherein tag names of said nonkey elements are deduced from said representative tag name on the basis of said conversion specification document, and table-form reversion conversion is performed on a structured document undergone said table-form conversion to restore description of said nonkey elements to an original state.

34. The structured document converting method according to claim 1, wherein when said structured document to be converted is described in a table form in which kinds and the number of elements in each record are identical, a conversion specification document, which is describing information for discriminating between said key elements and said nonkey elements and describing information for relating tag names and attribute names of said nonkey elements with a representative tag name as said predetermined tag name representing said tag names and said attribute names, is created; and
on said structured document to be converted, table-form conversion omitting said tag name conversion and performing only said content conversion is performed on the basis of said conversion specification document.

35. The structured document converting method according to claim 2, wherein when said structured document to be converted is described in a table form in which kinds and the number of elements in each record are identical, a conversion specification document, which is describing information for discriminating between said key elements and said nonkey elements and describing information for relating tag names and attribute names of said nonkey elements with a representative tag name as said predetermined tag name representing said tag names and said attribute names, is created; and
on said structured document to be converted, table-form conversion omitting said tag name conversion and performing only said content conversion is performed on the basis of said conversion specification document.

36. The structured document converting method according to claim 3, wherein when said structured document to be converted is described in a table form in which kinds and the number of elements in each record are identical, a conversion specification document, which is describing information for discriminating between said key elements and said nonkey elements and describing information for relating tag names and attribute names of said nonkey elements with a representative tag name as said predetermined tag name representing said tag names and said attribute names, is created; and
on said structured document to be converted, table-form conversion omitting said tag name conversion and performing only said content conversion is performed on the basis of said conversion specification document.

37. The structured document converting method according to claim 34, wherein tag names and attribute names of said nonkey elements are deduced from said representative tag name on the basis of said conversion specification document, and table-form reverse conversion is performed on said structured document undergone said table-form conversion to restore description of said nonkey elements to an original state.

38. The structured document converting method according to claim 35, wherein tag names and attribute names of said nonkey elements are deduced from said representative tag name on the basis of said conversion specification document, and table-form reverse conversion is performed on said structured document undergone said table-form conversion to restore description of said nonkey elements to an original state.

39. The structured document converting method according to claim 36, wherein tag names and attribute names of said nonkey elements are deduced from said representative tag name on the basis of said conversion specification document, and table-form reverse conversion is performed on said structured document undergone said table-form conversion to restore description of said nonkey elements to an original state.

40. The structured document converting method according to claim 31, wherein table form information about whether said structured document to be converted is described in a table form or not is described in said conversion specification document; and
execution/non-execution of said table-form conversion and said table-form reverse conversion is selected on the basis of said table from information in said conversion specification document.

41. The structured document converting method according to claim 32, wherein table form information about whether said structured document to be converted is described in a table form or not is described in said conversion specification document; and
execution/non-execution of said table-form conversion and said table-form reverse conversion is selected on the basis of said table from information in said conversion specification document.

42. The structured document converting method according to claim 33, wherein table form information about whether said structured document to be converted is described in a table form or not is described in said conversion specification document; and
execution/non-execution of said table-form conversion and said table-form reverse conversion is selected on the basis of said table from information in said conversion specification document.

43. The structured document converting method according to claim 40, wherein when it is described as said table form information that said structured document to be converted is not in the table form, said tag name conversion is performed.

44. The structured document converting method according to claim 41, wherein when it is described as said table form information that said structured document to be converted is not in the table form, said tag name conversion is performed.

45. The structured document converting method according to claim 42, wherein when it is described as said table form information that said structured document to be converted is not in the table form, said tag name conversion is performed.

46. The structured document converting method according to claim 16, wherein said conversion specification document is created as a structured document to give a conversion execution procedure.

47. The structured document converting method according to claim 17, wherein said conversion specification document is created as a structured document to give a conversion execution procedure.

48. The structured document converting method according to claim 18, wherein said conversion specification document is created as a structured document to give a conversion execution procedure.

49. The structured document converting method according to claim 16, wherein a style sheet for conversion instructing said conversion is created on the basis of said conversion specification document; and
a structured document converting processor executes said conversion using said style sheet for conversion.

50. The structured document converting method according to claim 17, wherein a style sheet for conversion instructing said conversion is created on the basis of said conversion specification document; and
a structured document converting processor executes said conversion using said style sheet for conversion.

51. The structured document converting method according to claim 18, wherein a style sheet for conversion instructing said conversion is created on the basis of said conversion specification document; and
a structured document converting processor executes said conversion using said style sheet for conversion.

52. The structured document converting method according to claim 19, wherein a style sheet for reverse conversion instructing said reverse conversion is created on the basis of said conversion specification document; and
a structured document converting processor executes said reverse conversion using said style sheet for reverse conversion.

53. The structured document converting method according to claim 20, wherein a style sheet for reverse conversion instructing said reverse conversion is created on the basis of said conversion specification document; and
a structured document converting processor executes said reverse conversion using said style sheet for reverse conversion.

54. The structured document converting method according to claim 21, wherein a style sheet for reverse conversion instructing said reverse conversion is created on the basis of said conversion specification document; and
a structured document converting processor executes said reverse conversion using said style sheet for reverse conversion.

55. A structured document converting method comprising the steps of:
separating elements constituting a structured document to be converted into key elements that are objects of data processing on said structured document and nonkey elements that are not objects of said data processing;
creating a new element given a predetermined tag name;
creating a character string in which symbols relating to tagging in description of said nonkey elements are replaced with character strings not relating to tagging;
describing said created character string as a content of said new element; and
describing said key elements unchanged in a converted structured document.

56. A structured document converting method comprising the steps of:
separating elements constituting a structured document to be converted into key elements that are objects of data processing on said structured document and nonkey elements that are not objects of said data processing;
creating a new element given a predetermined tag name and a predetermined attribute name;
creating a character string in which symbols relating to tagging in description of said nonkey elements are replaced with character strings not relating to tagging;
describing said created character string as an attribute value corresponding to said predetermined attribute name in said new element; and
describing said key elements unchanged in a converted structured document.

57. A structured document converting method comprising the steps of:
separating elements constituting a structured document to be converted into key elements that are objects of data processing on said structured document and nonkey elements that are not objects of said data processing;
giving a new attribute name to a parent element of said nonkey elements;
creating a character string in which symbols relating to tagging in description of said nonkey elements are replaced with character strings not relating to tagging;
describing said created character string as an attribute value corresponding to said new attribute name in said parent element; and
describing said key elements unchanged in a converted structured document.

58. A structured document converting method comprising the steps of:
separating elements constituting a structured document to be converted into key elements that are objects of data processing on said structured document and nonkey elements that are not objects of said data processing;
creating a character string in which symbols relating to tagging in description of said nonkey elements are replaced with character strings not relating to tagging;
describing said created character string as a content of a parent element of said nonkey element; and
describing said key elements unchanged in a converted structured document.

59. The structured document converting method according to claim 55, wherein a conversion specification document, which is describing information for discriminating between said key elements and nonkey elements and describing information on said new element, is created; and
on said structured document to be converted, conversion of description of said nonkey elements is performed on the basis of said conversion specification document.

60. The structured document converting method according to claim 56, wherein a conversion specification document, which is describing information for discriminating between said key elements and nonkey elements and describing information on said new element, is created; and
on said structured document to be converted, conversion of description of said nonkey elements is performed on the basis of said conversion specification document.

61. The structured document converting method according to claim 57, wherein a conversion specification document, which is describing information for discriminating between said key elements and said nonkey elements and describing information about said parent element, is created; and
on said structured document to be converted, conversion of description of said nonkey elements is performed on the basis of said conversion specification document.

62. The structured document converting method according to claim 58, wherein a conversion specification document, which is describing information for discriminating between said key elements and said nonkey elements and describing information about said parent element, is created; and
on said structured document to be converted, conversion of description of said nonkey elements is performed on the basis of said conversion specification document.

63. The structured document converting method according to claim 59, wherein on a structured document undergone said conversion, reverse conversion is performed on the basis of said conversion specification document to restore description of said nonkey elements to an original state.

64. The structured document converting method according to claim 60, wherein on a structured document undergone said conversion, reverse conversion is performed on the basis of said conversion specification document to restore description of said nonkey elements to an original state.

65. The structured document converting method according to claim 61, wherein on a structured document undergone said conversion, reverse conversion is performed on the basis of said conversion specification document to restore description of said nonkey elements to an original state.

66. The structured document converting method according to claim 62, wherein on a structured document undergone said conversion, reverse conversion is performed on the basis of said conversion specification document to restore description of said nonkey elements to an original state.

67. The structured document converting method according to claim 59, wherein said conversion specification document is created as a structured document to give a conversion execution procedure.

68. The structured document converting method according to claim 60, wherein said conversion specification document is created as a structured document to give a conversion execution procedure.

69. The structured document converting method according to claim 61, wherein said conversion specification document is created as a structured document to give a conversion execution procedure.

70. The structured document converting method according to claim 62, wherein said conversion specification document is created as a structured document to give a conversion execution procedure.

71. The structured document converting method according to claim 59, wherein a style sheet for conversion instructing said conversion is created on the basis of said conversion specification document; and
a structured document converting processor executes said conversion using said style sheet for conversion.

72. The structured document converting method according to claim 60, wherein a style sheet for conversion instructing said conversion is created on the basis of said conversion specification document; and
a structured document converting processor executes said conversion using said style sheet for conversion.

73. The structured document converting method according to claim 61, wherein a style sheet for conversion instructing said conversion is created on the basis of said conversion specification document; and
a structured document converting processor executes said conversion using said style sheet for conversion.

74. The structured document converting method according to claim 62, wherein a style sheet for conversion instructing said conversion is created on the basis of said conversion specification document; and
a structured document converting processor executes said conversion using said style sheet for conversion.

75. The structured document converting method according to claim 63, wherein a style sheet for reverse conversion instructing said reverse conversion is created on the basis of said conversion specification document; and
a structured document converting processor executes said reverse conversion using said style sheet for reverse conversion.

76. The structured document converting method according to claim 64, wherein a style sheet for reverse conversion instructing said reverse conversion is created on the basis of said conversion specification document; and
a structured document converting processor executes said reverse conversion using said style sheet for reverse conversion.

77. The structured document converting method according to claim 65, wherein a style sheet for reverse conversion instructing said reverse conversion is created on the basis of said conversion specification document; and
a structured document converting processor executes said reverse conversion using said style sheet for reverse conversion.

78. The structured document converting method according to claim 66, wherein a style sheet for reverse conversion instructing said reverse conversion is created on the basis of said conversion specification document; and
a structured document converting processor executes said reverse conversion using said style sheet for reverse conversion.

79. The structured document converting method according to claim 55, wherein entity reference description of a symbol relating to said tagging is used as a character string not relating to said tagging.

80. The structured document converting method according to claim 56, wherein entity reference description of a symbol relating to said tagging is used as a character string not relating to said tagging.

81. The structured document converting method according to claim 57, wherein entity reference description of a symbol relating to said tagging is used as a character string not relating to said tagging.

82. The structured document converting method according to claim 58, wherein entity reference description of a symbol relating to said tagging is used as a character string not relating to said tagging.

83. The structured document converting method according to claim 79, wherein when said structured document to be converted is an XML (extensible Markup Language) document, symbols “<” and “>” relating to said tagging are replaced with “&lt;” and “&gt;” respectively.

84. The structured document converting method according to claim 80, wherein when said structured document to be converted is an XML (extensible Markup Language) document, symbols “<” and “>” relating to said tagging are replaced with “&lt;” and “&gt;” respectively.

85. The structured document converting method according to claim 81, wherein when said structured document to be converted is an XML (extensible Markup Language) document, symbols “<” and “>” relating to said tagging are replaced with “&lt;” and “&gt;” respectively.

86. The structured document converting method according to claim 82, wherein when said structured document to be converted is an XML (extensible Markup Language) document, symbols “<” and “>” relating to said tagging are replaced with “&lt;” and “&gt;” respectively.

87. A structured document converting method comprising the steps of:
separating elements constituting a structured document to be converted conversion into key elements that are objects of data processing on said structured document and nonkey elements that are not objects of said data processing;
creating a new element given a predetermined tag name;
converting said nonkey elements into a compressed character string composed of character codes according to ASCII (American Standard Code for Information Interchange) by performing variable-length coding to assign a shorter variable-length code to a character or a character string having a higher frequency of appearance in said nonkey element, packing each six bits of binary data obtained by said variable-length coding into conversion data of one byte, and converting six-bit data packed into each conversion data into a character code according to ASCII;
describing said compressed character string as a content of said new element; and
describing said key elements unchanged in a converted structured document.

88. A structured document converting method comprising the steps of:
separating elements constituting a structured document to be converted into key elements that are objects of data processing on said structured document and nonkey elements that are not objects of said data processing;
creating a new element given a predetermined tag name and a predetermined attribute name;
converting said nonkey elements into a compressed character string composed of character codes according to ASCII (American Standard Code for Information Interchange) by performing variable-length coding to assign a shorter variable-length code to a character or a character string having a higher frequency of appearance in said nonkey element, packing each six bits of binary data obtained by said variable-length coding into conversion data of one byte, and converting six-bit data packed into each conversion data into a character code according to ASCII;
describing said compressed character string as an attribute value corresponding to said predetermined attribute name at said new element; and
describing said key elements unchanged in a converted structured document.

89. The structured document converting method according to claim 87, wherein in prior to conversion of said nonkey elements into said compressed character string, a character string configuring said nonkey elements is replaced with dictionary numbers using a static dictionary beforehand created, and a character string including said dictionary numbers is converted to said compressed character string.

90. The structured document converting method according to claim 88, wherein in prior to conversion of said nonkey elements into said compressed character string, a character string configuring said nonkey elements is replaced with dictionary numbers using a static dictionary beforehand created, and a character string including said dictionary numbers is converted to said compressed character string.

91. The structured document converting method according to claim 87, wherein when a converted structured document is reversely converted, said compressed character string is taken out from said converted structured document;
each character code in said compressed character string is converted into six-bit data according to ASCII;
a character or a character string configuring said nonkey element is restored from six-bit data obtained for each character code; and
an original structured document is restored using restored nonkey elements.

92. The structured document converting method according to claim 88, wherein when a converted structured document is reversely converted, said compressed character string is taken out from said converted structured document;
each character code in said compressed character string is converted into six-bit data according to ASCII;
a character or a character string configuring said nonkey element is restored from six-bit data obtained for each character code; and
an original structured document is restored using restored nonkey elements.

93. The structured document converting method according to claim 87, wherein a conversion specification document, which is describing information for discriminating between said key elements and said nonkey elements and describing information about said new element, is created; and
on said structured document to be converted, conversion of description of said nonkey elements is performed on the basis of said conversion specification document.

94. The structured document converting method according to claim 88, wherein a conversion specification document, which is describing information for discriminating between said key elements and said nonkey elements and describing information about said new element, is created; and
on said structured document to be converted, conversion of description of said nonkey elements is performed on the basis of said conversion specification document.

95. The structured document converting method according to claim 93, wherein on said converted structured document undergone said conversion, reverse conversion is performed on the basis of said conversion specification to restore said nonkey elements to an original state.

96. The structured document converting method according to claim 94, wherein on said converted structured document undergone said conversion, reverse conversion is performed on the basis of said conversion specification to restore said nonkey elements to an original state.

97. The structured document converting method according to claim 93, wherein said conversion specification document is created as a structured document to give a conversion execution procedure.

98. The structured document converting method according to claim 94, wherein said conversion specification document is created as a structured document to give a conversion execution procedure.

99. The structured document converting method according to claim 87, wherein information indicating a type of a character code system at the time of compression is given to said compressed character string;
said given information is referred to recognize a type of a character code system at the time of said compression when said converted structured document is reversely converted; and
said compressed character is restored so that a character code system of said recognized type is matched with a character code system at the time of said reverse conversion.

100. The structured document converting method according to claim 88, wherein information indicating a type of a character code system at the time of compression is given to said compressed character string;
said given information is referred to recognize a type of a character code system at the time of said compression when said converted structured document is reversely converted; and
said compressed character is restored so that a character code system of said recognized type is matched with a character code system at the time of said reverse conversion.

101. The structured document converting method according to claim 87, wherein a set of ASCII, in which character codes relating to tagging in a structured document are eliminated, is used when converting said six-bit data into said character code.

102. The structured document converting method according to claim 88, wherein a set of ASCII, in which character codes relating to tagging in a structured document are eliminated, is used when converting said six-bit data into said character code.

103. A data converting method comprising the steps of:
performing variable-length coding to assign a shorter variable-length code to a character or a character string having a higher frequency of appearance in a document to be converted; and
packing each six bits of binary data obtained by said variable-length coding into a conversion data of one byte and outputting said conversion data.

104. The data converting method according to claim 103, wherein six-bit data packed into each conversion data is converted into a character code according to ASCII (American Standard Code for Information interchange); and
said character code obtained for each conversion data is outputted as a result of compressing conversion of said document to be converted.

105. The data converting method according to claim 104, wherein when said result of compressing conversion is restored, each character code as said result of compressing conversion is converted into six-bit data according to ASCII; and
said character or said character string is restored from six-bit data obtained for each character code.

106. The data converting method according to claim 104, wherein a set of ASCII, in which character codes relating to tagging in a structured document are eliminated, is used when converting said six-bit data into said character code.
